(19) United States
(12) Patent Application Publication
(10) Pub. No.: US 2024/0158264 A1
(43) Pub. Date: May 16, 2024

(54) SPECIALIZED LAYERS AND APPARATUS FOR PASSIVE DEWATERING, MOISTURE REMOVAL, WATER SEPARATION, WATER VAPORIZATION, AND WATER AND/OR WASTE TREATMENT

(71) Applicant: change:WATER Labs Inc., Cambridge, MA (US)

(72) Inventors: Diana YOUSEF-MARTINEK, Cambridge, MA (US); Huda ELASAAD, Cambridge, MA (US); Andrew OLLERHEAD, Cambridge, MA (US); Ricci LACENTRA, Cambridge, MA (US); Hayley WALKER, Cambridge, MA (US); Yashik Chandrashekar GABBALADKA, Cambridge, MA (US); Ujjawal Yeshpal GAUTAM, Cambridge, MA (US); Michael MARTIN, Cambridge, MA (US); James SPENCE, Cambridge, MA (US); Amit GANDHI, Cambridge, MA (US)

(21) Appl. No.: 18/280,743

(22) PCT Filed: Mar. 9, 2022
(86) PCT No.: PCT/US2022/019527

§ 371 Date: Sep. 7, 2023

Related U.S. Application Data
(60) Provisional application No. 63/212,569, filed on Jun. 18, 2021.
(60) Provisional application No. 63/212,571, filed on Jun. 18, 2021.
(60) Provisional application No. 63/159,255, filed on Mar. 10, 2021.
(60) Provisional application No. 63/159,232, filed on Mar. 10, 2021.

(51) Int. Cl. C02F 1/04; A47K 11/06; B01D 1/30; B01D 61/36; B01D 71/52; B01D 71/56; B01D 71/80; C05F 17/40; C05F 17/90; F26B 3/04; F26B 5/04; F26B 5/16; F26B 9/06; C02F 103/00

(52) U.S. Cl. CPC C02F 1/048; A47K 11/06; B01D 1/30; B01D 61/362; B01D 61/364; B01D 71/52; B01D 71/56; B01D 71/80; C05F 17/40; C05F 17/90; F26B 3/04; F26B 5/044; F26B 5/16; F26B 9/06; B01D 2325/12; B01D 2325/36; B01D 2325/38; C02F 2103/005; C02F 2201/007; C02F 2303/02

(57) ABSTRACT

An apparatus and method for evaporative containment of liquid or solid wastes includes an evaporative membrane for receiving the solid or liquid waste and at least one flap including a wicking layer, an odor-neutralizing layer, or both, and a skeletal frame. An apparatus and method for moisture removal from media includes a hydrophilic evaporative layer and a wicking layer, the hydrophilic evaporative layer being non-porous or nano-porous and allowing selective passage of vapor water molecules while preventing passage of suspended or dissolved solids, ions, salt, or pollutants, the wicking layer absorbing and spreading bulk moisture across a surface area. An apparatus and method for collecting liquid or solid wastes includes liquid and solid waste capture containers capable of volume reduction of captured waste and generating a liquid or gas effluent with fewer impurities than the captured waste.

### CROSS-REFERENCE TO RELATED APPLICATIONS

This application claims the benefit of U.S. Provisional Patent Application Nos. 63/159,232, filed Mar. 10, 2021, 63/159,255, filed Mar. 10, 2021, 63/212,569, filed Jun. 18, 2021, and 63/212,571, filed Jun. 18, 2021, which are incorporated by reference herein in their entireties.

### TECHNICAL FIELDS

The relevant technical fields include evaporative processing, waste collection, and biological waste processing.

### BACKGROUND

Evaporation of aqueous solutions, whether partial or complete, and dewatering, the removal of water from solid media, are vital processes to a countless number of industries. The need to reduce the water content of various materials, including but not limited to food products, pharmaceuticals, soil and other agricultural substrates, construction materials, waste and sludge, industrial runoff, derives from diverse goals.

Solid materials or products, when manufactured, synthesized, harvested or otherwise obtained, often have a substantial moisture content due to the use of water in industrial processes and its abundance in natural resources. Similarly, as a notoriously compatible solvent, water is the most abundant component of most liquid products, including drinks, detergents, pharmaceutical solutions and more. While a higher moisture content is not inherently damaging to many of these products, many organic substrates including but not limited to food products, soil and other agricultural media and biological wastes, are susceptible to biological activity when the moisture content exceeds a threshold value. For example, fresh fruits and vegetables often have a very high moisture content, often in the range of 60 to 96%, providing a hospitable substrate for mold and digestive microbes which accelerates rotting. Furthermore, the water content of many substrates contributes substantially to the product's weight and/or volume, which increases storage and transportation requirements, and often influences the way they are handled or used as well. In the production of chemical fertilizers, for example, the industrial process yields a slurry with a water content often exceeding 50%, which requires drying before dense, solid fertilizer pellets may be obtained (a process which often occurs at the same plant or facility which produced the chemicals). If the product is not dried and retains this moisture content (e.g. 50%), the moisture alone includes roughly half of the material's weight and volume, effectively meaning twice as much volume is required for storage and twice as much weight must be transported just to accommodate the moisture within the fertilizer slurry, which can be costly and inefficient compared to storing a concentrated product. Application of many materials is also affected by moisture content The above reasons are equally true for liquid products, as many liquid products may be concentrated through the removal of water, reducing weight and volume while maintaining all wanted compounds.

Considering the commonplace need for reducing a material's moisture content, which exists across numerous vital industries, countless methods including small- and large-scale processes have been adapted for the evaporation and dewatering of different materials. When permissible and not detrimental to the material, many methods generate heat to be used in the drying process, employing direct heat, for example drying over an open flame, or indirect heat where heated air is used for drying. While direct heat is a simple method that can be operated at any scale and does not require specialized equipment (only fire is necessary), it is difficult to control the degree of drying due to inconsistent temperature distribution from an open flame. Furthermore, direct heat is not a viable option for the drying of flammable or combustible materials, nor should it be used if protein denaturation is a concern. Drying with indirect heat, typically blown air which has passed through one or more heating coil to reach the desired temperature, is preferred by many industries and offers better control over the drying process than direct heat by allowing the operator to control the temperature, velocity and direction of air, as well as sometimes the humidity of the air. Indirect heat is used for a broad array of drying applications at any size, though specialized equipment is often required to heat and circulate this air, and most large-scale indirect drying operations have been adapted to include additional specialty equipment including but not limited to conveyor belts, vibrating beds and fluidized beds. Regardless of the application or equipment used, indirect heating still relies on the heating of air, meaning energy is required and the heating element must be present and operational in order for the dryer to function, which may be costly and restrictive for many applications.

Solar drying, one of the earliest known drying methods, uses heat from the sun to warm air which flows across the surface of the materials being dried, eliminating the need for a dedicated heating element. While it requires little or no specialized equipment and poses a low risk of burning (making it suitable for many products, for example fruit), solar drying has a number of drawbacks. The absence of control parameters means that drying is highly dependent on weather conditions, and solar drying typically requires much more time than the above methods, which may allow organic materials to undergo partial degradation during the drying process. Furthermore, the maximum obtainable heat of a solar dryer may be below the heat required to adequately remove moisture from some substrates.

Alternate drying methods have been developed which do not require an external heat source to operate, though most of these methods require an adequate energy source and specialized equipment as well. Dielectric dryers, which use microwave and radio frequency to excite water molecules and promote vaporization, are one example, since they lack a heating element but require equipment capable of generating the necessary vibrations, which in turn require energy to function. An example of drying technology that does not require heat generation includes vacuum drying, where moisture from a wet substrate is removed by means of creating a vacuum. This is a superior drying method for many heat-sensitive materials, but relies on a pressure differential to operate which often requires a powered vacuum, meaning specialized equipment and an external energy source are needed.

While the above methods refer to dewatering of solids, there also exists a need to remove water from aqueous solutions, for the purposes of concentrating the solution or recovering dissolved ions and suspended solids. Several of the aforementioned drying methods for solid substrates can be modified and utilized for the removal of water from liquid solutions and, as a result, many methods for liquid separation rely on the addition of heat to vaporize water molecules while retaining the desired components. Boiling a solution, for example, is a simple and well-known method that may be used at any scale for concentrating a liquid or isolating solutes and suspended particles by vaporizing water. Distillation, a process which employs boiling and allows for the collection of the evaporated water and dissolved or suspended retentates, is a very popular method for the separation of liquid-liquid mixtures, however controllable high heats (whether applied directly or indirectly applied) are needed throughout the process, limiting distillation to applications and environments where said heat source is available. Furthermore, boiling and distillation are unsuitable methods for separating water from azeotropic solutions.

Simple filtration, where liquid is passed through a porous filter to trap suspended solids, does not require an energy source or costly materials, however it is only useful for particulates larger than the filter pores and does not work well for the removal of dissolved salts. Vacuum filtration and reverse osmosis are more effective forms of filtration, in which fewer impurities are allowed to pass with the water being removed, though equipment and energy is required to apply controllable pressures on the membrane or filter surface.

In over 40% of the world, there is a poor state of plumbing and safe sanitation. Lack of modern toilets (or sanitary handling and removal of human waste) results in many cases from a lack of maintained municipal plumbing or the inability to install a septic tank, which, in many regions is often the result of many combined conditions, such as a poor economy and lack of municipal funding, incompatible geological and climate/weather conditions, remoteness or, conversely, an overload in use/activity.

This is true not only for individual homes but also for public/communal toilets, such as those in schools and office buildings, camping grounds, construction sites, refugee camps/temporary settlements, events, and others. In many of these cases, the temporary use of the space makes connecting to plumbing or septic impractical, and the (currently considered “best”) alternative method is the use of portable chemical toilets in which human waste is pooled with additional odor-neutralizing chemicals until the waste can be emptied out and transported. This comes at a high economic cost and requires hefty transportation, followed by proper disposal.

The lack of appropriate home and public sanitation both have negative consequences for the individual, community and/or environment. The lack of proper residential sanitation is first and foremost a health hazard. Human feces contain pathogens which easily spread from person-to-person when not effectively treated (or from person-to-plant-to-person if deposited near crops). Common results of nonexistent or ineffective municipal water sanitation include hauling waste to appropriate remote treatment facilities (costly and requiring trucks/equipment), dumping into waterways, burning waste, inelegant collection, and burial of waste (by individuals or designated community collectors), collection in a lagoon or compost pile or, in the worst cases, dumping or discarding in public/populated areas (sometimes recklessly, such as open defecation or “flying toilets”).

Poor sanitation (i.e., mismanagement of/inevitable contact with human waste, garbage and more) is responsible for 80% of all infectious disease and 4% of deaths globally. Diseases often occur from accidental ingestion of waste (a consequence of proximity) or the contamination of water or soil which, in turn, affects people who do not realize they are in contact with fecal pathogens.

This issue is compounded in high-population areas, many of which are unfortunately prime examples of areas with poor sanitation measures and heavy buildup and pollution of human waste. While children, the elderly and those with compromised immune systems are typically the most at-risk of death from poor sanitation, chronic illness nonetheless occurs and diarrhea from pathogens is an abundantly common problem which affects people of all ages and is still potentially deadly in many parts of the world.

In addition to health problems, poor sanitation can drastically affect a person's quality of life or social prospects. In many regions, this means a person must carry the waste from their household nightly/regularly to remote areas to be buried away from communities, far enough that it will not contaminate waterways. Outside of the home, in schools, the lack of modern sanitation requires students to use distant and/or heavily communal toilets when at school, which puts students {particularly women and girls) at risk of being attacked while in a vulnerable state. These attacks are not uncommon and, as a result, students routinely avoid using the toilet by holding in their waste while at school (sacrificing comfort and health) or staying home from school (sacrificing their education). In refugee camps and other situations, a more desperate scenario exists where a person's only options are using communal toilets with the same risks, or relieving themselves in their dwelling/away from the toilets.

In many areas, there exist alternatives (often government or NGO aid or intervention) devoted to removing and treating waste from areas with poor sanitation profiles. Alternatives typically involve picking up waste in a truck or cart and transporting it to a remote area where it can be composted (requires land/labor and quite some time before safe), burned or desiccated in ovens (space and energy requirements), or treated in a biodigester/bioreactor.

These methods of course have an associated cost (higher than what most people pay to have toilets in their home in compatible areas) and, while typically paid for or subsidized by governments, NGOs or other forms of aid/charity, these require a network of manpower and funding to continue, and place the handling of the problem among outside people/those not affected by the conditions.

Due to the high-water content of human waste (and many forms of waste)—99% in urine and 75-80% in feces, on average—it is true that human waste is vastly made up of water, which contributes substantially to the weight and volume of both solid and liquid human waste.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In an aspect, an apparatus for moisture removal and separation from moisture-containing media includes one or more hydrophilic evaporative layers; and one or more wicking layers, where the moisture-containing media contains one or more of a suspended solid, a dissolved solid, a dissolved ion or salt, biological material or other pollutant, the one or more hydrophilic evaporative layers are non-porous or nano-porous and allowing selective passage of water molecules in vapor form while preventing passage of one or more of a suspended solid, a dissolved solid, a dissolved ion, salts, biological material or other pollutants, and the one or more wicking layer are adapted to absorb and spread bulk moisture, with or without dissolved ions, across a surface area, allowing the transfer of moisture from the one or more wicking layers to the one or more evaporative layers, direct evaporation from the one or more wicking layers retaining one or more of a suspended solid, a dissolved solid, a dissolved ion, salts, biological material or other pollutants.

The one or more evaporative layers may include a bag or tube with an opening for substrate or media delivery.

The one or more wicking layers and the one or more evaporative layers may be in contact.

The one or more wicking layers and the one or more evaporative layers may be not in contact, and the one or more wicking layers may be suspended into the media or substrate which is contained in the bag or tube formed of the one or more evaporative layers.

The apparatus may further include one or more odor-neutralizing layer, where the one or more wicking layers are each paired with the one or more odor-neutralizing layer, each pair of the one or more wicking layers and the one or more odor-neutralizing layers being in direct contact.

The one or more wicking layers may be impregnated with an absorptive material to increase moisture removal, including but not limited to hydrogel and silica gel.

The one or more wicking layers may be selectively hydrophilic or hydrophobic to control a direction of wicking or a release of moisture from the one or more wicking layers.

The one or more evaporative layers may be made from a copolyetherester elastomer, a polyether-block-polyamide, a polyether urethane, homopolymers or copolymers of polyvinyl alcohol, or mixtures thereof.

The one or more evaporative layers may be made from polyether-block-polyamide PEBAX® 1074, or a combination of polyether-block-polyamides in which PEBAX® 1074 is one component.

The one or more wicking layers and the one or more evaporative layers may be encased in a rigid shell for protection, with one opening for the delivery of moisture-containing media to the evaporative layer bag.

The apparatus may further include holes in the rigid shell for ventilation.

The apparatus may further include one or more of a powered fan and a vacuum for assisting airflow and ventilation.

The one or more wicking and one or more odor-neutralizing layers may be arranged in parallel to create channels that direct airflow through the apparatus.

The apparatus may further include a heater for providing additional heat into the rigid shell to improve a rate of pervaporation through the one or more evaporative layers.

In another aspect, a method for moisture removal and separation from moisture-containing media includes providing one or more hydrophilic evaporative layers, and providing one or more wicking layers, where the moisture-containing media contains one or more of a suspended solid, a dissolved solid, a dissolved ion or salt, biological material or other pollutant, the one or more hydrophilic evaporative layers are non-porous or nano-porous and allowing selective passage of water molecules in vapor form while preventing passage of one or more of a suspended solid, a dissolved solid, a dissolved ion, salts, biological material or other pollutants, and the one or more wicking layer are adapted to absorb and spread bulk moisture, with or without dissolved ions, across a surface area, allowing the transfer of moisture from the one or more wicking layers to the one or more evaporative layers, direct evaporation from the one or more wicking layers retaining one or more of a suspended solid, a dissolved solid, a dissolved ion, salts, biological material or other pollutants

The one or more evaporative layers may include a bag or tube with an opening for substrate or media delivery.

The one or more wicking layers and the one or more evaporative layers may be in contact

The one or more wicking layers and the one or more evaporative layers may be not in contact, and the one or more wicking layers may be suspended into the media or substrate which is contained in the bag or tube formed of the one or more evaporative layers.

The method may further include providing one or more odor-neutralizing layer, where the one or more wicking layers are each paired with the one or more odor-neutralizing layer, each pair of the one or more wicking layers and the one or more odor-neutralizing layers being in direct contact

The one or more wicking layers may be impregnated with an absorptive material to increase moisture removal, including but not limited to hydrogel and silica gel.

The one or more wicking layers may be selectively hydrophilic or hydrophobic to control a direction of wicking or a release of moisture from the one or more wicking layers.

The one or more evaporative layers may be made from a copolyetherester elastomer, a polyether-block-polyamide, a polyether urethane, homopolymers or copolymers of polyvinyl alcohol, or mixtures thereof.

The one or more evaporative layers may be made from polyether-block-polyamide PEBAX® 1074, or a combination of polyether-block-polyamides in which PEBAX® 1074 is one component.

The method may further include providing a rigid shell, where the one or more wicking layers and the one or more evaporative layers are encased in the rigid shell for protection, with one opening for the delivery of moisture-containing media to the evaporative layer bag.

The rigid shell may include holes for ventilation.

The method may further include providing one or more of a powered fan and a vacuum for assisting airflow and ventilation.

The one or more wicking and one or more odor-neutralizing layers may be arranged in parallel to create channels that direct airflow through the apparatus.

The method may further include providing a heater for providing additional heat into the rigid shell to improve a rate of pervaporation through the one or more evaporative layers.

In another aspect, a composition for passive dewatering and moisture removal includes at least one evaporative material selected from the group consisting of copolyetherester elastomer, a polyether-block-polyamide, a polyether urethane, homopolymers, copolymers of polyvinyl alcohol, polyether-block-polyamide PEBAX® 1074, a combination of polyether-block-polyamides in which PEBAX® 1074 is one component, or mixtures thereof, and at least one wicking material selected from the group consisting of cotton, cellulose fiber, silica gel, hydrogels, desiccant paper, wood cellulose absorptive paper, and mixtures thereof.

A weight ratio of the evaporative material to the wicking material may range from 1:3 to 5:2.

In another aspect, a composition for passive dewatering and moisture removal, includes: at least one evaporative material selected from the group consisting of copolyetherester elastomer, a polyether-block-polyamide, a polyether urethane, homopolymers, copolymers of polyvinyl alcohol, polyether-block-polyamide PEBAX® 1074, a combination of polyether-block-polyamides in which PEBAX® 1074 is one component, or mixtures thereof; and at least one odor-neutralizing material selected from the group consisting of cellulose fiber, activated carbon, zeolite, kinetic degradation fluxion media, synthetic fibers, cellulose activated carbon media, and mixtures thereof.

A weight ratio of the evaporative material to the odor-neutralizing material may range from 1:3 to 5:2.

In another aspect, a composition for passive dewatering and moisture removal, includes at least one wicking material selected from the group consisting of cotton, cellulose fiber, silica gel, hydrogels, desiccant paper, wood cellulose absorptive paper, and mixtures thereof; and at least one odor-neutralizing material selected from the group consisting of cellulose fiber, activated carbon, zeolite, kinetic degradation fluxion media, synthetic fibers, cellulose activated carbon media, and mixtures thereof.

A weight ratio of the wicking material to the odor-neutralizing material may range from 1:3 to 5:2.

In another aspect, a composition for passive dewatering and moisture removal, includes at least one evaporative material selected from the group consisting of copolyetherester elastomer, a polyether-block-polyamide, a polyether urethane, homopolymers, copolymers of polyvinyl alcohol, polyether-block-polyamide PEBAX® 1074, a combination of polyether-block-polyamides in which PEBAX® 1074 is one component, or mixtures thereof; at least one wicking material selected from the group consisting of cotton, cellulose fiber, silica gel, hydrogels, desiccant paper, wood cellulose absorptive paper, and mixtures thereof; and at least one odor-neutralizing material selected from the group consisting of cellulose fiber, activated carbon, zeolite, kinetic degradation fluxion media, synthetic fibers, cellulose activated carbon media, and mixtures thereof.

A weight ratio of the evaporative material to the wicking material may range from 1:3 to 5:2.

A weight ratio of the wicking material to the odor-neutralizing material may range from 1:3 to 5:2.

A weight ratio of the evaporative material to the odor-neutralizing material may range from 1:3 to 5:2.

In an aspect, an apparatus for evaporative containment of liquid or solid wastes includes one or more evaporative membranes for receiving the liquid or solid waste, one or more flaps comprising one or more of a wicking layer, an odor-neutralizing layer, or both, and a skeletal frame for supporting the one or more evaporative membranes and the one or more flaps.

The one or more evaporative membranes may include a membrane bag for removing moisture in the liquid or solid waste by pervaporation.

The apparatus may further include a first receptacle for receiving solid waste, and a second receptacle for receiving liquid waste.

The apparatus may further include a ventilation system comprising one or more vent cutouts for passive ventilation or a fan for active ventilation.

The apparatus may further include one or more hinged doors for providing access to the evaporative membrane and the one or more flaps.

The apparatus may further include a pre-treatment system configured for pre-treatment of liquid waste prior to the liquid waste being deposited on the evaporative membrane.

Liquid waste may be configured to be received by a receptacle for liquid waste, then received by the pre-treatment system before being received by the one or more flaps or the one or more evaporative membranes.

The pre-treatment system may include a funnel and one or more tubes.

The one or more flaps may include at least one of the wicking layer and at least one of the odor-neutralizing layer, the at least one wicking layer and the at least one odor-neutralizing layer being in contact at least partly to form a single flap of the one or more flaps. [0020] The one or more evaporative layers may be made from a copolyetherester elastomer, a polyether-block-polyamide, a polyether urethane, homopolymers or copolymers of polyvinyl alcohol, or mixtures thereof.

The one or more evaporative layers may be made from polyether-block-polyamide PEBAX® 1074, or a combination of polyether-block-polyamides in which PEBAX® 1074 is one component.

The apparatus may further include a heater for providing additional heat to improve a rate of pervaporation through the one or more evaporative membranes.

The apparatus may further include tracks or carriages or guide rails that allow for easy unrestricted linear movement of the receptacles.

In another aspect, a method for evaporative containment of liquid or solid wastes, includes providing an apparatus including one or more evaporative membranes for receiving the liquid or solid waste, one or more flaps comprising one or more of a wicking layer and an odor-neutralizing layer, or both, and a skeletal frame for supporting the one or more evaporative membranes and the one or more flaps.

The one or more evaporative membranes may include a membrane bag for removing moisture in the liquid or solid waste by pervaporation.

The apparatus may further include a first receptacle for receiving solid waste, and a second receptacle for receiving liquid waste.

The apparatus may further include a ventilation system comprising one or more vent cutouts for passive ventilation or a fan for active ventilation.

The apparatus may further include one or more hinged doors for providing access to the evaporative membrane and the one or more flaps.

The apparatus may further include a pre-treatment system configured for pre-treatment of liquid waste prior to the liquid waste being deposited on the evaporative membrane.

The method may further include receiving liquid waste using a receptacle for liquid waste, receiving liquid waste from the receptacle by the pre-treatment system, and receiving liquid waste from the pre-treatment system into the one or more flaps or the one or more evaporative membranes.

The pre-treatment system may include a funnel and one or more tubes.

The one or more flaps may include at least one of the wicking layer and at least one of the odor-neutralizing layer, the at least one wicking layer and the at least one odor-neutralizing layer being in contact at least partly to form a single flap of the one or more flaps.

The one or more evaporative layers may be made from a copolyetherester elastomer, a polyether-block-polyamide, a polyether urethane, homopolymers or copolymers of polyvinyl alcohol, or mixtures thereof.

The one or more evaporative layers may be made from polyether-block-polyamide PEBAX® 1074, or a combination of polyether-block-polyamides in which PEBAX® 1074 is one component.

The apparatus may further include a heater for providing additional heat to improve a rate of pervaporation through the one or more evaporative membranes.

The apparatus may further include tracks or carriages or guide rails that allow for easy unrestricted linear movement of the receptacles.

In another aspect, an apparatus for collecting liquid or solid wastes comprises a solid waste container and a liquid waste container, each capable of volume reduction of collected waste and generating effluent in liquid or gas form containing a lower amount of impurities than the captured waste.

The solid and liquid waste capture container comprise at least one of a hydrophilic material or wicking material, and volume reduction is achieved by partial vaporization of captured liquid through the waste capture container.

The apparatus may keep collected solid waste separate from collected liquid waste.

The apparatus may further include a membrane distillation module for receiving collected liquid waste and producing a liquid effluent.

The collected waste may be partially treated.

The apparatus may further include a filtration cell for receiving liquid waste and producing a liquid permeate.

The filtration cell may include at least one ultrafiltration membrane.

The apparatus may further include at least one of a disinfection component or an odor-reduction component.

The apparatus may further include a precipitation reactor or element configured to receive liquid waste and generate a solid compound.

The solid waste container and the liquid waste container may be configured to collect solid compounds and allow removal of solid compounds from the apparatus.

The solid waste container may be released into the liquid waste container.

The solid waste container may be nested inside the liquid waste container.

The apparatus may be configured to allow conversion of collected waste by composting, biogas generation, living organisms.

The apparatus may further include a turbine for providing internal airflow or energy to the apparatus.

In another aspect, a method for collecting liquid and/or solid waste for processing includes providing an apparatus including a solid capture container and liquid capture container, collecting a solid waste, liquid waste or feed liquid, and generating a solid compound or concentrated liquid.

The apparatus may further include a condensation surface configured to facilitate a gas-to-liquid phase change of gas effluent.

The condensation surface may be comprised of a superhydrophic material, superhydrophic coating, omniphobic material, omniphoic coating, or textured surface.

In another aspect, an apparatus for the collection of at least one solid waste, liquid waste, or liquid feed includes a waste capture container and an energy cell configured to receive a portion of the received waste and generate an electric current utilizing the waste.

The energy cell may receive a portion of diverted portion of liquid waste received by the apparatus.

In another aspect, an apparatus for the collection of solid and/or liquid waste includes a waste container having a plurality of volume reduction surfaces, wherein a reduction surface is configured to be tuneably intermittently submerged in the volume, ranging between partially submerged and fully submerged.

In another aspect, an apparatus for the collection of solid and/or liquid waste includes a capture container comprising a non-hydrophobic material and a hydrophobic material.

In another aspect, an apparatus for the collection of solid and/or liquid waste includes a waste container impermeable to gas and liquid and an evaporative surface configured to contact captured waste in the waste container and capable of volume reduction of captured waste and generating effluent in liquid or gas form.

### BRIEF DESCRIPTION OF THE DRAWINGS

The foregoing summary, as well as the following detailed description, will be better understood when read in conjunction with the appended drawings. For the purpose of illustration, certain examples of the present description are shown in the drawings. It should be understood, however, that the invention is not limited to the precise arrangements and instrumentalities shown. The accompanying drawings, which are incorporated in and constitute a part of this specification, illustrate an implementation of systems, apparatuses, and methods consistent with the present description and, together with the description, serve to explain advantages and principles consistent with the invention.

FIG. 1 is a side view of an example apparatus in which passive dewatering layers are secured in an example functional arrangement.

FIG. 2 is an angled overhead view of the example apparatus shown in FIG. 1, showing the points of contact between each layer.

FIG. 3 is a conceptual diagram demonstrating the movement of water molecules in one potential arrangement of layers.

FIG. 4 shows an isometric view of an example non-limiting evaporative toilet.

FIG. 5 shows the FIG. 4 toilet with a few of its external components hidden so as to illustrate its internal components.

FIG. 6 shows the front view of the FIG. 4 toilet.

FIG. 7 shows the back view of the FIG. 4 toilet.

FIG. 8 shows one of the components from FIG. 5 namely, the Liquid Receptacle.

FIG. 9 shows FIG. 8, the Liquid Receptacle in its exploded state, so that all of its constituent components are clearly visible.

FIG. 10 shows another component from FIG. 5 namely, the Solid Receptacle.

FIG. 11 shows FIG. 10, the Solid Receptacle in its exploded state, so that all of its constituent components are clearly visible.

FIG. 12 shows another component from FIG. 5, namely, the Pre-Treatment System and a part of it as a sectional view.

FIG. 13 shows another component from FIG. 5, namely, the Suspended Flaps System.

FIG. 14 shows the FIG. 4 toilet with most of its external components depicting the safety and servicing features in the exploded state.

FIG. 15 is a conceptual diagram of one embodiment of an apparatus for onsite waste volume reduction.

FIG. 16 is a conceptual diagram of another embodiment of an apparatus for onsite waste volume reduction.

FIG. 17A shows a conceptual diagram of another embodiment of an apparatus for onsite waste volume reduction including a membrane distillation module.

FIG. 17B shows a conceptual diagram of an embodiment of a membrane distillation module as seen in FIG. 17A.

FIG. 18A shows a conceptual diagram of another embodiment of an apparatus for onsite waste volume reduction including a filtration cell.

FIG. 18B shows a conceptual diagram of an embodiment of a filtration module, as seen contained in the filtration cell of FIG. 18A.

FIG. 19A shows a conceptual diagram of another embodiment of an apparatus for onsite waste volume reduction including a precipitation reactor.

FIG. 19B shows a conceptual diagram of an embodiment of a precipitation reactor as seen in FIG. 19A.

FIG. 20 shows a conceptual diagram of another embodiment of an apparatus for onsite waste volume reduction including a turbine, fan, condensation surface, battery, and heat component.

FIG. 21A shows a conceptual diagram of another embodiment of an apparatus for onsite waste volume reduction including an energy cell.

FIG. 21B shows a conceptual diagram of an embodiment of an energy cell, as seen in FIG. 21A.

FIG. 22 shows a conceptual diagram of a waste collection container evaporating liquid from and through a plurality of evaporative materials and surfaces.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested and thus apparent to those of ordinary skill in the art. Also, descriptions of well-known functions and constructions may be omitted for increased clarity and conciseness.

In addition, it is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity and are not intended to limit the scope of the invention or the appended claims. Further, it should be understood that any one of the features can be used separately or in combination with other features. Other systems, methods, features, and advantages of the invention will be or become apparent to one with skill in the art upon examination of the detailed description. It is intended that such additional systems, methods, features, and advantages be included within this description, be within the scope of the present invention, and be protected by the accompanying claims.

This disclosure relates generally to a working combination of multiple specialized layers performing in concert to selectively remove and evaporate water from a substrate or solution which contains water while retaining any solids and dissolved or suspended impurities, while potentially controlling odor and/or pathogen transference as well.

The layers referred to in this disclosure may be categorized into three types, including evaporative layers (which may be the outermost layer), wicking layers, and odor-neutralizing layers.

Evaporative layer(s) is a hydrophilic or non-hydrophobic membrane allowing for pervaporation. It may be unsupported, or coated or adhered onto a support material. In general, materials that are involved in water or waste water treatment are typically hydrophobic in order to prevent biofouling and/or repel the formation of biofilms, as biofouling or biofilms degrade the performance of the corresponding systems and leads to higher maintenance frequencies and cost. However, the use of hydrophobic materials also necessitates a mechanical force to push water through such materials which increases operational costs and inefficiencies. In this example, this material does not experience significant biofouling or significant formation of biofilms while also allowing efficient water absorption without the need for mechanical force given its inherent water attracting and absorbing properties. In short, as a result, the benefits of the described hydrophilic or non-hydrophobic material is that it enables efficient water/waste water separation or water/waste water treatment at low cost and low maintenance. Membrane materials capable of pervaporation for this purpose may include but are not limited to a copolyetherester elastomer, a polyether-block-polyamide, a polyether urethane, homopolymers or copolymers or polyvinyl alcohol, or mixtures thereof.

A wicking layer may include a sheet of paper or textile, woven or nonwoven, with capillary properties that allow for the absorption of moisture, distribution of moisture across a broader surface area, potentially vertically against gravity, and the release of moisture to the evaporative layer and/or surrounding air. The wicking layer may be treated, coated and/or impregnated with additives, for example hydrogels may be impregnated into the wicking layer to improve moisture absorption while a hydrophobic coating may be selectively applied to promote the release of moisture.

An odor-neutralizing layer may include a sheet which may be made of paper or a textile, woven or nonwoven, as well, however with additives to trap and prevent the spread of odors. Potential additives in the odor-neutralizing layer include but are not limited to granulated activated carbon and/or silica gel. In some embodiments, the odor neutralizing layer may take the form of a wicking layer that has been treated with an odor-neutralizing additive, and/or impregnated with an odor-neutralizing material. Similarly, some odor-neutralizing layers may possess wicking properties as well, aiding in the removal of moisture as well as odor control.

### I. Arrangement of Example Embodiments

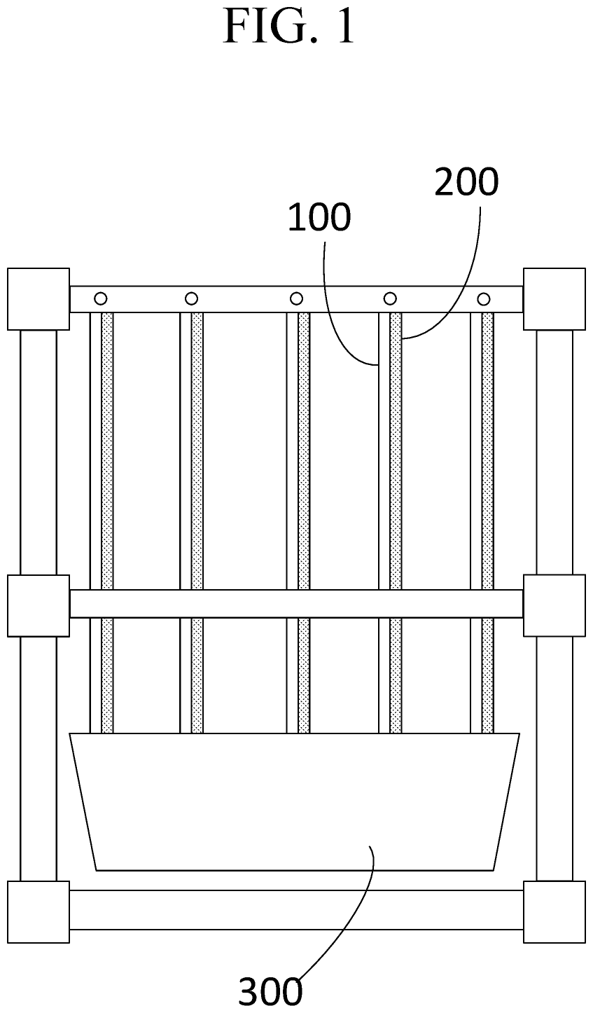

FIG. 1 is a side view of an example apparatus in which passive dewatering layers are secured in an example functional arrangement. Referring to FIG. 1, a structural apparatus supports an evaporative membrane 300 which has been made into a three dimensional bag by means of heat sealing, though other waterproof methods may be used. In this example, the evaporative membrane 300 is a bag, but this disclosure is not limited thereto. The bag is kept open by the apparatus to allow the addition of moisture-containing media and to provide access for the one or more wicking layers 100 and the one or more odor-neutralizing layers 200. For each wicking layer 100, there may be one odor-neutralizing layer 200 and in each pair, the wicking layer 100 and odor-neutralizing layer 200 may be kept in direct contact with one another along one face. The number of pairs may vary based on the application size-any number of pairs may be used and the layers do not need to be used in pairs. The evaporative membrane 300 contains a liquid media, from which the wicking layers 100 and odor-neutralizing layers 200 absorb moisture and spread it vertically to dry portions of the layers without making direct contact with the evaporative membrane 300.

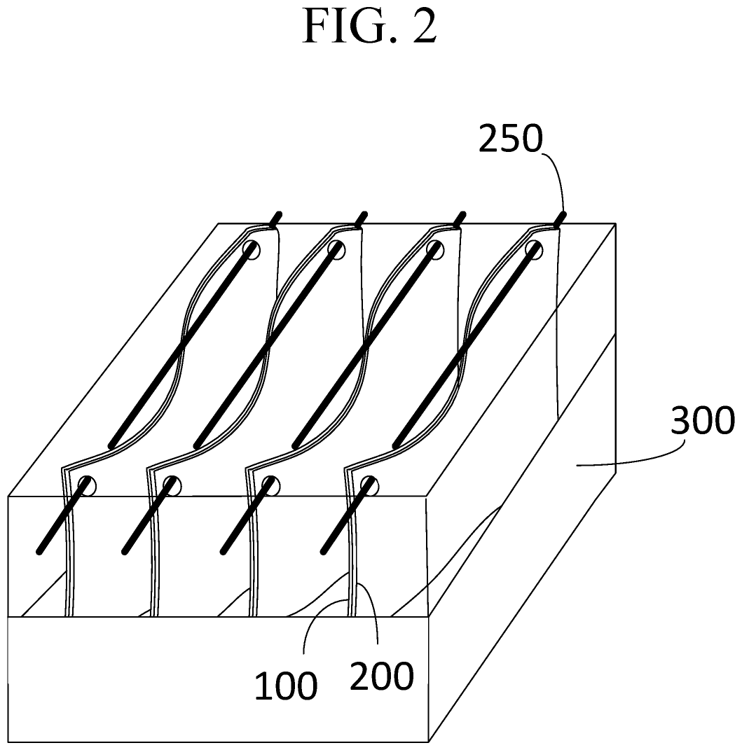

FIG. 2 is an angled overhead view of the example apparatus shown in FIG. 1, showing the points of contact between each layer. Referring to FIG. 2, in this example, each pair of a wicking layer 100 and an odor-neutralizing layer 200 are suspended by rods 250 into the evaporative membrane 300 bag. The wicking layer 100 and odor-neutralizing layer 200 in each pair are kept together at the point of suspension and may lose contact with one another at some point below this, though the layers may be optionally kept in full contact by several methods, including but not limited to stapling, sewing or adhesives. The wicking layer 100 and odor-neutralizing layer 200 pairs may optionally be adjusted so the bottom of each layer makes contact with the evaporative membrane 300, which can be achieved by lowering the height of the rods 250 or by cutting the wicking layers 100 and odor-neutralizing layers 200 longer.

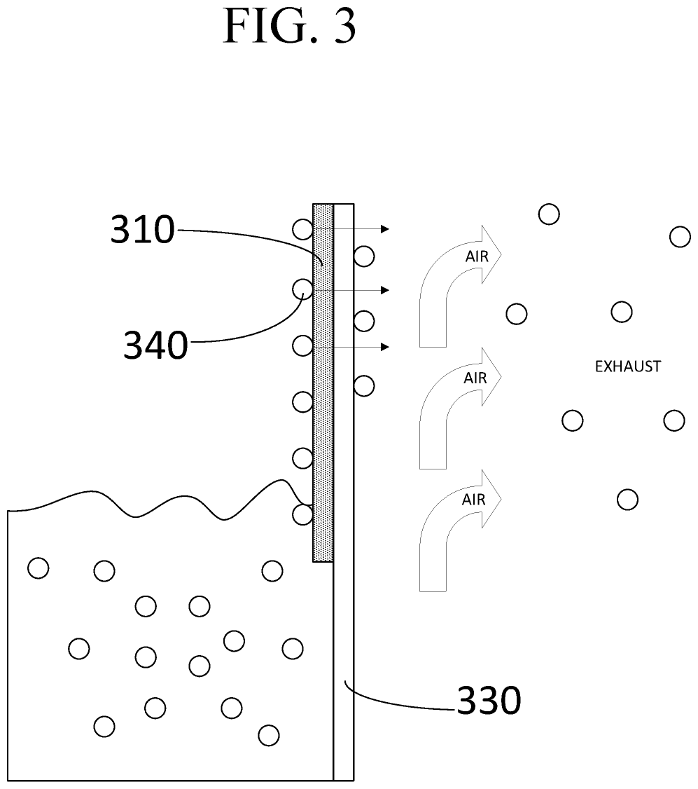

FIG. 3 is a conceptual diagram demonstrating the movement of water molecules in one potential arrangement of layers. Referring to FIG. 3, a wicking layer 310 may be kept in direct contact with an evaporative membrane 330. In this example, the wicking layer 310 is partly submerged in the moisture-containing media, and the layer absorbs water molecules 340 while spreading them vertically to dry portions of the evaporative membrane 330. Despite not making contact with the moisture-containing media, the area of the evaporative membrane 330 which is kept in contact with the wicking layer 310 is able to absorb water molecules 340 from the wicking layer 310 and transport them through the evaporative membrane 330 to be released on the other side as water vapor.

As detailed above, the arrangements provided in FIGS. 1-3 are merely example arrangements for the passive dewatering layers of the present application, and it should be appreciated that the use of two or more of these described evaporative, wicking, and odor-naturalizing layers may be provided in many alternative arrangements as described throughout this disclosure. That is, due to the tunability of this disclosure—for example the ability to resize, reshape or offset individual layers to maximize moisture removal based on properties, the option to add or remove odor-neutralizing layers when necessary—it may visually take on many forms. Similarly, the application may affect the size (or compactness) and shape or dimensions of the overall system and/or individual layers.

For example, an application for drying sludge may involve a large evaporative layer with a small wicking layer that avoids contact with the bottom where solids are expected to settle so as to avoid clogging or fouling of the wicking layer, and where an odor-neutralizing layer is kept in full direct contact with the wicking layer due to the odorous nature of the substrate, while an application for concentrating fruit juice may use a large evaporative layer, a larger wicking layer with substantial direct membrane contact and no odor-neutralizing layer. Another application may involve multiple wicking layers and an evaporative layer that are not in direct contact, where the evaporative layer serves to both dewater and contain the substrate being dried while the wicking layer further removes water by spreading the moisture across the wicking layer surface area, allowing water vapor to evaporate into the surrounding air on both sides of the wicking layer. Whether or not any two or more layers are in contact during use, as well as the degree of surface-area contact between layers—for example full or partial contact between layers—may depend on the specific application and substrate, as potential substrates differ in qualities including but not limited to homogeneity, salt content, water content, water retention properties, surface texture and smoothness. Such substrate properties may affect the ability of moisture to efficiently pass between layers, and as a result may influence the placement of layers with respect to each other. For example, in an application for concentrating sea water, the wicking layer(s) may be positioned to draw liquid out of the substrate or solution being dried without making direct contact with the evaporative layer, allowing moisture to be removed by the evaporative layer and wicking layers independently, but with the mutual benefit of removing water from the system and releasing it as a vapor. However, a common application may involve keeping the wicking and odor-neutralizing layers in full contact during use, which allows for the passage of moisture between layers and may improve odor-control and/or increase the volume of moisture absorbed from the substrate or solution being dried. Some embodiments may include an evaporative layer that, in addition to removing moisture, also serves to contain the substrate or material being dewatered due to its non-porous or nano-porous nature, as described in the previous example.

Furthermore, the shape and size of the overall system and/or the individual layers (as well as the number of individual layers) may depend on whether the layers are being used alone or fitted into a frame or an apparatus. The evaporative layer, which may serve as the outermost layer, may be shaped to accommodate the specific application. Depending on the material or combinations of materials selected for use in the evaporative layer(s), potential methods for shaping this layer may include heat-sealing, blow-molding, the use of adhesives or rigid clamps, and more. Potential shapes for this outermost layer include but are not limited to bags, pockets, hollow tubes or channels. The evaporative layer may also be draped or used to line a container, without the need for shaping.

This combination and arrangement of materials may be used alone, with or without structural support—for example a frame to maintain rigidity and/or a mesh cradle to support the weight of the substrate—or within a larger moisture-removal system which may include features such as added heat, pressure or ventilation/airflow or may employ multiple setups (tuned differently, different specifications) for separate or heterogeneous material streams—for example, an application where moisture is removed from combined food waste may include two distinct arrangements, one optimized for liquids and one for solids, with separate inlets for each setup, or a single inlet which uses a liquid-solid separation method to direct each of the two streams to the appropriate setup, to remove moisture from liquid and solid food wastes more efficiently in separate setups, as well as reduce the potential odor from microbial activity between the two.

Despite differences in appearance between potential embodiments, this disclosure pertains to the working combination of specialized layers to draw moisture from a source material, transport that moisture across a distance, often against gravity, and distribute it across a greater surface area from which it may evaporate more easily into the surrounding air. This can be compared to the fundamental mechanism by which moisture from soil enters a plant through its roots, travels vertically up the stem via capillary action, and distributes through the vasculature of leaves, covering the most allowable surface area before it is released as water vapor. In this analogy, the soil may be whatever wet substrate is being dried, while the wicking layer takes on the role of the roots and stem to absorb moisture from the substrate and channel it vertically against gravity, again taking advantage of capillary action and the adhesive/cohesive properties of water. The role of leaves to release vapor into the atmosphere is shared by a wicking layer and an evaporative layer, as the wicking layer spreads moisture across a broader portion of the evaporative layer's interior and allows for efficient diffusion across a much greater surface area. Though this analogy is a simplification of each component's total contribution to the system, it is biomimicry or the biological model from which this system is conceived and the layers are arranged and interact for the purpose of efficiently transporting and evaporating moisture.

In an example, additional power may supplied for heat, and airflow/ventilation or pressure may applied on the membrane surface. In another example, a filtration of liquid media may be applied before the liquid comes into contact with the wicking or evaporative layers. In another example, a UV disinfection may be included with the described passive dewatering layers.

One embodiment (for example for mixed waste) may include an evaporative layer formed into a bag, by means of heat-sealing, that is secured into a frame with a rigid rim and flexible mesh bottom to maintain the bag's shape and keep it open while providing weight support and puncture resistance, where the bag also serves to contain the media being dried, where one or more wicking and odor-neutralizing layers are suspended into the bag from above without making contact with the evaporative layer, where every wicking layer is paired with one odor-neutralizing layer with which it is kept in direct contact, as in FIG. 1.

In this example, one or more pairs of wicking and odor-neutralizing layers may be in full or partial contact with the evaporative layer, as illustrated in FIG. 3. In this example, the evaporative layer may be PEBAX® 1074, the wicking layer may be ONYX Desiccant Paper or Wood Cellulose Absorptive Media, and the odor-neutralizing layer may be Cellulose Activated Carbon Media, also from ONYX

Another embodiment (for example for separate solid and liquid waste streams) may include two evaporative layers made into bags by means of heat-sealing, with both bags secured into separate frames with a rigid rim and flexible mesh bottom to maintain the bags' shapes and keep them open while providing weight support and puncture resistance, where one bag is designated for solid media and the other for liquid media, where both bags also serve to contain the media being dried, where one or more wicking and odor-neutralizing layers are suspended into the bags from above without making contact with the evaporative layers, where every wicking layer is paired with one odor-neutralizing layer and are kept in direct contact.

In this example, one or more pairs of wicking and odor-neutralizing layers may be in full or partial contact with the evaporative layer.

In this example, only the liquids bag may use suspended wicking and odor-neutralizing layers while the solids bag may be made up of the evaporative layer only.

Another embodiment (for example, for combined waste that is separated into distinct solid and liquid waste streams) may include two evaporative layers made into bags by means of heat-sealing, with both bags secured into separate frames with a rigid rim and flexible mesh bottom to maintain the bags' shapes and keep them open while providing weight support and puncture resistance, where one bag is designated for solid media and the other for liquid media, where both bags also serve to contain the media being dried, where a liquid-solid separation method is used to physically segregate the added media into distinct liquid and solid streams before entering the bags respectively designated for liquid and solid material streams, where one or more wicking and odor-neutralizing layers are suspended into the bags from above without making contact with the evaporative layers, where every wicking layer is paired with one odor-neutralizing layer and are kept in direct contact.

In this example, one or more pairs of wicking and odor-neutralizing layers may be in full or partial contact with the evaporative layer.

In this example, only the liquids bag may use suspended wicking and odor-neutralizing layers while the solids bag may be made up of the evaporative layer only.

In this example, the liquid media component, once separated from the combined waste, may be filtered for particulates and dissolved ions before entering the liquids bag.

In this example, one or more fans may be implemented for improved airflow across one or more layers of the system, including an evaporative layer, a wicking layer and/or an odor-neutralizing layer, as well as for the improved ventilation and removal of moisture-containing air.

In this example, the air flowing out of the system may be filtered to control odor.

In this example, the entire system may be contained within a rigid shell, for example acrylic or polyethylene, to restrict and control airflow and to protect the interior from insects and other pests.

### II. Example Operation of Layers

This disclosure pertains to the working combination of multiple specialized layers performing in concert to selectively remove and evaporate water from a substrate or solution which contains water while retaining any solids and dissolved or suspended impurities, while potentially controlling odor and/or pathogen transference as well.

The layers referred to in this disclosure may be categorized into three types, including evaporative layers, wicking layers and odor-neutralizing layers. In many embodiments, an evaporative layer serves as the outermost layer.

The evaporative layer or layers in this disclosure remove moisture by means of pervaporation, which is the process in which a particular solvent is absorbed into a membrane on one side, transported across the membrane and released on the other side in vapor form. In this disclosure, the solvent is water, for which non-porous hydrophilic membranes are the most suitable pervaporation material due to their high affinity for water and high rejection rate of dissolved or suspended impurities, allowing moisture to be readily absorbed, transported across and released by the membrane. In pervaporation membranes, water vapor preferentially passes through while dissolved salts, as well as suspended particulates, are retained. For this reason, pervaporation may be viewed as similar to filtration, though pervaporation is unique in that it offers higher rejection rates of dissolved ions and because the solvent is released as a vapor rather than a liquid.

The wicking layer or layers absorb moisture and, taking advantage of the capillary effect, wick (or transport) it to the surrounding portions of the wicking layer, potentially vertically against the force of gravity, spreading the moisture across a broader surface area while continuously drawing water from the material being dried. When a wicking layer is kept in direct contact with an evaporative layer, the evaporative membrane absorbs the moisture contained in the wicking layer, transporting it across the evaporative membrane and releasing it as a vapor on the other side. Because the evaporative membrane alone is only able to absorb moisture from media that is in direct contact with the membrane surface, pervaporation does not occur in areas of the evaporative layer that remain dry. However, by lining an evaporative membrane with a wicking layer to distribute moisture across a greater surface area, more of the evaporative membrane's surface area is capable of absorbing and transporting moisture at a given time, resulting in more efficient moisture removal per square inch of membrane used. Moreover, due to the distribution of moisture across a broad surface area, any side of a wicking layer that is not in contact with the membrane may release water vapor into the air by means of standard evaporation, provided air flow is sufficient. A wicking layer alone is therefore capable of removing moisture from a medium via absorption and air drying, though the interplay between a wicking and evaporative layer often results in a higher rate of overall moisture removal.

While moisture removal from gaseous materials may require additional containment measures, the use of this system is fundamentally the same for the dewatering of solid, liquid and gaseous media, or combinations thereof. Moisture-containing media (where water is one of two or more components—i.e. dissolved ions or suspended solids if a liquid, any other components if it's a solid) is placed or deposited into a non-porous or micro-porous evaporative membrane, which serves to contain the media. Once moisture from this media comes into contact with the evaporative membrane and/or wicking layer or layers, the membrane begins to preferentially absorb water molecules as part of the pervaporation process, while the wicking layer or layers absorb bulk moisture and distribute it across a larger surface area. In embodiments where the evaporative membrane and wicking layer are arranged so that they make full contact along one face (as seen in FIG. 1), the moisture distributed by the wicking layer may be absorbed by the evaporative layer and released on the other side by means of pervaporation.

The rate at which water pervaporates through the hydrophilic evaporative membrane depends, among other factors, on the moisture content on the non-water side of the membrane, with moisture being released on the non-water side at a faster rate when that side is under dry or less humid conditions. This can be controlled by blowing air or another gas across the non-water side of the membrane to reduce the concentration of moisture in the surrounding air, or by using desiccant materials on the non-water side.

The rate of pervaporation can further be controlled by a number of methods, including but not limited to changing the temperature of incoming moisture-containing media, filtering the moisture-containing media and changing the thickness and/or composition of one or more evaporative membrane layers. When the moisture-containing media is heated and/or filtered to remove suspended or dissolved impurities before coming into contact with the evaporative membrane, the moisture vapor transmission rate is often increased, and filtration may reduce the risk of clogging in the wicking layer or layers and/or fouling on the evaporative membrane surface, both of which may influence moisture-removal performance. Evaporative membrane thickness is often inversely proportional to the rate of moisture vapor transmission, i.e. moisture is removed faster by thinner membranes, though membrane thickness is directly proportional to puncture and tear resistance, therefore both must be considered when choosing membrane thickness.

An important feature of this combination of layers is that the wicking layer or layers may absorb other impurities that are dissolved or suspended in the water being removed, including but not limited to dissolved salts, suspended particulates or emulsions such as oils or greases, while the evaporative membrane selectively discriminates against their passage. Since the outermost layer may be an evaporative layer, this means only water vapor exits the system via pervaporation, while all other components are retained within. Because the moisture exits as high purity water vapor, it can be captured and condensed for re-use or it can be harmlessly absorbed into surrounding air without the need for collection or disposal. Furthermore, the process of selective discrimination occurs at room temperature and without pressure applied across the membrane, meaning the wicking, selective absorption and vaporization of water are all passive processes within this disclosure and do not require the addition of energy.

Because the moisture exits as water vapor, it can either be emitted or discharged from the system as harmless, molecular water vapor to the surrounding air or it may be captured, harvested and/or used for any applications that require clean, molecular water, including but not limited to hydration or rehydration for various applications (for example, dried foods, pharmaceuticals and other dried matter), or providing moisture (for example, to plants, possibly in an enclosed growth chamber such as a greenhouse), or to a hygroscopic medium (for example, for agricultural or environmental conditioning applications).

Additionally, the high purity water vapor collected from the moisture removal and separation system may be harvested and condensed into potable or pure liquid water, which may also be alternatively used for any application requiring suitably clean or ultra-purified water, including but not limited to agriculture, food production, washing, industrial production, consumption, atmospheric water generation and the like. Condensation of water vapor into liquid water can be achieved actively, e.g. via active cooling, and/or passively using methods including but not limited to passive cooling, convection, wicking surfaces, vapor capture and/or hygroscopic media. The ability to collect and condense potable water from the moisture removal and separation system may be useful for off-grid applications, including but not limited to remote or off-shore contexts where safe drinking water is generally not accessible and is therefore required to be generated or transported and often amounts to a significant weight, volume and cost. Furthermore, the ability to generate potable, usable and/or suitably clean water from other water or wastewater sources, as well as from seawater, brackish water, brine or any contaminated or other water source, may be very useful in emergency situations such as after a natural disaster or in humanitarian contexts where potable, usable or suitably clean water may be scarce.

In some non-limiting example embodiments or approaches of harvesting, condensing and/or capturing the water vapor (as discussed above): as water vapor passes through the outermost membrane of the moisture removal and separation system, it may be vented into an enclosed collection well with a dome-like top wherein the internal humidity rises until water vapor condenses as droplets on the dome-like or other shaped top and/or surface before rolling down into the collection well as a liquid. Another embodiment involves the moisture removal and separation process taking place entirely within the water collection well. This method may be performed passively at ambient conditions or with low temperatures applied to the outside of the collection well, which may increase the rate of condensation. Additionally, the liquid water in the collection well may serve as a heat sink, which is a heat reservoir that can absorb an arbitrary amount of heat without significantly changing temperature, which would serve to pull heat from incoming water vapor thus increasing the rate at which it condenses. Alternative methods for the condensation of this moisture include venting it through a condensation jacket, which flows cold water across the vapor stream to pull heat from moisture and cause it to change phase, superhydrophilic surfaces and/or coatings, including but not limited to those treated with plasma, ultraviolet irradiation or anodization, which attract and promote cohesion among water molecules, resulting in condensation. Additionally, ultra/superhydrobic surfaces and/or coatings and/or omniphobic surfaces and/or coatings may be used.

By collecting or otherwise utilizing the moisture vapor generated by this system, potable water free of microbiological activity may be generated from any water source, including but not limited to wastewater, seawater, brackish water, at any scale. This may be performed with minimal energy or equipment requirements when compared to other such methods for desalinating seawater or contaminated water, including but not limited to reverse osmosis, electrodialysis and multiple effect distillation. Additionally, this allows potable water to be recovered directly from a separate moisture removal application. Though the pervaporation and condensation of moisture may be performed passively and at ambient conditions, active methods may be applied to the membrane, including but not limited to heat and/or pressure to increase the moisture vapor transmission rate, and to the collection well, including but not limited to low temperatures to increase the rate of condensation.

The evaporative layer is a non-porous or nano-porous membrane that is hydrophilic, meaning the membrane absorbs water and allows it to pass through. When a humidity gradient exists on one side of the membrane, the moisture absorbed from the more humid side may diffuse through the membrane's thickness to be released on the less humid side. Hydrophilic membranes, hereinafter referred to as membranes in this disclosure, feature sufficiently high water vapor transmission rates and can include one or more individual layers made from materials including but not limited to the same or different hydrophilic polymers. Hydrophilic polymers are defined as polymers which absorb water when in contact with liquid water at room temperature, according to the International Standards Organization specification ISO 62.

Due to the non-porous or nano-porous nature of the membrane, it is able to contain the material being dried and also prevent the passage of particulates, which may include microbes such as bacteria and viruses, allowing for pathogen control in the expelled water vapor.

### III. Example Compositions and Manufacture of Layers

III. A. Evaporative Membrane

The hydrophilic polymers may be made into a membrane of any desired thickness to serve as the evaporative layer(s) in this disclosure, though a thickness between 20 and 200 micrometers is preferred for its moisture vapor transmission rates. In an example, the thickness of the evaporative layer is at least 20 micrometers, at least 30 micrometers, at least 40 micrometers, at least 50 micrometers, at least 60 micrometers, at least 70 micrometers, at least 80 micrometers, at least 90 micrometers, at least 100 micrometers, at least 110 micrometers, at least 120 micrometers, at least 130 micrometers, at least 140 micrometers, at least 150 micrometers, at least 160 micrometers, at least 170 micrometers, at least 180 micrometers, at least 190 micrometers, at least 200 micrometers, at most 20 micrometers, at most 30 micrometers, at most 40 micrometers, at most 50 micrometers, at most 60 micrometers, at most 70 micrometers, at most 80 micrometers, at most 90 micrometers, at most 100 micrometers, at most 110 micrometers, at most 120 micrometers, at most 130 micrometers, at most 140 micrometers, at most 150 micrometers, at most 160 micrometers, at most 170 micrometers, at most 180 micrometers, at most 190 micrometers, or at most 200 micrometers. Several methods for manufacturing a membrane from hydrophilic polymers are available, though melt extrusion is the preferred process for obtaining a homogenous film due to the ease of adjusting membrane thickness and the dimensions of the extruded film. In short, melt extrusion is the process by which a polymer is heated above its melting point, forced through a flat or annular die and shaped, typically into a flat sheet using a roller system or into a tube or sleeve that is open at one end via blowing. Melt-extrusion of flat membrane sheets is preferred in many applications as it allows for the outermost evaporative layer to be constructed into more diverse shapes once formed. Methods for shaping the membrane include but are not limited to heat sealing, adhesives and/or clamps, provided they are not compromised by moisture and restrict the flow of water.

An evaporative membrane may include one or more individual layers of hydrophilic polymer (the same or different polymers), and those layers can also be a co-extrusion of two or more polymers in which two layers are extruded separately and melted together, or a blend in which two or more polymer resins are blended together before extrusion as a single layer.

Due to the need for this membrane to remain free of holes and resistant to punctures and tears during use, reinforcement techniques such as re-annealing or laminating membranes can strengthen membrane and patch any holes that may have been created during the extrusion process (or whatever process is used to obtain a film). The membrane can also be coated on or adhered to a support material, though blocking sections of the evaporative layer's exterior may result in reduced pervaporation performance in those spots. Common support materials include but are not limited to fabrics and papers, including woven, nonwoven and bonded varieties of both) and screens made from water vapor permeable polymers such as polyethylene, polypropylene, or fiberglass.

The hydrophilic polymer can be one or a blend of two or more polymers. Useful membrane material options for this application include but are not limited to copolyether elastomers or mixtures of two or more copolyether elastomers, such as those available from E.I. du Pont de Nemours and Company under the trade name HYTREL®, as well as polyether-block-polyamides or mixtures of two or more polyether-block-polyamides, such as those available from Arkema under the trade name PEBAX®. Other hydrophilic polymers such as a polyether urethane or a mixture of polyether urethanes, homopolymers or copolymers of polyvinyl alcohol or a mixture of homopolymers or copolymers of polyvinyl alcohol may also be suitable materials for the hydrophilic membrane or membranes in this disclosure.

A preferred polymer for the evaporative membrane layer in this disclosure is a polyether-block-polyamide, specifically PEBAX® MV 1074 (or a mixture of polyether-block-polyamides where PEBAX® MV 1074 is one component, including ultraviolet-resistant variants and variants where the ratio of polyether to polyamide is modified to bring about different membrane properties), having a sufficiently high moisture-vapor transmission rate at atmospheric conditions and demonstrating good tear resistance and ease of shaping via heat sealing once formed. Other hydrophilic polymers with similar properties preferred for the evaporative membrane include PEBAX® MI 1657, PEBAX® MV 3000 and PEBAX® RNEW®/PEBAX® 30R51, as well as ultraviolet-resistant variants of the aforementioned materials, and variants of the aforementioned materials where the ratio of polyether to polyamide is modified to bring about different membrane properties, and combinations thereof.

Depending on the application, the polymer from which the evaporative membrane is made may be compounded with additives for cosmetic or functional purposes, including but not limited to dyes or pigments, ultraviolet stabilizers for improved ultraviolet protection and anti-microbial reagents.

III. B. Wicking Layer

Due to the variety of materials that may include the wicking layer or layers, a number of distinct methods may be used to produce them. If a textile or fabric is used, it may be woven or nonwoven, and may take the form of a typical fabric layer. Synthetic fabrics, for example polyester, may be preferred for their moisture transport and release properties, though natural materials may be used, including but not limited to cotton or bamboo. Specialty papers are also an option and may be preferred due their rigidity compared to fabrics, as well as their small comparative thickness (preferably in the range of 0.2 to 6.0 millimeters thick). In an example, the thickness of the wicking layer is at least 0.2 millimeters, at least 0.25 millimeters, at least 0.5 millimeters, at least 0.75 millimeters, at least 1 millimeters, at least 1.25 millimeters, at least 1.50 millimeters, at least 1.75 millimeters, at least 2 millimeters, at least 2.25 millimeters, at least 2.50 millimeters, at least 2.75 millimeters, at least 3 millimeters, at least 3.5 millimeters, at least 4 millimeters, at least 4.5 millimeters, at least 5 millimeters, at least 5.5 millimeters, at least 6 millimeters, at most 0.2 millimeters, at most 0.25 millimeters, at most 0.5 millimeters, at most 0.75 millimeters, at most 1 millimeters, at most 1.25 millimeters, at most 1.50 millimeters, at most 1.75 millimeters, at most 2 millimeters, at most 2.25 millimeters, at most 2.50 millimeters, at most 2.75 millimeters, at most 3 millimeters, at most 3.5 millimeters, at most 4 millimeters, at most 4.5 millimeters, at most 5 millimeters, at most 5.5 millimeters, or at most 6 millimeters. Many papers are also biodegradable, which may be preferable in applications where the wicking layer is disposable.

Paper for the wicking layer or layers may be manufactured using the same processes used in standard papermaking, i.e. pulp is pressed into sheets which are then dried and cut to shape. Common paper materials for this application include but are not limited to cotton and cellulose fiber, which may be formulated to include additives for improved absorption or moisture retention, including but not limited to silica gel or hydrogels. Similarly, hydrophilic and/or hydrophobic additives or spray coatings may be applied to the paper's surface to control the direction of wicking. Paper for wicking may be die-cut into almost any shape, allowing the paper wicking layer or layers to conform to any application.

Preferred wicking materials may include Desiccant Paper and wood cellulose absorptive paper, both of which are available through Onyx Specialty Papers, but this disclosure is not limited thereto.

III. C. Odor-Neutralizing Layer

The processes by which odor-neutralizing layers are made are similar to those for wicking layers. Papers may be manufactured from cellulose fiber blended with an odor-neutralizing agent, including but not limited to activated carbon, zeolite or kinetic degradation fluxion media (KDF media). These layers may also be produced from synthetic fibers blended with an odor-neutralizing agent, which provides more resistance against degradation and is less hospitable to microbes than cellulose fiber. In either case, the pulp may be pressed into sheets and pressed dry, after which it may be die-cut into any shape. Because moisture must be able to move between the odor-neutralizing and wicking layers for effective odor control, the odor-neutralizing layer or layers may also be capable of wicking and absorbing moisture, though to a lesser extent than the wicking layer or layers. In an example, the thickness of the odor-neutralizing layer is at least 0.2 millimeters, at least 0.25 millimeters, at least 0.5 millimeters, at least 0.75 millimeters, at least 1 millimeters, at least 1.25 millimeters, at least 1.50 millimeters, at least 1.75 millimeters, at least 2 millimeters, at least 2.25 millimeters, at least 2.50 millimeters, at least 2.75 millimeters, at least 3 millimeters, at least 3.5 millimeters, at least 4 millimeters, at least 4.5 millimeters, at least 5 millimeters, at least 5.5 millimeters, at least 6 millimeters, at most 0.2 millimeters, at most 0.25 millimeters, at most 0.5 millimeters, at most 0.75 millimeters, at most 1 millimeters, at most 1.25 millimeters, at most 1.50 millimeters, at most 1.75 millimeters, at most 2 millimeters, at most 2.25 millimeters, at most 2.50 millimeters, at most 2.75 millimeters, at most 3 millimeters, at most 3.5 millimeters, at most 4 millimeters, at most 4.5 millimeters, at most 5 millimeters, at most 5.5 millimeters, or at most 6 millimeters.

Preferred odor-neutralizing layer materials in this disclosure include Cellulose Activated Carbon Media, also available through Onyx Specialty Papers, but this disclosure is not limited thereto.

III. D. Example Assembly of Components

Due to the tunability of this disclosure, numerous combinations and permutations of layers may be used, potentially with differing degrees of contact. In an example, the evaporative membrane is not adhered, stapled or sewn to any other layer to avoid a puncture in the membrane which may severely compromise its pervaporation performance. For this reason, the evaporative membrane may be formed into a bag or sleeve which is held open by a frame or apparatus, with the other layer or layers positioned in relation to the evaporative membrane-however, this disclosure is not limited thereto. As demonstrated in FIG. 2, pairs of wicking and odor-neutralizing layers, or two or more wicking layers, may be loosely joined together at the point of suspension (in the case of FIG. 2, a metal rod) with substantial contact being maintained due to the semi-rigidity of the wicking and odor-neutralizing layers. Furthermore, the degree of contact may be increased by joining the layers together at additional points, for example by sewing the layers together, though this may reduce the amount of airflow between layers. In an example, the ratio of evaporative layer surface area to wicking layer surface area is at least 1:3, at least 2:5, at least 1:2, at least 2:3, at least 1:1, at least 3:2, at least 2:1, at least 5:2, at least 3:1, at most 1:3, at most 2:5, at most 1:2, at most 2:3, at most 1:1, at most 3:2, at most 2:1, at most 5:2, or at most 3:1, though this ratio is modifiable based on different applications. In another example, the ratio of wicking layer surface area to odor-neutralizing layer surface area is at least 1:1, at least 3:2, at least 2:1, at least 5:2, at least 3:1, at most 1:1, at most 3:2, at most 2:1, at most 5:2, or at most 3:1.

In one example, the materials of any of the evaporative membrane layer, the wicking layer, and the odor-neutralizing layer may be provided as a composite material, i.e. a material formed of the constituent materials of (A) the evaporative membrane layer and the wicker layer; (B) the evaporative membrane layer and the odor-neutralizing layer; (C) the wicking layer and the odor-neutralizing layer; or (D) the evaporative membrane layer, the odor neutralizing layer, and the wicking layer. In this example, the same materials described above for each respective layer may be used. The weight ratio of the materials may include a weight ratio of evaporative layer material to wicking layer material that is at least 1:3, at least 2:5, at least 1:2, at least 2:3, at least 1:1, at least 3:2, at least 2:1, at least 5:2, at least 3:1, at most 1:3, at most 2:5, at most 1:2, at most 2:3, at most 1:1, at most 3:2, at most 2:1, at most 5:2, or at most 3:1, though this ratio is modifiable based on different applications. A weight ratio of evaporative layer material to odor-neutralizing layer material that is at least 1:3, at least 2:5, at least 1:2, at least 2:3, at least 1:1, at least 3:2, at least 2:1, at least 5:2, at least 3:1, at most 1:3, at most 2:5, at most 1:2, at most 2:3, at most 1:1, at most 3:2, at most 2:1, at most 5:2, or at most 3:1, though this ratio is modifiable based on different applications. A weight ratio of wicking layer material to odor-neutralizing layer material that is at least 1:3, at least 2:5, at least 1:2, at least 2:3, at least 1:1, at least 3:2, at least 2:1, at least 5:2, at least 3:1, at most 1:3, at most 2:5, at most 1:2, at most 2:3, at most 1:1, at most 3:2, at most 2:1, at most 5:2, or at most 3:1, though this ratio is modifiable based on different applications.

The materials of any of the evaporative membrane layer, the wicking layer, and the odor-neutralizing layer may be formed together or connected to one another in a number of different ways. In one case, these layers may be adhered together by a connecting layer, a supporting layer, or an adhesive with the function of supporting, adhering, or connecting any layer to another layer. In other examples, these layers may be co-molded, co-extruded, heat-sealed, formed together, adhered, stapled, mechanically attached, aligned, or connected in other ways. Example adhesive, supporting, or connecting materials or layers may include fabrics and papers, including woven, nonwoven and bonded varieties of both, and screens made from water vapor permeable polymers such as polyethylene, polypropylene, fiberglass, epoxy resin, or a two-compound plastic adhesive based on epoxy resin, two-part polyurethane adhesives such as Scotch-Weld by 3M (or products from Loctite or ULine), bonding films, other solvent-based approaches, or combinations thereof.

### IV. Example Advantages and Benefits

Both the wicking layers and evaporative layers transport moisture passively, without the need for specialized equipment or electricity. In example embodiments, the wicking layer works by taking advantage of capillary action and the natural adhesion/cohesion properties of water, while the pervaporation performance of the membrane is driven by a moisture gradient, where lower-humidity conditions on the outside of the membrane promote the passive release of moisture absorbed from the inside of the membrane.

Because the evaporative membrane preferentially absorbs highly dipolar molecules such as water, it may absorb water molecules that are already in a solution, bound to solid media or absorbed into a wicking layer, and the non-porous or nano-porous nature of the membrane prevents the passage of any impurities, dissolved or suspended in the source water.

Further, since water molecules diffuse through the membrane surface individually, as opposed to bulk water, the moisture that passes through may evaporate off the membrane surface into the air and be absorbed as ambient humidity, eliminating the need to contain and dispose of the water removed by the evaporative membrane.

Typical use of the described layer arrangements may include to remove moisture from moisture-containing media. This may have many practical effects depending on the nature of the media such as: (A) Reducing the mass and/or volume of media—this means less space is needed for storage and less space and fuel needed for transportation; (B) Reducing odor transmission via an odor-neutralizing layer or layers and by restricting microbial activity; (C) Reducing pathogen transmission, both in the media being dried due to a reduction in microbial activity and in the removed water vapor due to the non-porous or nano-porous nature of the evaporative membrane.

Generally, the advantages of membrane pervaporation (compared to other liquid separation measures such as distillation) may include: (A) High purity permeate (i.e. the water vapor exiting the system is nearly pure water), potentially harmful chemicals, bacteria and viruses are not present in the removed water vapor even if suspended in the source media; (B) pervaporation can be used to remove moisture from solid, liquid or gaseous media streams, or any combination thereof; (C) Pervaporation requires low or no energy, able to function with no electricity or fuel source; (D) Economical; (E) Flexibility, portability, and can be used anywhere climate is suitable (indoors or outdoors); among other advantages and benefits. It should be appreciated that the advantages and benefits described are only exemplary and non-exhaustive; other benefits and advantages may be apparent to persons of skill in the art.

V. EXAMPLE USES

Example uses for the described arrangement of layers of this disclosure include for passive dewatering and moisture removal of human waste, industrial waste, or use in personal or commercial applications such as drying, material concentration, resource recovery, separating, cooling, humidification/dehumidification, climate control applications, use in clothing, food and packaging, sludge/brine concentration or drying, construction, drying of soil or other agricultural applications, among other examples. For example, for use with human waste, the described arrangements and embodiments may be used for In-home or on-site toilets, portable toilets, camping or RV sites where waste is, or landfills and waste storage facilities to conserve space. For use with industrial waste, the described arrangements and embodiments may be used for any need to separate azeotropic mixtures, and can be less energy-intensive and more portable than distillation, dehydration with heaters/ovens. Example markets may include municipal sewage treatment, specialty waste collection/removal, bio-digestors, dumping waste, municipal sewage treatment, specialty waste collection/removal, reverse osmosis/vacuum-membrane technology.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

In one example, the present disclosure describes personal/household toilets, or toilets for use anywhere, that do not require a hookup to plumbing or a septic tank. Although a toilet is described as an example embodiment, it should be appreciated that the present disclosure may be applied to different devices for dewatering and/or evaporative containment of solid or liquid wastes. Unlike a primitive toilet/outhouse, the present disclosure describes the process of removing water from waste as soon as waste is added, releasing clean vapor that is 99.9% water while retaining bulk waste, sediment, and solutes/contaminants. This process continues as waste is regularly added and allows significant volumes of waste to be passively dewatered/dehydrated while the system enjoys regular use.

In at least some examples of the present disclosure, waste is not entirely disposed of, i.e., does not disappear per se (the final product must be collected and disposed of, or disposed of with the bag). Nonetheless, the constant removal of water will substantially reduce the weight and volume of materials already in the system, allowing more waste to be added before the bag/system is full. Furthermore, this results in a much higher density of hazardous human waste that can be transported or stored at a time when compared to untreated waste (or waste with additives, be they chemical like in a portable toilet or organic matter like an outhouse). This results in less volume being transported (less fuel, fewer trips), less space needed for waste storage, reduced sloshing/problems arising from transporting a mostly liquid haul.

In addition to reducing space and transport requirements, as well as allowing for simpler, more hygienic handling, the removal of water from both solid and liquid wastes may reduce odor transmission and the growth/spread of pathogens and bacteria. Additionally, drying may deter flies or other insects from eating the waste or laying eggs on the waste.

The drying (partial dehydration or desiccation) of human and animal waste has been proven to restrict the growth and activity of microbial pathogens. Microbial activity decreases in substrates with a moisture content below 25%, with most microbes being rendered inactive below 10%—this is true not only for stool but a number of wastes which contain organic material.

Drying may not necessarily sterilize or “kill” the microbes or their endospores, which may regrow if/when water content increases. Actual pathogen destruction may depend on a number of variables such as temperature, pH, water content and retention time. But regrowth of microbes usually takes a minimum of six months. In some examples, further treatment may be required for dried end products to be considered sterilized. The present disclosure describes reducing the likelihood of transmission during handling/removal of end products and offsets the need for further drying (which may reduce the time, required energy input or both needed to complete the process) after removal.

Similarly, removing moisture from many wastes also reduces odor transmission and severity of odor. The separation of solid and liquid waste streams into different dewatering channels (a useful technique for improving drying times and reducing biological activity/interaction between the two streams) is a valuable tool for preventing/restricting the creation of odorous byproducts which occur from mixing waste streams—a known technique used in existing urine-diverting toilets. Additionally, reducing moisture content is a useful way to inactivate bacteria and slow microbial activity, which is responsible for the generation of many offensive odors associated with human waste and a number of other organic wastes.

The non-limiting technology described here is a highly configurable evaporative sanitation system that provides an environmentally sustainable alternative to the ubiquitous water-based sanitation systems. The ability to configure the system provides high tunability enabling this technology to be used as an effective sanitation system across various climates, cultures, and geographical locations.

The technology provides a plethora of benefits including but not limited to—rapid evaporation of waste, waterless operation, chemical-free operation, odorless operation, configurable waste containment capacity, waste volume minimization, ease of installation and maintenance, operability in extreme climates, environmentally friendly.

The example embodiment uses an evaporative membrane bag along with an active ventilation system as its main driver for achieving evaporation. However, it should be appreciated that the evaporative membrane may take other forms not limited to a bag such as a tube, a layer, a sheet, or other configurations. In this example, solid and liquid waste are handled through separate paths using the same apparatus but it should be appreciated that, in other examples, an apparatus may handle only solid waste, only liquid waste, or solid and liquid waste in the same or similar paths. For example, the process may start with the separation of the two waste streams into their respective receptacles which are lined with the membrane. The membrane has a high evaporative capability which coupled with directed airflow through an exhaust fan provides rapid evaporation of the waste in the receptacles. An exhaust fan is described in one embodiment of this disclosure, but other examples may or may not use an exhaust fan. Once the waste is dried, the receptacles can be easily accessed by opening the servicing doors and rolling them out for servicing.

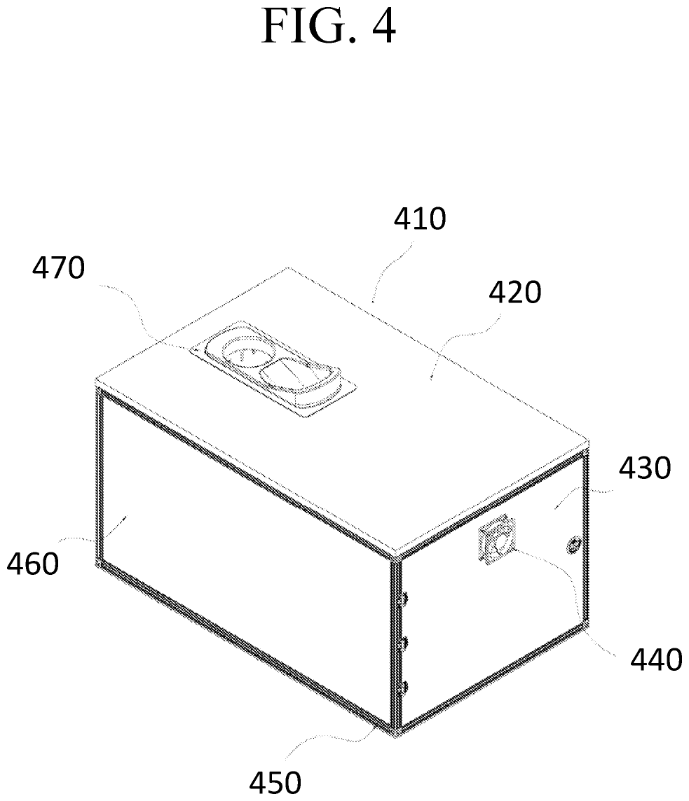

FIG. 4 shows an isometric view of an example non-limiting evaporative toilet 410. Referring to FIG. 4, the example non-limiting system 410 includes an enclosure which may be made of an inert plastic material 460 or a similar rugged, durable, inert material and supported structurally by a skeletal frame which may be made of corrosion resistant metal bars 450. The example embodiment shows the enclosure in the shape of a cuboidal box, but the size and shape of this enclosure is non-limiting. The system 410 shown here may generally be placed underneath a floor platform 420 with a waste diverting squat pan 470—in other examples, the system 410 may be placed above ground and an above ground cover or squat pan 470 may be used. The Pan 470 may have two distinct openings, with the large circular one (as illustrate in this example, other shapes and sizes may be used) used for defecation and the other declivity with a smaller opening (as illustrated in this example, other shapes and sizes may be used) at the end used for urination. The openings may each be the same or different sizes, and may have a square, circular, triangular, slit, quadrilateral, abstract, or any other shape and size. Pan 470 shown here is non-limiting in both its type and design, and variations of similarly operating apparatus that work for a sit (western) type of toilet can be used as well. Pan 470 can be made from plastic, ceramic, stainless steel or other similar materials which are inert and produce a smooth low friction surface. In this example, access to the internal system is provided by two hinged doors on the front and the back of the toilet. One of the doors 430 is shown here which houses the exhaust fan 440.

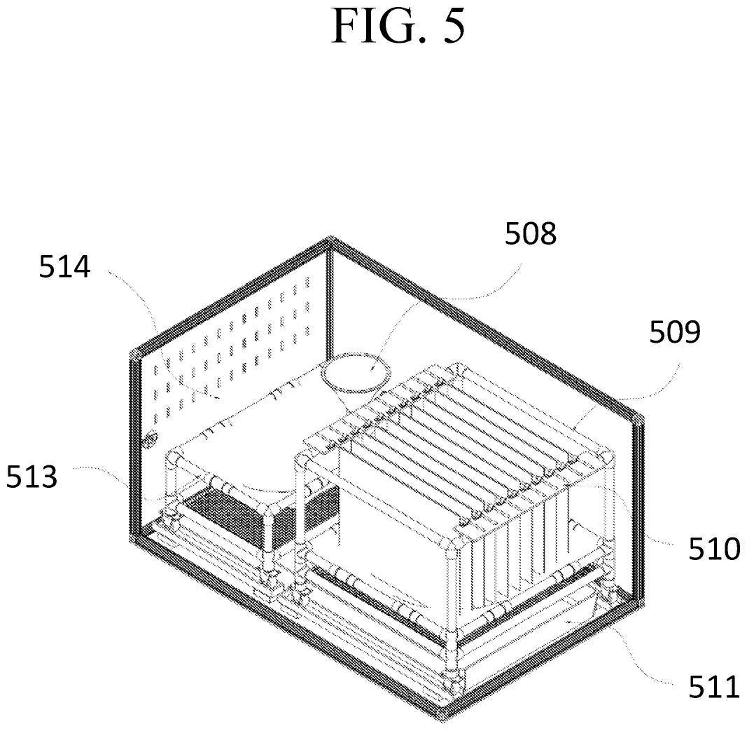

Referring to FIG. 5, two receptacles may be placed underneath the platform 420, namely a liquid receptacle 509 and a solid receptacle 513. Although two receptacles are illustrated, in other examples one or more receptacles may be used. In this example, a pre-treatment system 508 may treat the urine before depositing the urine into the receptacle 509; but in other examples a pre-treatment system 508 is not used. A suspended flaps system 510, which aids in the evaporation of the urine, may be clamped onto the liquid receptacle 509. A leak/overflow containment tray 511, which is present underneath the receptacles 509, 513, may contain the waste in case there is any spillage from the receptacles. Door 514, which in this example provides access to the solid receptacle 513 is also illustrated.

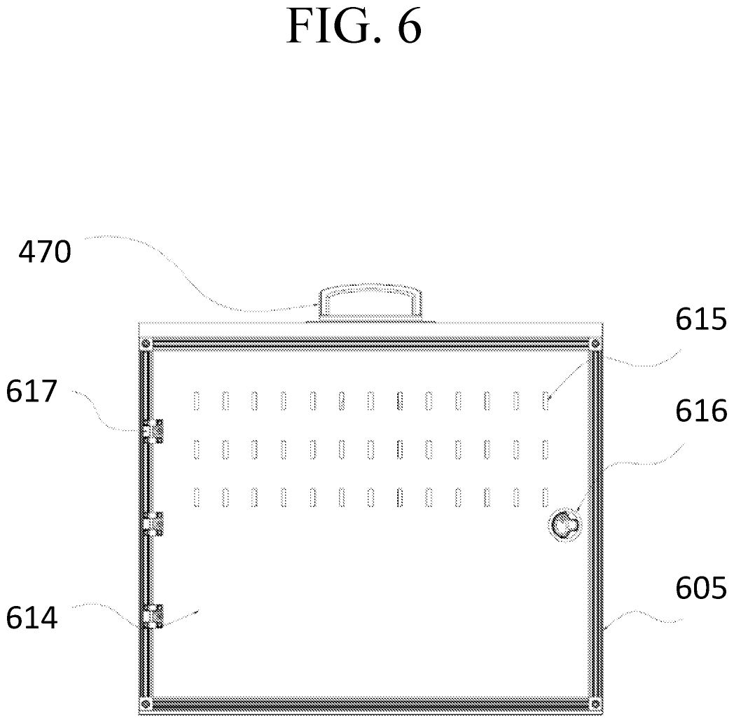

Referring to FIG. 6, in this example, door 614 is hinged to the skeletal frame 605 using hinges 617. This allows opening and closing of the door and providing access to the solid receptacle 613 for servicing or troubleshooting. A lock 616 that can double as a handle allows for easy opening of the door while also ensuring that there is no unauthorized access to the internal systems. Door 614 may also include cutouts 615 that act as inlets for airflow into the system. The number, position, and dimensions of the cutouts shown is non-limiting and they can be optimized based on the size and shape of the system 410 and other related parameters.

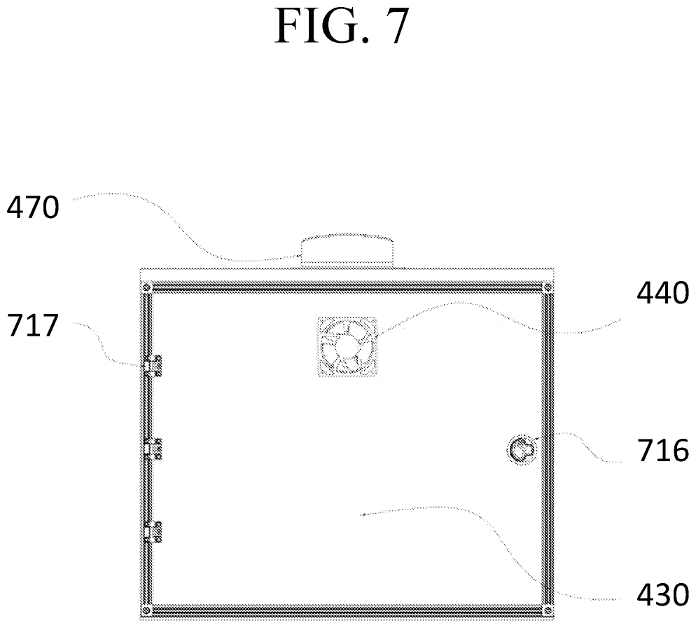

Referring to FIG. 7, door 430 may be hinged to the skeletal frame using hinges 717. In this example, door 430 may provide access to the liquid receptacle 509 along with the suspended flaps system 510, and the pre-treatment system 508. Lock 616 may be present on door 430 as well. Door 430 may have a cutout that houses the electrically powered exhaust fan 440. The size, type, power, and placement of the exhaust fan 440 is non-limiting and can be optimized based on the system; and the exhaust fan 440 may or may not be used.

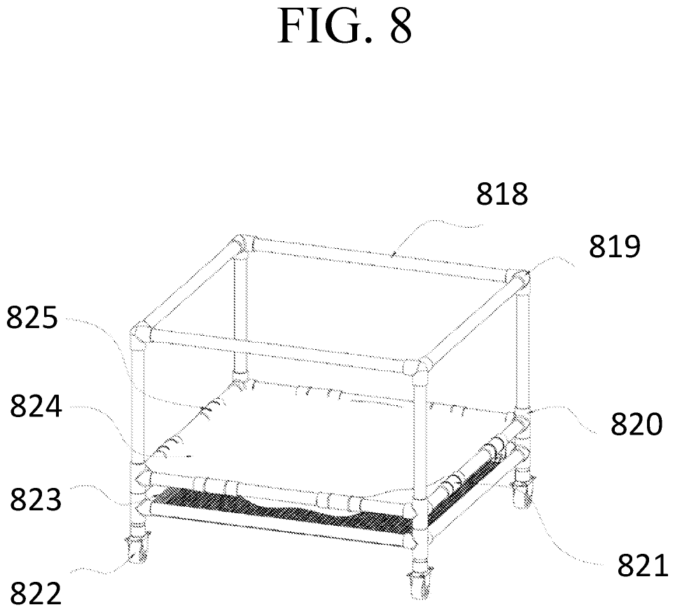

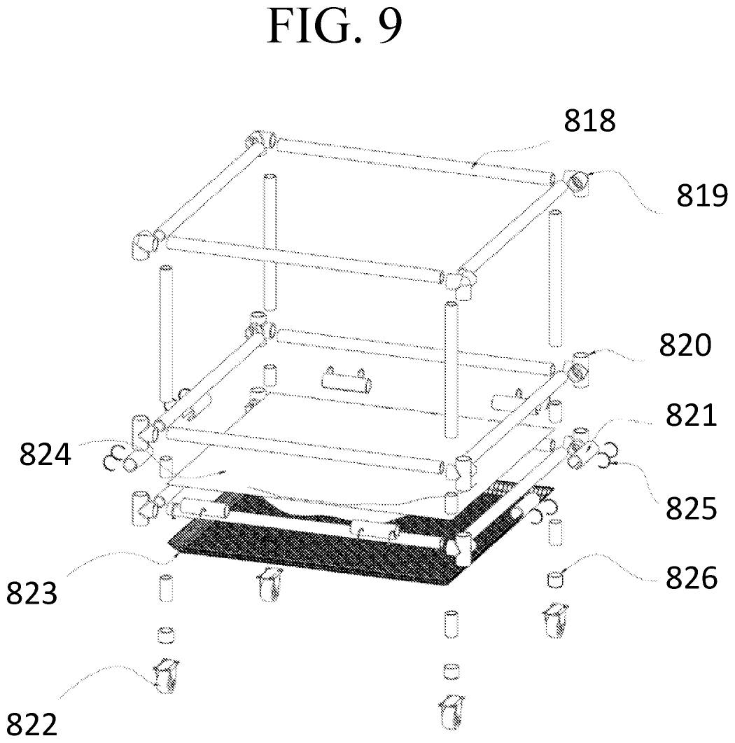

Referring to FIGS. 8 and 9, the example non-limiting liquid receptacle is a three-dimensional structural frame that contains the liquid waste and facilitates servicing of the same. In the present embodiment, it has a cuboidal/rectangular shape although any other forms that help in achieving the aforementioned functions can be considered as suitable alternatives. The structural frame of the example receptacle includes rigid plastic tubes of varying lengths 818, three-way plastic elbow connectors 819, four-way elbow connectors 820, and plastic end caps 826. All the parts may fit snugly together. In one example, the frame may be constructed by piecing together the constituent parts, press-fitting them, and applying a bonding agent, like a PVC cement in this case, to bind everything together into a single solid structural frame. The rigidity of the frame, in certain aspect, provides support for the weight of the waste over time without any deformation or failure. A membrane bag 824 may be held along the middle rungs of the frame and secured by means of silicone tubing 821 and external retainer rings 825. The silicone tubing may secure the membrane bag 824 in place without any tearing or deformation as the receptacle gets deposited with urine. The retainer rings 825 may clamp down on the silicone tubing ensuring that the membrane bag 824 does not slip from the frame as it gets heavier. The silicone tubing 821 and the retainer rings 825, in certain aspect, may provide the added benefit of easy installation and removal of the membrane bag 824 during servicing. In an example, a curved rigid mesh support 823 is secured to the bottom rungs of the frame by using zip-ties to hold them in place. An alternative method might be drilling holes along the length of the pipe and securing the mesh by screwing it against the pipe on all sides. Another method may include the use of a bonding agent like plastic cement to bond the mesh in place. Other adhesion or attachment methods may also be used. The mesh support acts as a conforming surface for the membrane bag 824 to rest on, into which the urine is deposited. The perforations inherent in the mesh provide a channel to achieve evaporation. One uni-directional caster wheel 822 each may be located on the four corners of the liquid receptacle. These wheels are screwed onto the plastic end caps 826. In certain aspect, the wheels 822 provide stability and portability to the receptacle, allowing linear motion to and from the system during its servicing.

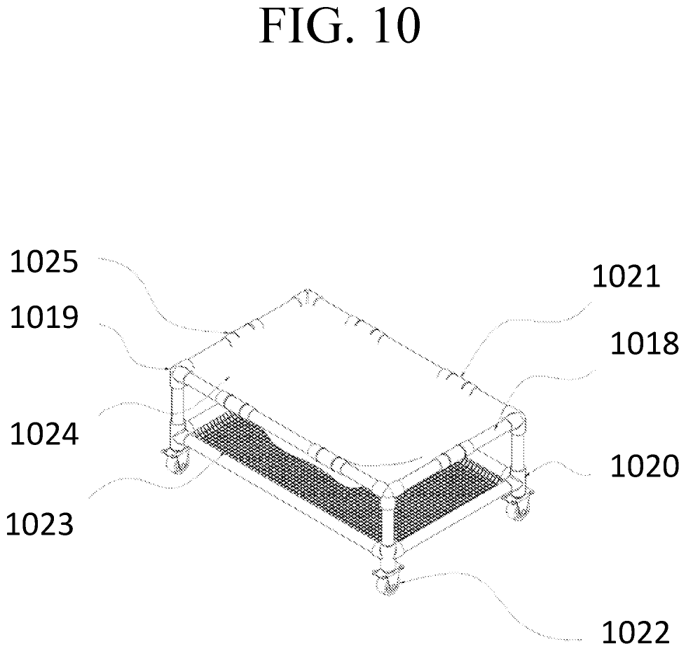

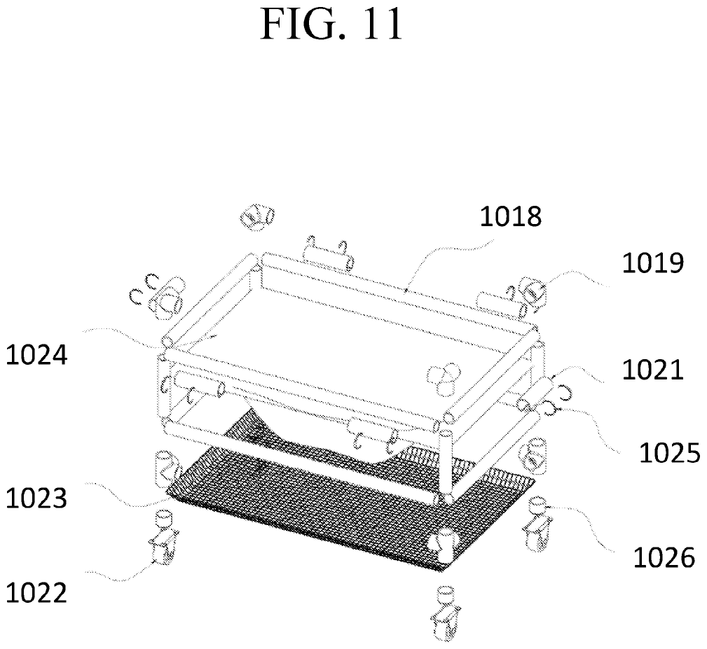

Referring to FIGS. 10 and 11, an example non-limiting solid receptacle 513 is a three-dimensional structural frame that may contain the solid waste and facilitate servicing of the same. Structurally, the solid receptacle may be similar to the liquid receptacle 509, but may be smaller in size—the receptacles 509, 513 may be interchangeable so that either may be used for solid or liquid waste, and in some examples, only one receptacle may be used. In the present embodiment, the receptacle 513 has a cuboidal/rectangular shape although any other forms that help in achieving the aforementioned functions can be considered as a suitable alternative. The structural frame of the example receptacle may include rigid plastic tubes of varying lengths 1018, three-way plastic elbow connectors 1019, four-way elbow connectors 1020, and plastic end caps 1026. In one example, all the parts fit snugly together. The frame may be constructed by piecing together the constituent parts, press-fitting them, and applying a bonding agent, like a PVC cement in this case, to bind everything together into a single solid structural frame. In certain aspects, the rigidity of the frame can provide support for the weight of the waste over time without any deformation or failure. A membrane bag 1024 may be held along the top rungs of the frame and secured by means of silicone tubing 1021 and external retainer rings 1025. The silicone tubing may secure the membrane bag 1024 in place without any tearing or deformation as the receptacle gets deposited with feces. The retainer rings 1025 may clamp down on the silicone tubing ensuring that the membrane bag 1024 does not slip from the frame as it gets heavier. In certain aspects, the silicone tubing 1021 and the retainer rings 1025 may provide the added benefit of easy installation and removal of the membrane bag 1024 during servicing. A curved rigid mesh support 1023 may be secured to the bottom rungs of the frame by using zip-ties to hold them in place. An alternative method might be drilling holes along the length of the pipe and securing the mesh by screwing it against the pipe on all sides. Another method may include the use of a bonding agent like plastic cement to bond the mesh in place. Any other adhesion or attachment methods may be used. The mesh support may act as a conforming surface for the membrane bag 1024 to rest on, into which the feces is deposited. One uni-directional caster wheel 1022 each may be located on the four corners of the solid receptacle. These wheels may be screwed onto the plastic end caps 1026. The wheels 1022 may provide stability and portability to the receptacle, allowing linear motion to and from the system during its servicing.

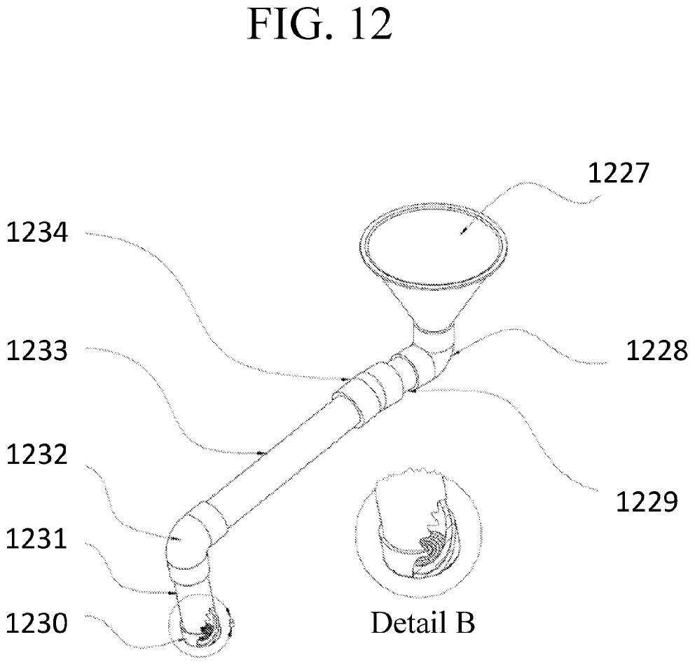

Referring to FIG. 12, the pre-treatment system shown, in this example, includes an appropriately sized plastic funnel 1227, which connects to a 900 angle plastic elbow 1228, followed by a short length of transparent plastic tubing 1229, a 450 angle plastic elbow 1234 oriented downwards, a longer length of transparent plastic tubing 1233, another 90° angle plastic elbow 1232, followed by a shorter length of transparent plastic tubing 1231, and terminating with a perforated plastic cap 1230 as shown in DETAIL B. The final length of the tubing along with the perforated plastic cap 1230 may encase a pretreatment media that filters the urine before it deposits into the liquid receptacle. The pretreatment media may be lined along an entire length of the tubing or only partially along part of the length of the tubing. In the present embodiment, the pretreatment media may include three sandwiched layers—an activated carbon-impregnated filter pad (cut to fit snugly in the tube) which catches any unwanted solids and provides adsorption of ammonia and hydrogen sulfide in the passing solution. A bed of zeolite, an ion-exchange media with a strong affinity for ammonium, readily absorbs additional ammonia from solution and a final pad adsorbs nitrite from solution and may act as an additional physical filter to prevent loss of zeolite pellets. Any similar media which perform the functions outlined above can be used as substitutes. For example, other materials may include bentonite clay, rice husks, silica gel, KDF-55, hydrogels and other materials. In an example, the perforated plastic cap 1230 may prevent the pretreatment media from shifting or falling out of the tube as the urine passes through. In certain aspects and in one example, the use of transparent tubing may provide servicers the ability to easily assess clogging and media replacement. The pre-treatment system shown here is non-limiting in its design and can be a combination of different configurations of pipes and elbows based on the size and shape of the system 410. The materials used may vary from plastics to metals, and in a preferred non-limiting example, the materials are inert, corrosion resistant, and provide little to no friction to the flow of liquid through them.

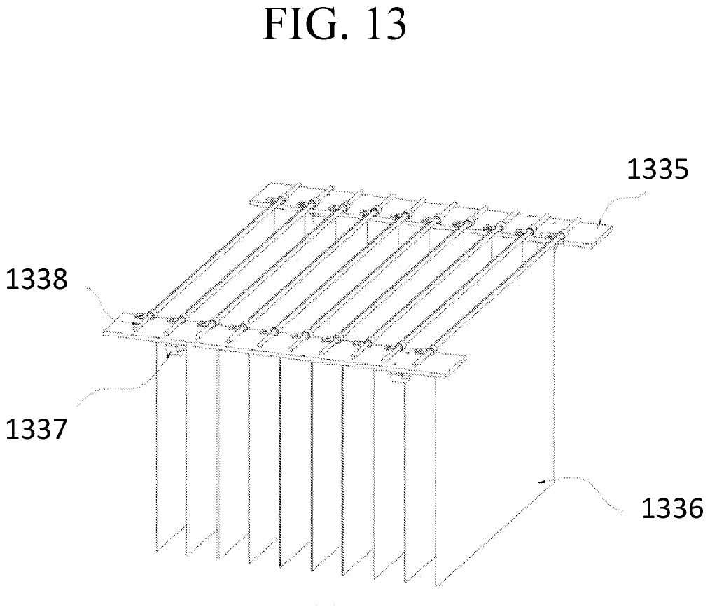

Referring to FIG. 13, the suspended flaps system shown may include two parallel plastic bars 1335 that clamp onto the topmost rungs of the liquid receptacle 509 (as shown in FIG. 5) using routing clamps 1337. Thin rods 1338, which may be made of stainless steel, may run along the length of these parallel bars. The rods 1338 may be held in place by snap-in plastic clamps. The rods can be made of any material as long as it is corrosion resistant, smooth, and allows for easy movement of the flaps across its length. Depending on the size of the receptacle, the number of rods present may vary. In the current embodiment, ten rods are present. In this example, flaps 1336 with grommets are passed through the rods 1338 and run along the entire length of rods as shown. The flaps 1336 may include two layers—a wicking layer and an embedded odor-naturalizing layer. These flaps extend below into the liquid receptacle, making contact with a membrane bag 824 and its content (as shown in FIG. 5). In this example, the wicking layer helps in aiding the evaporation and the embedded odor-naturalizing layer helps with odor mitigation. The example layers described for flaps 1336 is non-limiting, and any number, type, or combination of layers which enhance the capability of the system can be used—in fact, the system may operate with or without the use of one or more of these layers and/or membrane bag.

In this example, the one or more pairs of wicking and odor-neutralizing layers forming flaps 1336 may be in full or partial contact with the evaporative layer or membrane bag 824, as illustrated, and may be in full or partial contact with one another. For example, the evaporative layer or membrane bag 824 may be made from PEBAX® I 074, the wicking layer of the flaps 1336 may be made from ONYX Desiccant Paper or Wood Cellulose Absorptive Media, and the odor-neutralizing layer of the flaps 1336 may be made from Cellulose Activated Carbon Media, also from ONYX. But this disclosure is not limited to these materials, as detailed below.

Evaporative Membrane or Membrane Bag.

Hydrophilic polymers may be made into a membrane of any desired thickness to serve as the evaporative layer(s) in this disclosure, though a thickness between 20 and 200 micrometers is preferred for its moisture vapor transmission rates. In an example, the thickness of the evaporative layer is at least 20 micrometers, at least 30 micrometers, at least 40 micrometers, at least 50 micrometers, at least 60 micrometers, at least 70 micrometers, at least 80 micrometers, at least 90 micrometers, at least 100 micrometers, at least 110 micrometers, at least 120 micrometers, at least 130 micrometers, at least 140 micrometers, at least 150 micrometers, at least 160 micrometers, at least 170 micrometers, at least 180 micrometers, at least 190 micrometers, at least 200 micrometers, at most 20 micrometers, at most 30 micrometers, at most 40 micrometers, at most 50 micrometers, at most 60 micrometers, at most 70 micrometers, at most 80 micrometers, at most 90 micrometers, at most 100 micrometers, at most 110 micrometers, at most 120 micrometers, at most 130 micrometers, at most 140 micrometers, at most 150 micrometers, at most 160 micrometers, at most 170 micrometers, at most 180 micrometers, at most 190 micrometers, or at most 200 micrometers. Several methods for manufacturing a membrane from hydrophilic polymers are available, though melt extrusion is the preferred process for obtaining a homogenous film due to the ease of adjusting membrane thickness and the dimensions of the extruded film. In short, melt extrusion is the process by which a polymer is heated above its melting point, forced through a flat or annular die and shaped, typically into a flat sheet using a roller system or into a tube or sleeve that is open at one end via blowing. Melt-extrusion of flat membrane sheets is preferred in many applications as it allows for the outermost evaporative layer to be constructed into more diverse shapes once formed. Methods for shaping the membrane include but are not limited to heat sealing, adhesives and/or clamps, provided they are not compromised by moisture and restrict the flow of water.

An evaporative membrane may include one or more individual layers of hydrophilic polymer (the same or different polymers), and those layers can also be a co-extrusion of two or more polymers in which two layers are extruded separately and melted together, or a blend in which two or more polymer resins are blended together before extrusion as a single layer.

Due to the need for this membrane to remain free of holes and resistant to punctures and tears during use, reinforcement techniques such as re-annealing or laminating membranes can strengthen membrane and patch any holes that may have been created during the extrusion process (or whatever process is used to obtain a film). The membrane can also be coated on or adhered to a support material, though blocking sections of the evaporative layer's exterior may result in reduced pervaporation performance in those spots. Common support materials include but are not limited to fabrics and papers, including woven, nonwoven and bonded varieties of both) and screens made from water vapor permeable polymers such as polyethylene or fiberglass.

The hydrophilic polymer can be one or a blend of two or more polymers. Useful membrane material options for this application include but are not limited to copolyether elastomers or mixtures of two or more copolyether elastomers, such as those available from E.I. du Pont de Nemours and Company under the trade name HYTREL®, as well as polyether-block-polyamides or mixtures of two or more polyether-block-polyamides, such as those available from Arkema under the trade name PEBAX®. Other hydrophilic polymers such as a polyether urethane or a mixture of polyether urethanes, homopolymers or copolymers of polyvinyl alcohol or a mixture of homopolymers or copolymers of polyvinyl alcohol may also be suitable materials for the hydrophilic membrane or membranes in this disclosure.

A preferred polymer for the evaporative membrane layer in this disclosure is a polyether-block-polyamide, specifically PEBAX® MV 1074 (or a mixture of polyether-block-polyamides where PEBAX® MV 1074 is one component, including ultraviolet-resistant variants and variants where the ratio of polyether to polyamide is modified to bring about different membrane properties), having a sufficiently high moisture-vapor transmission rate at atmospheric conditions and demonstrating good tear resistance and ease of shaping via heat sealing once formed. Other hydrophilic polymers with similar properties preferred for the evaporative membrane include PEBAX® MH 1657, PEBAX® MV 3000 and PEBAX® RNEW®/PEBAX® 30R5 1, as well as ultraviolet-resistant variants of the aforementioned materials, and variants of the aforementioned materials where the ratio of polyether to polyamide is modified to bring about different membrane properties, and combinations thereof

Depending on the application, the polymer from which the evaporative membrane is made may be compounded with additives for cosmetic or functional purposes, including but not limited to dyes or pigments, ultraviolet stabilizers for improved ultraviolet protection and anti-microbial reagents.

Wicking Layer.

Due to the variety of materials that may include the wicking layer or layers, a number of distinct methods may be used to produce them. If a textile or fabric is used, it may be woven or nonwoven, and may take the form of a typical fabric layer. Synthetic fabrics, for example polyester, may be preferred for their moisture transport and release properties, though natural materials may be used, including but not limited to cotton or bamboo. Specialty papers are also an option and may be preferred due their rigidity compared to fabrics, as well as their small comparative thickness (preferably in the range of 0.2 to 6.0 millimeters thick). In an example, the thickness of the wicking layer is at least 0.2 millimeters, at least 0.25 millimeters, at least 0.5 millimeters, at least 0.75 millimeters, at least 1 millimeters, at least 1.25 millimeters, at least 1.50 millimeters, at least 1.75 millimeters, at least 2 millimeters, at least 2.25 millimeters, at least 2.50 millimeters, at least 2.75 millimeters, at least 3 millimeters, at least 3.5 millimeters, at least 4 millimeters, at least 4.5 millimeters, at least 5 millimeters, at least 5.5 millimeters, at least 6 millimeters, at most 0.2 millimeters, at most 0.25 millimeters, at most 0.5 millimeters, at most 0.75 millimeters, at most 1 millimeters, at most 1.25 millimeters, at most 1.50 millimeters, at most 1.75 millimeters, at most 2 millimeters, at most 2.25 millimeters, at most 2.50 millimeters, at most 2.75 millimeters, at most 3 millimeters, at most 3.5 millimeters, at most 4 millimeters, at most 4.5 millimeters, at most 5 millimeters, at most 5.5 millimeters, or at most 6 millimeters. Many papers are also biodegradable, which may be preferable in applications where the wicking layer is disposable.

Paper for the wicking layer or layers may be manufactured using the same processes used in standard papermaking, i.e. pulp is pressed into sheets which are then dried and cut to shape. Common paper materials for this application include but are not limited to cotton and cellulose fiber, which may be formulated to include additives for improved absorption or moisture retention, including but not limited to silica gel or hydrogels. Similarly, hydrophilic and/or hydrophobic additives or spray coatings may be applied to the paper's surface to control the direction of wicking. Paper for wicking may be die-cut into almost any shape, allowing the paper wicking layer or layers to conform to any application.

Preferred wicking materials may include Desiccant Paper and wood cellulose absorptive paper, both of which are available through Onyx Specialty Papers, but this disclosure is not limited thereto.

Odor-Neutralizing Layer.

The processes by which odor-neutralizing layers are made are similar to those for wicking layers. Papers may be manufactured from cellulose fiber blended with an odor-neutralizing agent, including but not limited to activated carbon, zeolite or kinetic degradation fluxion media (KDF media). These layers may also be produced from synthetic fibers blended with an odor-neutralizing agent, which provides more resistance against degradation and is less hospitable to microbes than cellulose fiber. In either case, the pulp may be pressed into sheets and pressed dry, after which it may be die-cut into any shape. Because moisture must be able to move between the odor-neutralizing and wicking layers for effective odor control, the odor-neutralizing layer or layers may also be capable of wicking and absorbing moisture, though to a lesser extent than the wicking layer or layers. In an example, the thickness of the odor-neutralizing layer is at least 0.2 millimeters, at least 0.25 millimeters, at least 0.5 millimeters, at least 0.75 millimeters, at least 1 millimeters, at least 1.25 millimeters, at least 1.50 millimeters, at least 1.75 millimeters, at least 2 millimeters, at least 2.25 millimeters, at least 2.50 millimeters, at least 2.75 millimeters, at least 3 millimeters, at least 3.5 millimeters, at least 4 millimeters, at least 4.5 millimeters, at least 5 millimeters, at least 5.5 millimeters, at least 6 millimeters, at most 0.2 millimeters, at most 0.25 millimeters, at most 0.5 millimeters, at most 0.75 millimeters, at most 1 millimeters, at most 1.25 millimeters, at most 1.50 millimeters, at most 1.75 millimeters, at most 2 millimeters, at most 2.25 millimeters, at most 2.50 millimeters, at most 2.75 millimeters, at most 3 millimeters, at most 3.5 millimeters, at most 4 millimeters, at most 4.5 millimeters, at most 5 millimeters, at most 5.5 millimeters, or at most 6 millimeters.

Preferred odor-neutralizing layer materials in this disclosure include Cellulose Activated Carbon Media, also available through Onyx Specialty Papers, but this disclosure is not limited thereto.

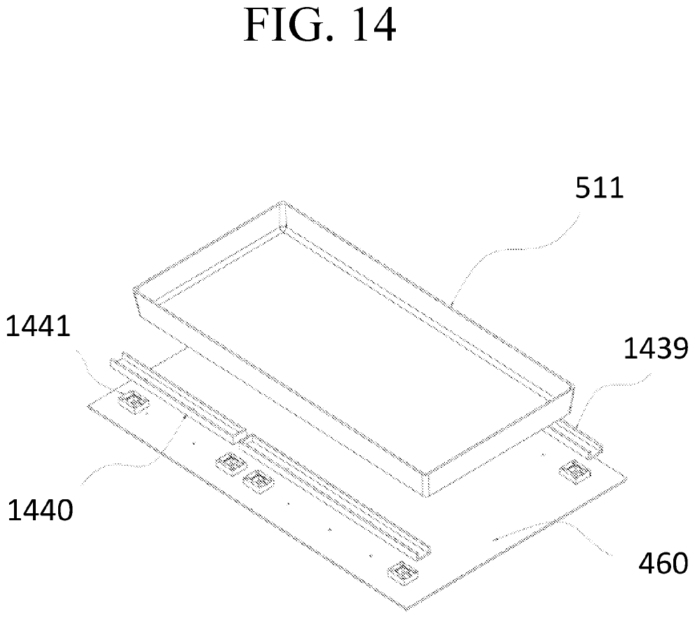

Referring back to the figures and in particular to FIG. 14, the leak/overflow containment tray 511 may be present underneath the receptacles. The tray 511 may be sized according to the volume of waste generation anticipated and may encompass the total length of both the solid and liquid receptacles 509, 513. In this example, the function of the tray 511 is to contain the waste in case of any leaks or overflows from the receptacles. The tray 511 may be made of a light-weight, durable, inert material like plastic which allows for easy handling during servicing. In this example, eight elevating mounts 1441 are screwed on to the bottom panel of the system 460. Four of these support the liquid receptacle's U-channel tracks 1439, and the other four support the solid receptacle's U-channel tracks 1440 as shown. The mounts can also be used to house load sensors which track the weight of the receptacles. In certain aspects, the U-channel tracks 1439, 1440 help provide a guided path for the movement of the receptacles in the system. They have one open end from which the receptacles can be moved into or out of the system and three closed walled-off ends which prevents the receptacles from moving out of its intended position. The tracks may be secured on to the bottom panel using threaded studs.

Referring generally to FIGS. 1-11 and operation of the system 410, waste separation may be achieved by user placement and positioning, with two distinct openings for solid and liquid waste which direct the waste into separate receptacles below the floor platform. In the non-limiting embodiment shown here, users position themselves above the pan 470 facing so that the liquid-waste opening is in front of the user and circular solid-waste opening is behind them. When used correctly, defecation results in the solid waste falling through the circular opening and depositing into the solid receptacle 513, requiring no use of additional hardware. Similarly for urination, the liquid waste runs through the declivity into the liquids opening, enters the pre-treatment system through funnel 1227, is guided by the combination of tubes and elbows, filtered by the pre-treatment media before draining into the liquid receptacle 509.

The evaporation of the wastes in the receptacles is achieved by three main ways—the evaporative membrane material (in this case, a bag 824), the suspended flap system 510, and the ventilation system. The liquid receptacle 509 has an additional way to aid evaporation with the suspended flaps system.

Membrane bag: In one example, the membrane bag may be the mam driver for evaporation or pervaporation in the system. It is made up of evaporative layers that remove moisture by means of pervaporation, which is the process in which a particular solvent is absorbed into a membrane on one side, transported across the membrane and released on the other side in vapor form. In this disclosure, the solvent is water, for which non-porous hydrophilic membranes are the most suitable pervaporation material due to their high affinity for water and high rejection rate of dissolved or suspended impurities, allowing moisture to be readily absorbed, transported across and released by the membrane. In pervaporation membranes, water vapor preferentially passes through while dissolved salts, as well as suspended particulates, are retained. Moisture-containing media (where water is one of two or more components—i.e. dissolved ions or suspended solids if a liquid, any other components if it's a solid) is placed or deposited into this non-porous or micro-porous evaporative membrane, which also serves to contain the media.

Suspended flaps system: The suspended flaps system may include two layers that contact the membrane bag 824 in the liquid receptacle 509—a wicking layer and an embedded carbon layer. The wicking layer as the name suggests, wicks the urine from the bag in a capillary action, distributing it across its surface area, allowing easy diffusion/evaporation to the atmosphere. The flaps may be oriented along a direction of the airflow in the system to offer high rates of evaporation due to the constant supply of air across their surface from the exhaust fan 440. The embedded carbon layer helps in absorbing any contaminant particles present in the liquid receptacle and also aids in odor mitigation.

Ventilation System: The ventilation system described here (which is used in certain non-limiting examples) can be operated both as a passive ventilation system or a more powerful active ventilation system. The passive ventilation uses a matrix of vent cutouts 615 in the door panel 614. The vents in combination with the opening from the pan 470 provide air circulation inside the system by using natural air currents and thermal buoyancy effects which increase the rate of evaporation inside the system. The active ventilation system consists of the passive ventilation system along with an electrically powered exhaust fan 440. The fan drives up the rate of evaporation by rapidly exhausting the air inside the system. This causes a pressure drop inside the system, which forces more fresh air intake from the vents 615. This process may be continuous which significantly increases the rate of evaporation. The speed of the fan can be adjusted based on the humidity and the temperature inside the chamber allowing for effective evaporation even at variable conditions The fan may also ensure proper and timely venting of noxious gases or odors that may build up inside the system without adequate ventilation.

In other configurations, rather than using an exhaust fan 440, the fan 440 may be an intake fan 440 which pushes air through the system for active ventilation. It should be appreciated that the current configuration of vent cutouts 615 can be adjusted to achieve optimal airflow. In this example, the vent cutouts 615 are arranged in three parallel rows across the door 614 from one side to another side, substantially across its entire width. The vent cutouts 615 may be arranged on a top half of the door 614—this allows for optimal airflow through the internal chamber of the system across the surface of the flaps and avoids inflow of excess water from external inclement weather conditions such as rain and flooding. Similarly, the exhaust fan 440 is arranged on a top half of the opposing door 430 and in a central position across a width of the door 430. This optimal arrangement for the vent cutouts 615 and the exhaust fan 440 provides for improved energy efficiency with respect to active or passive ventilation. This disclosure is not limited to these configurations, and other configurations may be used.

Once the wastes are dried and free of moisture, the doors 430, 614 may be opened to access the liquid and solid receptacles respectively for servicing. The liquid receptacle may be wheeled out of the system along the U-channel tracks 1439, while the solid receptacle may be wheeled out along the U-channel tracks 1440. Servicing the bag may include removing the rods 1338 from the snap-on plastic rings, replacing the used flaps with new ones and reinserting the rods back into place. At the same time, the membrane bag 824 may be replaced by carefully removing all of the retainer rings 825 and silicone tubings 821, and replacing the used membrane bag with a new one and securing it back in place using the silicone tubings and retainer rings. The above mentioned procedure is bio-hazardous. In certain examples, proper care and equipment may be essential while undertaking the procedure and also during disposing the used flaps and membrane bags.

In the example embodiments discussed above, because the moisture exits as water vapor, it can either be emitted or discharged from the system as harmless, molecular water vapor to the surrounding air or it may be captured, harvested and/or used for any applications that require clean, molecular water, including but not limited to hydration or rehydration for various applications (for example, dried foods, pharmaceuticals and other dried matter), or providing moisture (for example, to plants, possibly in an enclosed growth chamber such as a greenhouse), or to a hygroscopic medium (for example, for agricultural or environmental conditioning applications).

Additionally, the high purity water vapor collected from the moisture removal and separation system may be harvested and condensed into potable or pure liquid water, which may also be alternatively used for any application requiring suitably clean or ultra-purified water, including but not limited to agriculture, food production, washing, industrial production, consumption, atmospheric water generation and the like. Condensation of water vapor into liquid water can be achieved actively, e.g. via active cooling, and/or passively using methods including but not limited to passive cooling, convection, wicking surfaces, vapor capture and/or hygroscopic media. The ability to collect and condense potable water from the moisture removal and separation system may be useful for off-grid applications, including but not limited to remote or off-shore contexts where safe drinking water is generally not accessible and is therefore required to be generated or transported and often amounts to a significant weight, volume and cost. Furthermore, the ability to generate potable, usable and/or suitably clean water from other water or wastewater sources, as well as from seawater, brackish water, brine or any contaminated or other water source, may be very useful in emergency situations such as after a natural disaster or in humanitarian contexts where potable, usable or suitably clean water may be scarce.

In some non-limiting example embodiments or approaches of harvesting, condensing and/or capturing the water vapor (as discussed above): as water vapor passes through the outermost membrane of the moisture removal and separation system, it may be vented into an enclosed collection well with a dome-like top wherein the internal humidity rises until water vapor condenses as droplets on the dome-like or other shaped top and/or surface before rolling down into the collection well as a liquid. Another embodiment involves the moisture removal and separation process taking place entirely within the water collection well. This method may be performed passively at ambient conditions or with low temperatures applied to the outside of the collection well, which may increase the rate of condensation. Additionally, the liquid water in the collection well may serve as a heat sink, which is a heat reservoir that can absorb an arbitrary amount of heat without significantly changing temperature, which would serve to pull heat from incoming water vapor thus increasing the rate at which it condenses. Alternative methods for the condensation of this moisture include venting it through a condensation jacket, which flows cold water across the vapor stream to pull heat from moisture and cause it to change phase, superhydrophilic surfaces and/or coatings, including but not limited to those treated with plasma, ultraviolet irradiation or anodization, which attract and promote cohesion among water molecules, resulting in condensation. Additionally, ultra/superhydrobic surfaces and/or coatings and/or omniphobic surfaces and/or coatings may be used.

By collecting or otherwise utilizing the moisture vapor generated by this system, potable water free of microbiological activity may be generated from any water source, including but not limited to wastewater, seawater, brackish water, at any scale. This may be performed with minimal energy or equipment requirements when compared to other such methods for desalinating seawater or contaminated water, including but not limited to reverse osmosis, electrodialysis and multiple effect distillation. Additionally, this allows potable water to be recovered directly from a separate moisture removal application. Though the pervaporation and condensation of moisture may be performed passively and at ambient conditions, active methods may be applied to the membrane, including but not limited to heat and/or pressure to increase the moisture vapor transmission rate, and to the collection well, including but not limited to low temperatures to increase the rate of condensation.

In certain examples, a thermally insulating material to retain heat inside the system may coat or line the interior of the apparatus chamber, walls, and/or doors. This serves to regulate the temperature and/or retain heat inside the system. Such thermally insulating material may itself be a heat conductor but may act to improve heat retention or increase the internal temperature within the system. By increasing the internal temperature of the air within the system chamber, this results in a higher moisture uptake by the air which, in turn, drives faster evaporation with the system. Some examples of such insulating materials or coatings may include phase change materials, zeolite, waxes, metals, fiberglass, among many other materials which are known to persons of skill in the art.

Other example features for alternative embodiments may include: An inlet fan to increase air intake into the system; A control circuitry to activate the ventilation system based on the inner micro-climate of the system; Sensors that provide information of the variables like humidity, temperature, and pressure inside the system; A highly customizable design providing tunability depending on the time, place, and application; One or more outlet vents designed to enhance air circulation around the receptacle; Easily replaceable/serviceable receptacles; Filtration and microbial processing capabilities; Minimal or zero energy consumption based on the configuration used; A heating element that aids the process of evaporation—this can be integrated with the sensor systems providing intermittent heating only when required conserving power; A phase change material or an insulating coating that serves to regulate the temperature and/or retain heat inside the system; A configurable system based on the culture, population, or gender; No moving parts necessary for basic operation reducing the likelihood of failure; A system which prevents potential vector transmission and endemic diseases; A system which protects the user from exposure to waste and meets applicable health safety standards; A system with passive self-cleaning and disinfection capabilities; Sensors that track the number of uses and detect the level of waste in the receptacle, restricting access to the toilet; Sensors that track the weight of the receptacles and relay the real time data; Sensors that detect the presence of dangerous gases like hydrogen sulfide and alerts the users; and waste to value applications such as converting waste to some value or reuse of waste.

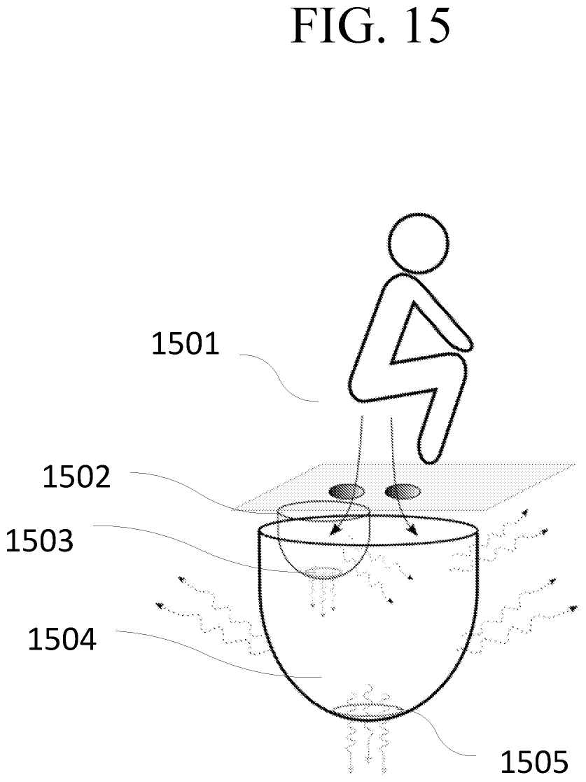

FIG. 15 is a conceptual diagram of one embodiment of an apparatus for onsite waste volume reduction. The user provides the waste by using the toilet (either squat- or sit version) 1501. The liquid and solid waste are separated.

Feces/solids are collected in a solid waste collection vessel 1502, which is positioned inside of or upstream of the liquid waste collection vessel 1504 and may be rendered from materials or combinations of materials including but not limited to plastics, polymers, textiles, fabrics, papers, films, clays, minerals, specialized media, or any composites or combination thereof

Urine/liquids are collected in a large liquid waste collection vessel 1504. This vessel may be rendered from materials or combinations of materials including but not limited to plastics, polymers, textiles, fabrics, papers, films, clays, minerals, specialized media, or any composites or combination thereof

In an example embodiment, the solid waste collection vessel 1502 may be made fully from a non-porous or nano-porous material(s) (that allows only the passage of water vapor from the waste collected), fully from a porous material(s) 1503 (which enables filtration or separation of solid and/or liquid volume from the waste collected), or any combination of these (to allow separation of vapor, liquid and/or solid volume from the waste collected). In a specific embodiment, the solid collection vessel 1502 may be made from a non-porous or nano-porous material while a porous filter or separator 1503 at the bottom of the vessel may allow the removal of liquids or gasses, facilitating further volume reduction in the solid collection vessel 1502. Any waste removed from the solid waste collection vessel at this stage can be collected in the larger liquid waste collection vessel 1504 to facilitate volume reduction while retaining the dried solids.

Similarly, the liquid waste collection vessel 1504 may be made fully from a non-porous or nano-porous material(s) (that allows only the passage of water vapor from the waste collected), fully from a porous material(s) 1505 (which enables filtration or separation of liquid volume from the waste collected), or any combination of these (to allow separation of both vapor and liquid volume from the waste collected). In a specific embodiment, the liquid waste collection vessel 1504 may be made from a non-porous or nano-porous material while a porous filter or separator 1505 at the bottom of the vessel may allow the removal of liquids or gasses, facilitating further volume reduction in the solid collection vessel 1504. Any waste removed or discharged from the liquid waste collection vessel 1504 at this stage can be discharged from the system in a non-toxic, hygienic or neutralized form, either as solid, liquid or gas/vapor, with the ultimate aim being volume reduction of onsite waste within the system. This reduction of solid and/or liquid waste volume via separation of moisture through a non-porous or nano-porous layer may be facilitated by additional strategies, elements or treatments to disinfect, sanitize or neutralize the discharged or emitted volumes, including but not limited to osmosis, the use of wicking or hydrophobic interactions, hydrophilic and/or hygroscopic attractions, functionalized surfaces, surface coatings or surface chemistries, diffusion and/or other processes. Furthermore, the reduction of solid and/or liquid waste volume via separation of moisture through a porous media, such as separators 1503 and 1505, may be facilitated using additional strategies including but not limited to compression, gravity, filtration, size exclusion, hydrophilic/hydrophobic attractions, and/or other molecular forces, including attractive, repulsive, chemical, electrostatic, ion exchange and other selective or exclusive molecular forces. This last step may be facilitated by additional strategies, elements or treatments to disinfect, sanitize or neutralize the discharged or emitted volumes.

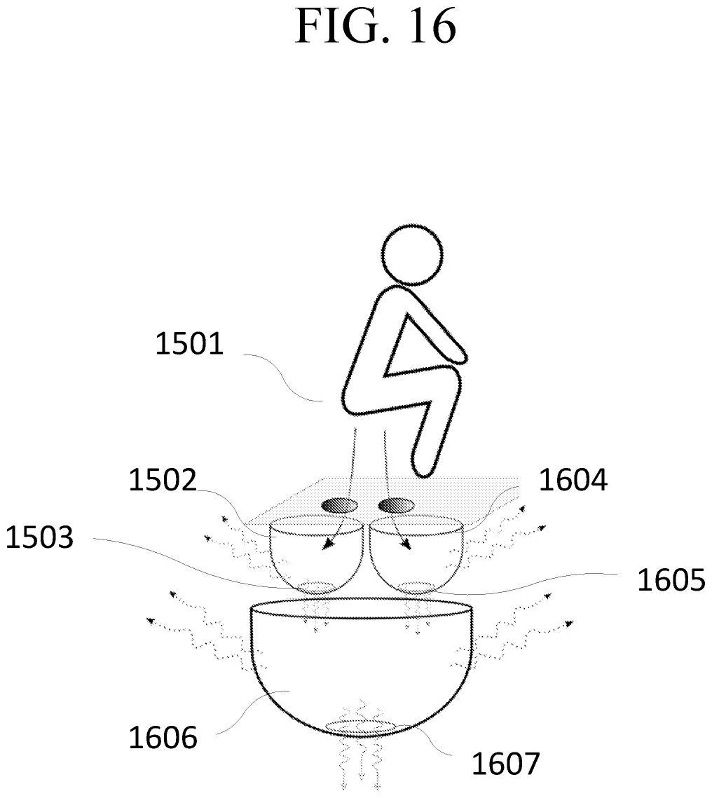

FIG. 16 is a conceptual diagram of another embodiment of an apparatus for onsite waste volume reduction. The user provides the waste by using the toilet (either squat- or sit version) 1501. The liquid and solid waste are separated. Solids/feces are collected in a solid waste collection vessel 1502. Liquids/Urine are collected in a liquid waste collection vessel 1604. Enclosing or downstream of these two primary waste collection vessels 1502, 1604 is positioned a secondary waste collection vessel 1606 for the purpose of collecting and processing solid, liquid or gaseous waste passed through from the primary vessels 1502, 1604.

The solids/feces waste collection vessel 1502 may be rendered from materials including but not limited to plastics, polymers, textiles, fabrics, papers, films, clays, minerals, specialized media, or any composites or combination thereof

The urine/liquids waste collection vessel 1604 may be rendered from materials or combinations of materials including but not limited to plastics, polymers, textiles, fabrics, papers, films, clays, minerals, specialized media, or any composites or combination thereof.

The secondary waste collection vessel 1606 may be rendered from materials or combinations of materials including but not limited to plastics, polymers, textiles, fabrics, papers, films, clays, minerals, specialized media, or any composites or combination thereof.

In an example embodiment, the solid waste collection vessel 1502 may be made fully from a non-porous or nano-porous material(s) (that allows only the passage of water vapor from the waste collected), fully from a porous material(s) 1503 (which enables filtration or separation of solid and/or liquid volume from the waste collected), or any combination of these (to allow separation of vapor, liquid and/or solid volume from the waste collected). In a specific embodiment, the solid collection vessel 1502 may be made from a non-porous or nano-porous material while a porous filter or separator 1503 at the bottom of the vessel may allow the removal of liquids or gasses, facilitating further volume reduction in the solid collection vessel 1502. Any waste removed from the solid waste collection vessel at this stage can be collected in the secondary waste collection vessel 1606 to facilitate volume reduction while retaining the dried solids.

In such an embodiment, the liquid waste collection vessel 1604 may be made fully from a non-porous or nano-porous material(s) (that allows only the passage of water vapor from the waste collected), fully from a porous material(s) 1605 (which enables filtration or separation of solid and/or liquid volume from the waste collected), or any combination of these (to allow separation of vapor, liquid and/or solid volume from the waste collected). In a specific embodiment, the liquid waste collection vessel 1604 may be made from a non-porous or nano-porous material while a porous filter or separator 5 at the bottom of the vessel may allow the removal of liquids or gasses, facilitating further volume red'uction in the liquids waste collection vessel 1604. Any waste removed from the liquid waste collection vessel 1604 at this stage can be collected in the secondary waste collection vessel 1606 to facilitate volume reduction.

Similarly, the secondary waste collection vessel 1606 may be made fully from a non-porous or nano-porous material(s) (that allows only the passage of water vapor from the waste collected), fully from a porous material(s) 1607 (which enables filtration or separation of liquid volume from the waste collected), or any combination of these (to allow separation of both vapor and liquid volume from the waste collected). In a specific embodiment, the secondary waste collection vessel 1606 may be made from a non-porous or nano-porous material while a porous filter or separator 1607 at the bottom of the vessel may allow the removal of liquids or gasses, facilitating further volume reduction in the secondary collection vessel 1607. Any waste removed or discharged from the secondary waste collection vessel 1606 at this stage can be discharged from the system in a non-toxic, hygienic or neutralized form, either as solid, liquid or gas/vapor, with the ultimate aim being volume reduction of onsite waste within the system. This reduction of solid and/or liquid waste volume via separation of moisture through a non-porous or nano-porous layer may be facilitated by additional strategies, elements or treatments to disinfect, sanitize or neutralize the discharged or emitted volumes, including but not limited to osmosis, the use of wicking or hydrophobic interactions, hydrophilic and/or hygroscopic attractions, functionalized surfaces, surface coatings or surface chemistries, diffusion and/or other processes. Furthermore, the reduction of solid and/or liquid waste volume via separation of moisture through a porous media, such as separators 1503 and 1605, may be facilitated using additional strategies including but not limited to compression, gravity, filtration, size exclusion, hydrophilic/hydrophobic attractions, and/or other molecular forces, including attractive, repulsize, chemical, electrostatic, ion exchange and other selective or exclusive molecular forces. This last step may be facilitated by additional strategies, elements or treatments to disinfect, sanitize or neutralize the discharged or emitted volumes to target a non-toxic or hygienic liquid effluent, using methods including but not limited to chemical disinfection, sonic disinfection and infrared and/or ultraviolet disinfection. It will be appreciated by those skilled in the art that changes could be made to the embodiments described above without departing from the broad inventive concept thereof It is understood, therefore, that the invention disclosed herein is not limited to the particular embodiments disclosed, and is intended to cover modifications within the spirit and scope of the present invention.

This disclosure describes embodiments of a device or an approach to separate and/or remove water from waste, wet substrate, wastewater or water with some impurities. Such a device or method seeks to remove water from such a substrate by converting it to gaseous water. Compared to most approaches to treat or process waste and/or water, which often employ multiple conditioning intermediary steps to eliminate impurities and/or solutes from water, this approach removes the water itself from the waste, mediated through liquid-to-gas phase change, leaving behind most or all other constituents as solid and/or liquid. Such a “one-step” approach for water removal, water treatment and/or waste treatment may be more efficient, more thorough, more cost-effective or more energy-efficient and/or less energy-consuming.

Conversion of water contained in a wet substrate, including but not limited to waste, wastewater and pre-treated water, from liquid to gas may be achieved through evaporation. However, this disclosure describes embodiments of a method or apparatus that aims to achieve water evaporation for the purpose of sanitation, waste treatment, wastewater treatment, water treatment, waste elimination and/or dewatering, without incurring high energy-consumption that would be needed from intensive heating or boiling. Rather, this approach targets relatively low-energy water separation or water evaporation by harnessing ambient moisture diffusion or passive evaporation. Such an approach promotes efficient waste volume reduction and/or water separation by utilizing ambient conditions including but not limited to relative moisture, relative humidity differential and temperature, and/or active or passive air flow. Also, as described later in this disclosure, some embodiments may utilize non-hydrophobic materials or membranes to facilitate low-energy separation of water, whereas most water separation treatment approaches tend to use hydrophobic materials or membranes to avoid formation of biofilms, but then also require additional energy use to overcome the water-repulsive forces of the material. Other materials that may be used to facilitate low-energy separation of water instead of or in combination with such non-hydrophobic materials may include but are not limited to other moisture-permeable, breathable, or wicking materials or membranes. Moisture-permeable or breathable material may mean material that permits moisture and/or air to pass through. Wicking material may mean material capable of drawing liquid away from a collected pool and/or facilitating evaporation.

The approach or devices disclosed herein optimize or amplify ambient moisture diffusion or passive evaporation by creating maximal evaporation opportunities and/or surfaces. Normally, evaporation of liquid will only occur off the top, exposed surface of a liquid pool or wet substrate, effectively limiting evaporation to “two dimensions.” In such cases, increasing passive evaporation without affecting the surrounding conditions or changing the composition of the substrate would require increasing the surface area of the substrate exposed to the atmosphere.

The targeted applications envisioned by the approach disclosed herein assume significant space or operational or cost constraints that preclude the ability to increase the exposed surface area of the substrate to be processed. Therefore, this disclosure describes embodiments of an apparatus and method that creates or provides more surfaces to enable evaporation “in three dimensions,” for example, to allow a contained pool or wet substrate to evaporate not only from the top liquid surface or exposed surface(s), but also to evaporate through the sides and bottom of a liquid-impermeable container and/or from added or structured evaporative surfaces, in contact with but not fully submerged in, the wet substrate that may draw or lift some liquid out of the substrate and distribute it across increased evaporative surface area in order to increase the occurrences of liquid molecules diffusing into the surrounding atmosphere and overall rate of evaporation from the contained substrate. Enabling evaporation “in three dimensions” (ie from the top, bottom, sides and additional surfaces, or from atmosphere-exposed surfaces as well as surfaces not directly in contact with the atmosphere) allows such a device or method to achieve efficient or higher throughput of evaporation in a more compact space. While some embodiments of this approach may rely wholly or partly on ambient or atmospheric conditions (eg surrounding temperature, surrounding relative humidity, ambient air flow), some embodiments may also augmented conditions to increase the rate of evaporation or enhance moisture diffusion from or through the various surfaces with addition of some heat or assisted ventilation or facilitated air flow. However, the amount of energy input to assist such augmentations is still generally less than the energy required by other evaporative approaches to water treatment and/or removal, including but not limited to distillation, which often require liquid pumping, pressurization, exorbitant heating, and/or additional equipment, components or processes.

A significant benefit of the described approach is that it may enable a significant amount of evaporation in a tight space or compact design. This in turn may allow for onsite sanitation, waste treatment, water treatment, wastewater treatment or waste elimination to be more feasibly or operationally or economically deployable in a number of hard-to-access or underserved contexts, such as in low-resource urban areas, informal settlements and/or emergency relief situations. Such devices or approaches also allow for complete onsite containment of any substrate, with no liquid discharge. As such, embodiments may be deployable as self-contained, above-ground systems for such challenging terrain such as water-logged areas or areas with hard ground, thereby posing more feasible alternatives to other more-prevalent onsite sanitation, waste treatment, wastewater treatment, water treatment or waste elimination options, many of which must be installed in the ground and/or must function by discharging partially treated liquid effluent into the surrounding environment.

Because this approach turns a portion of solid or liquid substrate into gas, thereby reducing the mass of the substrate onsite, a relatively large volume of liquid or wet solid may be fed into a relatively small device without the need for onsite discharge or frequent emptying, as is often the case for other available devices and/or existing processes with comparable throughput or processing volumes. For example, an embodiment of such a waste-evaporating device with capacity of 100-200 L may receive or handle the equivalent of 30-50 uses-per-day of solid and liquid waste for a period of 28 days, which may range from between 200 and 2000 L, without any release or discharge of waste onsite, and may support residual waste removal as infrequently as once or twice per month. Furthermore, the footprint of such designs or approaches may be further reduced by features or components that may facilitate faster and/or more continuous evaporation.

The avoidance of liquid discharge allows such a proposed device to serve as a “zero-liquid discharge”, herein after referred to as ‘ZLD”, solution or to address unmet needs for onsite sanitation, waste treatment, wastewater treatment, water treatment or waste elimination in unsewered areas or applications where the release of liquid discharge or effluent is restricted. Other approaches for ZLD, including but not limited to multi-effect distillation, may also use the approach of processing wastewater by evaporating liquid to gas to avoid liquid effluent, but such systems use exorbitant amounts of heat and therefore are generally not economically feasible below very large scale, or are not operationally feasible in places with constrained power availability.

The disclosed device and method also offers a much cleaner option for sanitation, waste treatment, wastewater treatment, water treatment or waste elimination when compared to other available or prevalent options. In addition to preventing any discharge of solid or liquid wastes or impurities onsite or into the environment, and consuming a minimal amount of energy relative to the volume of substrate processed, this approach does not use or pollute water, but in fact converts much of the captured waste or substrate into pure molecular water. By avoiding water use and pollution, this approach provides a more sustainable option for sanitation in water-constrained areas. With the above-mentioned benefits that increase deployability, feasibility and thus availability of enclosed sanitation systems in unsewered areas, as well as the complete containment and reduction of onsite waste achieved by such systems, these devices also have potential to reduce sanitation-related or vector-borne disease spread. Additionally, by dewatering or dehydrating waste or wastewater, this approach has the ability to stabilize waste and to reduce or cut-off microbial metabolism and/or conversion of organic wastes into methane or other greenhouse gasses. As described later in this disclosure, this device has to capacity to treat and reduce waste down to its most concentrated, nutrient-rich form and without the use of environmentally-harmful additives, thereby facilitating the capture, use and/or reuse of the recovered nutrients to promote other sustainable production or agriculture processes, or to displace the use of virgin or unsustainably-sourced alternative inputs. This waste-shrinking approach reduces the overall volume of waste, allowing for a reduction in collection, management and/or disposal requirements, as well as more sustainable waste-management, waste-treatment or water-treatment regimes and/or infrastructure systems. Further applications of this approach may also address the following needs: sanitation or waste management or water treatment applications where power availability is restricted or intermittent, for example in off-grid applications including but not limited to climate-adaptive sanitation, waste management and/or water treatment, due to the limited dependence of such approaches on external energy sources, the ability to operate without consuming or polluting water, because such approaches convert much of waste back into clean water.

A non-limiting function of some example embodiments of the invention is to contain and reduce or eliminate collected waste volumes onsite. Collected waste may include a wet solid and/or liquid substrate that is input into such a system directly from a source and/or from an upstream container or process and/or a partially treated substrate. Partially treated may refer to having undergone one or a combination of chemical/biochemical processing or conditioning such as the non-limiting examples of the addition or removal of chemical compounds through a chemical reaction, or any other action that affects a chemical composition. Partially treated may also refer to having undergone one or a combination of some physical processing or conditioning, a non-limiting example including passing through a filter to remove components, or altering a temperature, or any other action that affects a physical condition. One non-limiting example approach to reducing or eliminating waste onsite is by evaporating the liquid or water content of the collected waste collected in a container. Non-limiting examples of a container include a bag, compartment, vessel, box, tube, engineered surface, or any other physical construct capable of containing matter. Throughout the disclosure and unless otherwise indicated, container, evaporative container, and evaporative capture container may be used interchangeably, at least in the context of evaporating liquid from some substrate, mass, and/or volume collected in a container. Evaporation may be achieved in a number of ways, including, but not limited to, use of pervaporation, which may be defined as separation of liquid mixtures by partial vaporization through a non-porous or porous membrane; use of materials and/or surfaces, including but not limited to breathable or wicking surfaces, to transport and/or distribute liquid molecules from pooled liquid and/or wet substrate across large surface areas to facilitate increased diffusion of vapor to the surrounding air; or addition of energy, including but not limited to heat, to facilitate diffusion of liquid molecules as vapor to the—surrounding air.

In some embodiments, it may be preferable to use a non-evaporative, liquid-impermeable waste capture container to collect liquid and/or solid wastes, and, rather than the capture container itself, utilize other evaporative surfaces in contact with the captured waste to achieve volume reduction by generating or through the removal of a liquid and/or gaseous effluent, with this effluent being at least partially treated or containing less impurities than the collected or contained waste. Such evaporative surfaces may utilize one or more or a combination of a hydrophilic or otherwise non-hydrophobic, a breathable, or a wicking material.

Additionally, embodiments of this approach as already described or combinations thereof may be used for additional purposes beyond containment and reduction and/or elimination of waste. Additional applications may include but are not limited to: purification and/or treatment to yield clean liquid water; partial and/or complete dewatering of a wet substrate; passive production of vapor or moisture from a liquid and/or solid substrate; production of vapor or moisture; and evaporative cooling.

Additionally, embodiments of this approach as already described and/or combinations thereof may be used for additional purposes beyond containment and reduction and/or elimination of waste. Additional applications may include but are not limited to: purification and/or treatment to yield clean liquid water; partial and/or complete dewatering of a wet substrate; passive production of vapor or moisture from a liquid and/or solid substrate; production of vapor or moisture; and evaporative cooling.

In one example embodiment for the collection and/or volume reduction of solid and/or liquid substrate utilizing one or more containers with a membrane, and at least one evaporative surface. The substrate includes but is not limited to solid waste, liquid waste, wastewater, a water feed or a combination thereof. The capture container(s) may contain solid waste, liquid waste, water and/or other wet substrates. Liquid may be evaporated directly from multiple interfaces, including but not limited to the surface(s) of materials within the capture container, through one or more evaporative membrane layers of the capture container, from at least one evaporative surface, or any combination thereof.

Some embodiments may collect solid waste, liquid waste, water and/or other wet substrates using one or more capture containers wherein one or more membranes of the container(s) may be used to evaporate, pervaporate, process, separate and/or otherwise treat the contents of the container when those contents come into contact with the membrane.

Some embodiments may include a container with one or more membranes to receive waste, water or wastewater. The container may be comprised of at least one evaporative surface in contact with some or all of the substrate within the container. In embodiments utilizing evaporation, evaporation of contained substrate may take place where the substrate surface is in contact with air, where the substrate surface is in contact with at least one membrane and/or evaporative surface, or using any combination thereof. Some embodiments may include multiple diverse evaporative surfaces and/or configurations thereof to facilitate volume reduction of the contained substrate. In such configurations, one or more surfaces may be fully or partially submerged within the substrate, and may remain submerged or be intermittently submerged. Some embodiments may utilize pervaporation through a membrane layer to achieve partial or total volume reduction of the contents. Throughout the disclosure, it should be understood that pervaporation and evaporation may be used interchangeably in the context of an evaporative volume reduction of collected waste or other substrate through a membrane. Some embodiments may provide or otherwise utilize heat to improve the rate of evaporation and/or volume reduction of contained substrate. While such an approach may require the addition of energy, energy consumption may be modest, especially in comparison to a number of other established approaches to process waste or water, and/or to eliminate waste or wastewater. In some embodiments, enhanced airflow may be utilized to improve evaporation and/or volume reduction of the contained substrate, and/or to disperse any accumulating odors or gasses. These embodiments may utilize ventilation, provided through passive and/or active means. Passive ventilation may channel external airflows to facilitate evaporation, including partial or total dewatering of the contained substrate. Active ventilation may be used to improve airflow via the use of powered systems, including but not limited to fans, or via passive means, including but not limited to the use of liquid flow turbines and/or wind turbines to push or pull air for use in evaporating contained wet substrate and/or to generate electricity that may be used to improve evaporation, or any combination thereof. In some embodiments, powered systems may refer to electrical energy powered, chemical energy powered, kinetic energy powered, or potential energy powered.

Some embodiments of the invention differ from many waste treatment and/or water treatment approaches by utilizing non-hydrophobic materials or membranes including but not limited to those described herein. Use of non-hydrophobic materials or membranes may reduce the energy or power needed to separate, process, treat and/or remove water when compared to many traditional approaches that use hydrophobic materials or membranes for these purposes. Many conventional approaches of waste or water treatment utilize hydrophobic materials to avoid the formation of biofilms at the treatment interface or surface, which requires added power or energy to overcome any repulsive forces of the hydrophobic material. Use of non-hydrophobic or hydrophilic surfaces including but not limited to those in this disclosure may avoid the need for such power as water is not repelled by such treatment interfaces. Also, use of certain non-hydrophobic surfaces such as those in this disclosure may confer added benefits in that they do not appear to form performance-eroding biofilms.

Some embodiments may also utilize hydrophobic materials or membranes to separate, process, treat and/or remove water. In some cases, such approaches or designs may use only hydrophobic materials or membranes in the capture container. In some cases, combinations of hydrophobic and non-hydrophobic materials or membranes may be used in the capture containers.

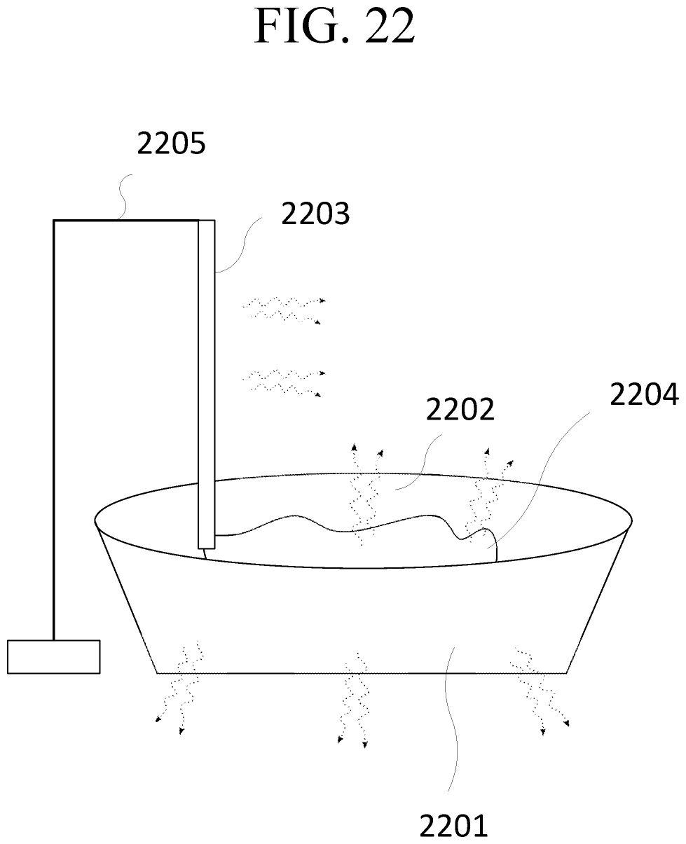

FIG. 22 shows an example embodiment of evaporative volume reduction of a collected waste through multiple vectors. The waste capture container 2201 with a membrane 2202, serves as a container for the collected waste 2204. An evaporative surface(s) 2203 is suspended on the support structure 2205 and is configured to contact a portion of the collected waste 2204. In such a configuration, evaporation may occur directly from the collected waste 2204, through the container membrane 2202, from the evaporative surface 2203, or any combination thereof.

Evaporative performance of such an embodiment was evaluated by measuring an initial weight of a collected waste and comparing to weight measurements recorded after certain periods of time, such as five minute intervals. A minimum of 5% mass and/or volume reduction of collected waste was measured over a 24-hour period. By frequently recording the weight of collected material in embodiments, additional metrics and insights may be learned. Weight increases may correspond to an addition of waste and increments of added waste may correspond to a total number of users of an embodiment. Total users and timing of use may also be understood. Additionally, other metrics may be measured using additional quantitative and qualitative metrics. User behavior including but not limited to what times users enter the restroom and how long they spend may be measured using additional sensors, such as motion-detectors that record when somebody passes through a door of some embodiments. Motion sensors may determine whether or not an embodiment is in use or if an embodiment is close to a full capture container capacity. Substrate within embodiments may be measured for temperature, salinity and/or total dissolved solids, pH, concentrations and/or emissions of H2S and/or methane and/or ammonium, to monitor the substrate and/or effluent quality and predict a rate of evaporation and/or other performance metrics. Qualitative performance metrics, such as odor, user behavior/education and user feedback, may rely primarily on the reported experiences of users and/or servicers. Some surrogate qualitative testing may however be performed, including but not limited to liquid and air-quality sensors which detect the presence of hydrogen sulfide and/or ammonia, which are odorous compounds that affect user experience.

### Alternate Embodiment Configurations

While some embodiments of the invention use one or more evaporative waste capture containers fabricated from embodiments of the evaporative membrane described herein, other embodiments may not utilize evaporation, using other waste capture and/or collection structures and/or treatment methods, either in addition to the components mentioned previously or as alternatives.

Embodiments of the invention may be further enhanced, augmented or used to achieve additional outcomes including: Separation and/or collection of raw waste streams; Onsite treatment and/or processing of water or raw waste streams; Onsite recovery and/or collection of water and/or waste constituents; and onsite conversion of solid and/or liquid waste to remove toxic or hazardous constituents and/or obtain some value and/or use from the output.

Non-limiting benefits of such additions may include but are not limited to the following: economic benefits including rendering onsite and/or decentralized sanitation, waste treatment, wastewater treatment, water treatment or waste elimination more economically sustainable by lowering the costs to install, establish and/or operate such processes. Cost reductions accruing from lower cost equipment and/or operations to achieve these processes; reduced treatment volumes, resulting from elimination and/or conversion; reduction and/or elimination of inputs or requirements for treatment processes, including water use, chemicals, electricity, disposal costs; conversion of treated waste or water into value-added or useful outputs that may, in turn, be themselves monetized, including energy, fertilizer, animal feed, nutrients, biofeedstocks, salts, chemicals, clean water. Embodiments of the described waste-to-value conversions have the potential to support more opportunities for circular sanitation, wherein monetization of the collected waste or derivative waste outputs may offset the upfront installation costs of such sanitation or treatment systems and/or the ongoing operational and maintenance costs. Improved environmental sustainability as a result of such outcomes including, but not limited to: reducing waste volumes, disposal or pollution; conversion of waste into cleaner, safer or neutral outputs; or conversion of waste into renewable resources or value-added outputs that, in turn, may be used to reduce or displace consumption of virgin or non-renewable materials or inputs. Increased accessibility, availability, portability and/or deployability of clean or safe onsite/decentralized sanitation, water treatment or waste treatment. Such increases may be as a result of the cost reductions described above. They may also result from other aspects or capabilities of the described processes or devices, including but not limited to the following. By reducing volumes of onsite waste, embodiments herein therefore reduce the space or footprint needed, relative to many conventional solutions. As such, embodiments of these systems may be installed in more constrained or difficult-to-access contexts or locations. By completely containing any waste feeds and/or avoiding any harmful discharge, embodiments of the systems allow for safer and/or cleaner sanitation, waste treatment, wastewater treatment, water treatment or waste elimination in more contexts and/or locations where alternatives may be too costly, infeasible, inoperable or cannot physically be implemented, for example in water-logged areas, built-out areas, hard-ground areas, inaccessible areas, remote areas, areas where such systems cannot be installed underground.

Such additional functionalities described above may be implemented or achieved within the previously-described example embodiments, or through embodiments containing additional components and/or compartments that are placed upstream of waste capture containers, downstream of waste capture containers, and/or in parallel to waste capture containers.

Separation of Waste Streams.

In some example embodiments, it may be preferred to separate the raw waste streams and/or collect separated waste streams in their raw forms.

Some non-limiting benefits that accrue from separating waste streams may include the following. Separation of liquid and solid waste streams increases the efficiency of waste drying or water removal. With more efficient, more extensive or faster removal of water or moisture from waste, less odor and gas are produced, including green-house gasses, and waste streams may be more effectively neutralized to allow for safer, cleaner operations. Separation also facilitates more and better options for post-collection use, conversion or treatment. Unlike many waste treatment or sanitation systems, embodiments of the device or methods may support urine collection and/or recovery, which opens possibilities for use of urine or urine constituents for downstream productive purposes. Furthermore, embodiments of this device or method enhances economic and/or operational feasibility of collecting waste streams by concentrating said waste onsite, at the point-of-use/production, as a result of water removal or separation.

Collected waste streams may be captured and separated in the previously-described embodiments or in embodiments including additional containers or compartments placed upstream, downstream or alongside of waste capture containers.

In some embodiments that require a more compact or simpler design, waste streams may not be separated, but rather collected together in unified compartments. In such cases, the added complexity of processing or treating or reducing mixed waste streams may be counterbalanced by augmentations that allow for or facilitate more active or increased rapid drying or moisture-removal, in some embodiments by augmenting or modifying heat or airflow.

Onsite Treatment and/or Processing of Waste Streams.

Some embodiments of the invention may be configured to achieve onsite treatment and/or processing of raw waste streams. Such treatment or processing may improve safety and hygiene for users and operators and may enable safer and/or cleaner discharge of waste effluent onsite. This may include partial or full clarification of urine, liquid waste or liquid waste effluents prior to collection, removal or discharge. This may also include treatment or processing of solid or liquid waste for disinfection or odor reduction or mitigation.

Treatment of waste or wastewater may be partial or exhaustive, and lead to a reduction in debris or suspended solids which may settle in the evaporative container and block evaporative surface area, or removal of molecules that may contribute to odor, including but not limited to reduced nitrates, nitrogen ions, ammonium and urea, or general non-specific odor-reduction. Additionally, partial or more extensive treatment may help reduce osmolarity of the waste, water, or wastewater in the evaporative bag, and thus increase the efficiency of evaporation and/or pervaporation.

In some embodiments, it may be preferable to have the effluent from a solid capture container be fed or released into a liquid capture container, which may facilitate a treatment or processing pathway wherein effluent from the solid container is combined with the constituents of the liquid container to be treated together.

In some embodiments, partial treatment of waste or wastewater feeds may occur in a pre-filter as seen in FIG. 12 using the such components including but not limited to the following:

Nitrate filter pad may serve as the first physical filter, rejecting the passage of debris or large suspended solids. The nitrate filter pad may also adsorb or fix some nitrate in the feed, binding it to the filter pad and blocking nitrate passage to reduce nitrate content in the liquids/urine capture container.

Zeolite organized in a layer of pellets or any other form or arrangement, may remove some nitrogen and ammonium ions from solution of the incoming waste, binding them within the pellets and preventing passage. The zeolite layer adds a residence time to the passage of waste, facilitating greater absorption of ammonia and nitrogen ions. Zeolite may also release heat upon contact with a passing liquid waste, increasing the heat of the liquid waste feed to the capture container and therefore the heat of the liquids/urine capture container, which may increase a rate of—pervaporation through the membrane and/or facilitate the liquid's wicking to a wicking surface or material.

Activated Carbon Filter Pad may serve as a secondary physical filter, rejecting the passage of suspended solids from the liquid feed before capturing by the evaporative container. These filters may adsorb some urea or some ammonia, which may serve to both reduce concentrations of these constituents in the evaporative container, with a potential benefit to reduce osmolarity in the evaporative containers and thereby enhance or improve evaporation rates. These filters may also limit the ammonia odor in the liquids container or in the system overall. These filters may also adsorb or fix dissolved phenols which may cause odors, or active pharmaceutical ingredients (“APIs”), medications and/or their metabolites which may be present in liquid waste.

Additionally, activated carbon layers may absorb and/or help neutralize odors in the waste capture containers, external to those compartments, or in line with the ventilation systems to adsorb volatiles and/or odors in the system.

Such pre-filters, in addition to providing some benefit in terms of partially clarifying collected waste for more efficient downstream processing (e.g. by mitigating the build-up of high salt concentrations or osmotic pressure inside a downstream evaporative container or compartment over an extended use-cycle) may also be used to concentrate or collect certain valuable solutes for recovery or useful purpose, in line with what is described below.

In some embodiments, processing of urine, liquid waste, liquid waste effluents and/or other feed water may be achieved by the addition of membrane-mediated methods in addition to, upstream of, downstream from, in parallel to or instead of the above-described evaporative membrane or waste capture containers, including but not limited to filtration, ultrafiltration, membrane distillation, or other types of filtration including but not limited to particulate or solute exclusion. Other methods to clarify or treat urine, liquid waste and/or liquid waste effluents include, but are not limited to the use of selective media, deionization, solute precipitation, or other solute removal methods.

Filtration and Ultrafiltration.

Broadly understood in a non-limiting theoretical context, filtration and ultrafiltration include membrane-based separation processes. Ultrafiltration may be used for the removal of contaminants from liquid streams, including but not limited to plastics, bacteria, viruses, protozoa, proteins and organic molecules. Ultrafiltration may use semipermeable membrane made from a wide variety of materials, including but not limited to cellulose acetate, polyvinylidene fluoride, polyacrylonitrile, polypropylene, polysulfone and polyethersulfone, with a pore size between 0.005 and 0.1 micron. Unlike an adsorption-diffusion mechanism utilized in some embodiments of the evaporative membrane, the separation method of ultrafiltration relies on size exclusion to reject suspended solids while enabling the permeation of liquid water and low molecular-weight dissolved ions.

Ultrafiltration offers low operating temperatures and low operating pressures, for some embodiments in the range of 2 to 5 bar, to drive the feed solution across the membrane surface, which may require a pressurized pump as well as pressurized seals between the pump and membrane permeate. The pressurized feed solution enters an ultrafiltration module, which contains the membrane, and permeated liquid water may be collected as an effluent. Multiple module configurations exist for ultrafiltration, including but not limited to tubular, hollow fiber, spiral-wound and plate-and-frame modules, which differ in footprint and energy consumption. Due to the small size of some ultrafiltration membranes compared to evaporative membranes, two or more modules may be operated in parallel to increase the effective membrane surface area and therefore total filtered feed flux. An ultrafiltration module may be implemented to replace the evaporative container found in some embodiments described within this disclosure. Some embodiments may require a prefilter to supply feed to the ultrafiltration module due to the need to prevent fouling of the ultrafiltration membrane. Some embodiments may include a pressurized pump, either upstream or downstream of the prefilter, to provide feed pressure for separation within the ultrafiltration module.

In some embodiments of this disclosure, it may be preferable to remove the water content of waste as a liquid effluent rather than a gas effluent. In some such embodiments, ultrafiltration would be placed downstream of liquid and/or solid waste capture containers. In some embodiments, inclusion of ultrafiltration in addition to evaporation and/or pervaporation may increase the overall rate of liquid from solid separation, allowing for faster water removal from waste products and/or recovery of removed liquid. In some such embodiments, removed liquid may be a non-potable water, potable water, or drinkable water. Because the separation process is not restricted by the feed concentration, ultrafiltration may be an effective process for removing suspended solids and/or urinary constituents from the feed solution prior to its addition to the evaporative container, reducing the concentration of impurities or solutes and thereby improving the rate, extent and/or duration of pervaporation, for example, over the course of the use cycle. Like membrane distillation, effluent of the ultrafiltration process is a liquid which may be readily stored or purged, and while dissolved ions may not be removed via ultrafiltration alone, the exclusion of bacteria and viruses allows for safe discharge into the environment. Furthermore, some embodiments may include the combined use of membrane distillation and ultrafiltration for liquid separation and water purification application.

In some embodiments, the incoming collected liquid waste may already be partially treated. Non limiting examples of collected liquid waste may include waste collected directly as liquid (eg urine, wastewater) or liquid effluent drained, extracted or produced from solid waste.

Such an embodiment may also be used to treat water feeds in addition to waste or wastewater, so as to remove low-concentration impurities or solutes to improve the quality of effluent water for potentially useful purpose.

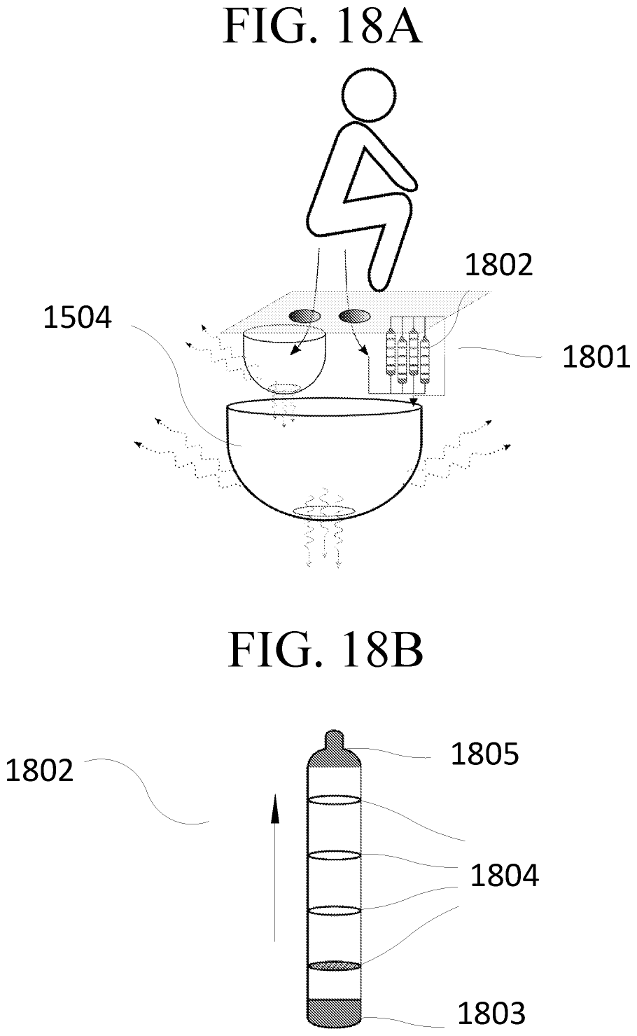

FIGS. 18A and 18B, show an example embodiment including a filtration cell 1801 for receiving collected liquid waste and producing a liquid permeate that may be collected in a waste capture container 1504, the cell comprising at least one filtration module 1802 having a filter feed side 1803, a filter permeate side 1805, and at least one filtration membrane 1804 separating the feed side and the permeate side. In some embodiments, feed may pass through the filtration cell with gravitation. In other embodiments, the cell 1801 may be configured to provide a pressure differential between the filter feed side 1803 and the permeate side 1805, and may utilize a component and/or system to provide such a pressure differential. Permeate from such a filtration cell may feed into subsequent sections of the apparatus, for example a waste capture container 1504. Alternatively, such permeate may be released from the system.

In some embodiments, the filtration cell 1801 may use ultrafiltration membranes to remove particles exceeding the membrane exclusion size, or to partially or largely disinfect a resulting liquid permeate. The filtration module 1802 may comprise more than one filtration membrane 1804 of different pore sizes/diameters, arranged in such a way that the membrane with the largest pore size is closest to the filter feed side 1803 and the membrane with the smallest pore is closest to the permeate side 1805. The filtration membrane may have pores with an average diameter of between 0.005 and 10 micron. The feed may flow through at least one membrane 1804 at a pressure of between 2 and 5 bar. The filtration membrane(s) 1804 may be a semipermeable membrane and may be comprised from materials including but not limited to cellulose acetate, polyvinylidene fluoride, polyacrylonitrile, polypropylene, polysulfone and/or polyethersulfone, and other synthetic or non-synthetic materials or combinations thereof.

In such an embodiment, an ultrafiltration cell comprising four parallel ultrafiltration modules removed over 98% of pathogens and organic molecules contained within the feed, generating clean water at a flux of 200 gallons per square foot of membrane per day (GFD). This was achieved with a membrane pore size of 0.01 micron and a feed pressure of 4 bar, though feed pressure and membrane pore size may be tuned to increase/or reduce the flux and/or to allow or exclude the passage of smaller molecules.

Membrane Distillation.

Broadly understood in a non-limiting theoretical context, membrane distillation is a separation process, sometimes used for seawater desalination, process water treatment and the production of potable water from contaminated sources, in which clean water is driven through a membrane while suspended solids and dissolved ions are retained. A hydrophobic, microporous membrane used in membrane distillation (also referred to as MD) may range from 0.01 to 1.0 micron and may be made from materials including but not limited to polypropylene, polyvinylidene fluoride and polytetrafluoroethylene. A driving force of the separation process for MD is a temperature difference between a heated feed and a cooling stream on opposite sides of the membrane. The temperature differential facilitates a phase change, and the resulting vapor pressure differential drives the permeation of water vapor molecules through the membrane. Though both membrane distillation and membrane pervaporation are separation processes involving membranes, MD differs due to its separation mechanism. Unlike in pervaporation, which utilizes an adsorption-diffusion mechanism, the selective permeation in MD depends on vapor-liquid equilibrium phase separation to drive selected components through the membrane, with MD not chemically distinguishing the components of a feed solution the way the pervaporative membrane does. As a result, feed osmolarity does not influence permeation rate in MD the way it does pervaporation, so no limit on feed concentration exists for MD.

In some embodiments and/or applications of this disclosure, it may be preferable to remove the water content of waste as a liquid effluent instead of evaporating it. In such designs, MD may be placed downstream of liquid and/or solid waste capture containers. Inclusion of MD within the system may alternatively replace the function of the evaporative container or may be implemented upstream of the evaporative container to separate clean water from the feed stream before it enters the membrane for pervaporation and/or evaporation. By implementing MD in some embodiments, impurities including bacteria and pathogens may be effectively removed from the feed stream prior to collection, allowing for safe reuse of the separated components in any applications that require clean water. Furthermore, because MD may separate liquid streams regardless of feed quality, its inclusion within some embodiments may allow the treatment of more concentrated waste streams without negatively impacting the rate of pervaporation through the membrane, thereby allowing more waste to be separated and harvested in a given time without the need for dilution or pretreatment. In embodiments where an MD module is used to replace the evaporative container, the effluent may exit the system as liquid water as opposed to a vapor, however the purity of this product water enables its immediate reuse or disposal into the environment, as potential contaminants are removed by the MD process.

In some embodiments, operation of MD requires two liquid streams—one of which contains the feed solution, the other containing a cooling liquid such as clean water—flowing parallel to one another on opposite sides of the membrane. The feed stream is heated, either directly or via a heat exchanger, typically to between 30 and 60° C., while the cooling stream operates around 20° C., which may require chilling to obtain. In addition to the module containing the membrane interface through which both streams flow, some embodiments utilizing MD uses separate tanks for the feed and cooling solutions via evaporative containers within the apparatus may serve this purpose—as well as mechanical pumps to maintain constant flow of the feed and cooling stream. A heating source and electrical/energy source may also be required to heat the feed solution and power the pumps as well as any electrical controls one may choose to implement, though the low operating temperatures and low operating pressure of MD compared to most existing water purification processes amount to low energy requirements which may be sufficiently provided off-grid using solar energy and/or other renewable or waste energy sources. Solar energy may be implemented in some embodiments to both heat the feed solution to the necessary operating temperature, using a solar collector such as a solar pond or still, and/or converted to electricity via on-site photovoltaic panels to power pumps as well as any electrical controls. A battery may be further implemented in some embodiments to store electricity converted from sunlight for use during nighttime hours. Additionally, the cooling stream solution may require chilling to fall within the necessary cooling temperature range, though a temperature of 20° C. may be obtained by keeping a reserve of cooling solution in a shaded area or insulated during the daytime.

Multiple configurations have been developed for the operation of MD which differ somewhat in mechanical requirements but operate under the same non-limiting theoretical principles. Direct contact membrane distillation (DCMD) is the simplest and most widely studied configuration in which the feed stream and cooling stream are each in direct contact with opposite surfaces of the membrane. The cooling solution often comprises pure water and the water vapor from the feed which permeates the membrane condenses within the cooling stream, transferring clean water from one stream to the other. Another possible configuration, air gap membrane distillation (AGMD) is fundamentally similar to AGMD, though an air gap exists between the membrane and cooling liquid, and the inclusion of a chilled surface within the air gap allows the water vapor to permeate the membrane and condense on the chilled surface, entering a separate permeate tank rather than the cooling stream. The operation of AGMD is similar to that of DCMD, however by increasing the distance between the heated feed and chilled cooling streams, heat loss between the streams is reduced, resulting in improved thermal efficiency. Vacuum membrane distillation (VMD) in which vacuum pressure is applied to the air gap of AGMD, and sweeping-gas membrane distillation (SGMD) in which an inert sweeping gas is blown across the air gap of AGMD, are other possible configurations which may yield greater mass flux than DCMD or AGMD, though both methods require an external condenser to collect the permeated water which, in turn, requires additional equipment and operational costs.

In some embodiments, the incoming collected liquid waste may already be partially treated. Non-limiting examples of collected liquid waste may include waste collected directly as liquid (eg urine, wastewater) or liquid effluent drained, extracted or produced from solid waste.

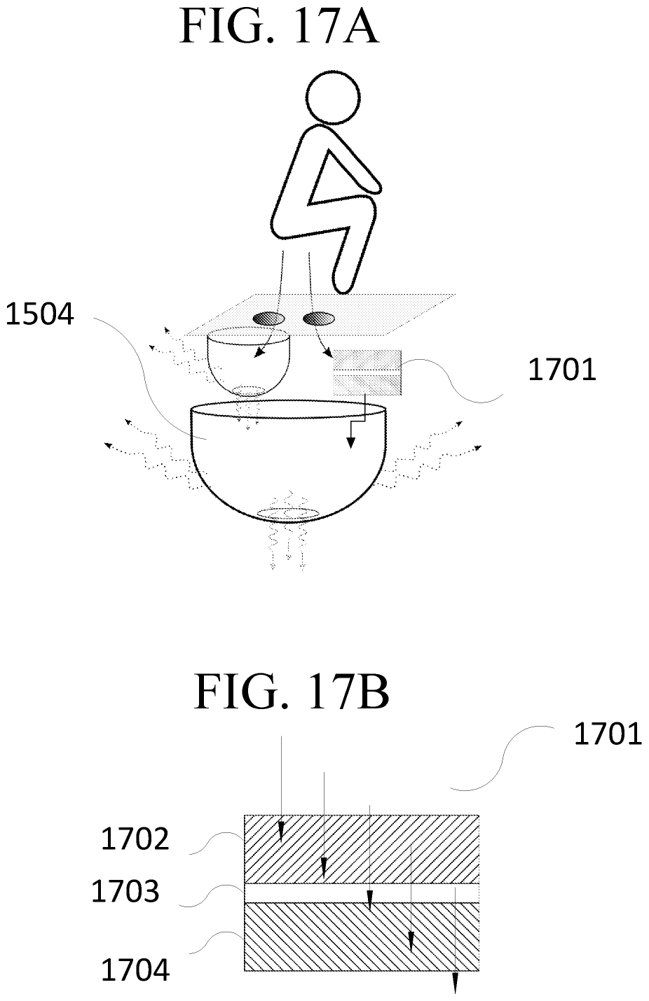

FIGS. 17A and 17B show an example embodiment including a membrane distillation function. The membrane distillation module 1701 has a feed side 1702, one or more distillation membranes 1703, and a distillate side, 1704. Incoming collected waste is directed to the feed side 1702 and mixed with a warm fluid, liquid distillate selectively passes through the distillation membrane(s) 1703, which separates the feed side and distillate side, into a cooled fluid in the distillate side 1704 and into subsequent sections of the apparatus, for example a waste capture container 1504. Alternatively, such permeate may be released from the system.

The distillation membrane 1703 may be hydrophobic and may be made from materials including but not limited to polytetrafluoroethylene, polyvinylidene difluoride, polypropylene or other synthetic or non-synthetic materials. The distillation membrane 1703 may have a pores with a standard diameter of between 0.1 and 0.5 micron.

In such an embodiment using a DCMD module, operating at atmospheric pressure or with no applied pressure with a 20° C. temperature differential across the membrane, membrane distillation removed over 97% of total contaminants from the feed stream, with over 99% salt rejection, which is of particular interest in the separation of concentrated wastewater streams.

Other Treatments, Processing, and Conversion.

Some example embodiments may include either a disinfection component, odor reduction component or both in the solid and/or liquid capture container(s). Disinfection of solid or liquid waste may be achieved by filtration of any liquid effluents, use of disinfecting or anti-microbial additives, composting to neutralize pathogens or microbes, thorough or rapid drying, or other onsite disinfection methods including but not limited to sonication, ultraviolet, irradiation, or any other disinfection method. Odor reduction or mitigation may be achieved but not limited to the use of additives to reduce microbial activity, additives to prevent odor production, additives to bind, mask and/or filter odor, including but not limited to fragrances and activated carbon, and ventilation designs and/or systems. These additions may be implemented within the previously-described example embodiments, or through embodiments containing additional components upstream of, downstream from, or parallel waste collection compartments.

Resource Recovery.

Some example embodiments may include onsite recovery and/or harvesting of waste constituents from solid and/or liquid wastes. Such embodiments not only allow for the safe handling and treatment of human waste but enables the separation and recovery of useful resources available within, including but not limited to water, urea, nitrogen, phosphorus, sodium, chloride, potassium, fibers, fats, and/or other organic or inorganic nutrients. The use of a pervaporative membrane layer allows for clean water to diffuse through the membrane while dissolved ions as well as suspended components are retained, meaning that through standard operation of the toilet, desiccated waste may be concentrated and reused or stored for future use once moisture has been partially or fully removed from the evaporative container. Depending on the source, this desiccated waste may be comprised of desiccated stool and/or combined urinary solids.

Additionally, clean or treated water may be harvested from liquid and/or solid wastes, resulting from evaporation and/or pervaporation of the water content of waste, or from filtration or membrane-mediated methods described above. Alongside the recovery of evaporated water vapor, this process represents one of the most straightforward methods of recovering usable resources from waste within the system.

Resource recovery from waste may deliver economic or improved sustainability benefits (eg from reduced pollution or value-added use). For example, onsite drying of collected waste streams may yield concentrated sources of raw organic, non-chemical nutrients useful in different agricultural processes including but not limited to crop cultivation and artificial and/or commercial forestry. In addition to harvesting and recycling the source of nutrients and avoiding dumping of waste and resulting pollution, the onsite concentration of these nutrients may increase the unit value of these resources within their respective value chains, but may also reduce logistics costs of collection, sourcing or transportation, and/or downstream processing costs.

Such resource harvesting or recovery may be implemented in a number of ways. Recovering solid or liquid resources from solid or liquid waste may be achieved through concentration or precipitation or filtration or other advanced methods.

Some embodiments may include a precipitation system or component that may facilitate conversion of liquid waste to a solid compound(s) through one or a combination of processes involving solidification, condensation, concentration, or precipitation.

Included herein are example embodiments containing devices, components, designs and methods of collection of solid waste, liquid waste and/or other liquid feeds in one or more containers that may facilitate volume reduction of the contained substrate by providing effluent in liquid or gaseous form. Such volume reduction may then yield one or more solid compounds or concentrated liquid solutions or brine from what is retained from the process or in the system. Some embodiments may have the solid capture container and/or the liquid capture container configured to capture one or more generated solid compounds and allow for removal and/or collection of such compound(s) from the device.

While processes that allow for the bulk recovery of dried urinary solids, the output is somewhat crude as it may include a combination of dissolved ions and solids, including but not limited to proteins, bacteria, viruses, polysaccharides and other organic matter, which may require further separation or purification treatment prior to reuse for a number of applications. To improve the separation of resources from waste streams, particularly liquid streams, a prefilter may be implemented to screen and retain constituents before entering the evaporative container. This prefilter may screen and remove larger particulates and/or dissolved ions contained in waste, and may additionally serve to capture odorous or volatile constituents to prevent contamination of other recovered resources and/or improve the user's experience. Not only does this method allow for the multi-stage separation of resources, and therefore easier collection and application of separate waste constituents, but the filtration and removal of ions and suspended particles prior to entering the liquids evaporative membrane may improve the rate of pervaporation through the membrane due to the improved feed quality.

Embodiments of the evaporative process as described in this disclosure include a passive system capable of removing moisture from a solid or liquid substrate, reserving dried solids and producing an effluent stream of clean water vapor possibly with comparable or improved purity compared to that obtained via existing water purification technologies such as reverse osmosis. However, the rate and/or quality of separation may be further improved via the incorporation of additional resource recovery and water purification technologies, including but not limited to membrane distillation and ultrafiltration. The inclusion of these technologies may improve the volume and purity of diverse separated components and therefore improve the waste-to-value potential of example embodiments of this disclosure.

Precipitation.

The chemical formulas of precipitated solids are diverse and depend upon the ions present in solution, though ammonium and phosphorus are desirable components when the product is to be used as a fertilizer. Nutrients may be added to the solution, for example within the precipitation reactor, to increase the formation of a particular precipitate—this is the case for struvite, a nutrient-dense solid formed by the precipitation of ammonium, phosphate and magnesium, which may require the artificial addition of magnesium to improve product yield. Embodiments may include a reactor to provide the turbulence for precipitate formation, accumulating precipitates which react and solidify out of solution while purging the remaining liquid and constituents. This reactor may be a simple stirring and filtration mechanism which may be operated mechanically or manually, for example with a crank, reducing the energy and equipment requirements for this process.

Due to the simple operation of the precipitation reactor, the removal and chemical conversion of dissolved ions from urine may be easily incorporated into some embodiments, either before the liquid enters the evaporative container, upstream or downstream of the prefilter. This placement allows for ions to be precipitated out of solution prior to contact with the pervaporative membrane, thereby reducing the feed solute concentration and improving the rate of pervaporation. Alternatively, the precipitation reactor may operate downstream of the evaporative container, separating usable resources from concentrated urine.

The precipitation of ammonia and additional urinary constituents is a common unwanted consequence of urea hydrolysis within wastewater systems which increases the solution pH, causing dissolved ions to react and solidify out of solution, forming dense nutrient deposits. While these hard, rock-like deposits may clog conventional wastewater systems, the precipitants are desirable fertilizers due to their nutrient availability and slow nitrogen release when applied to soil. Additionally, due to the lack of turbulence in some embodiments, unintentional precipitate formation is unlikely to occur and lead to blockages or membrane fouling, allowing their formation to occur in a separate chamber or reactor without disruption to the rest of the system.

Such additional functionalities described above may be implemented or achieved within the previously-described example embodiments, or through embodiments containing additional components or compartments that are placed upstream of waste capture containers, downstream of waste capture containers, and/or in parallel to waste capture containers.

While some embodiments of a precipitation reactor may include a component or device designed to facilitate the precipitation of solid compounds at least in part by providing a physical agitation, other non-limiting embodiments of a precipitation reactor may include any surface, chamber, tube, or media configured to extract a solid compound from the liquid and/or solid waste feeds. In such embodiments, a precipitation reactor may simply be considered a precipitation element.

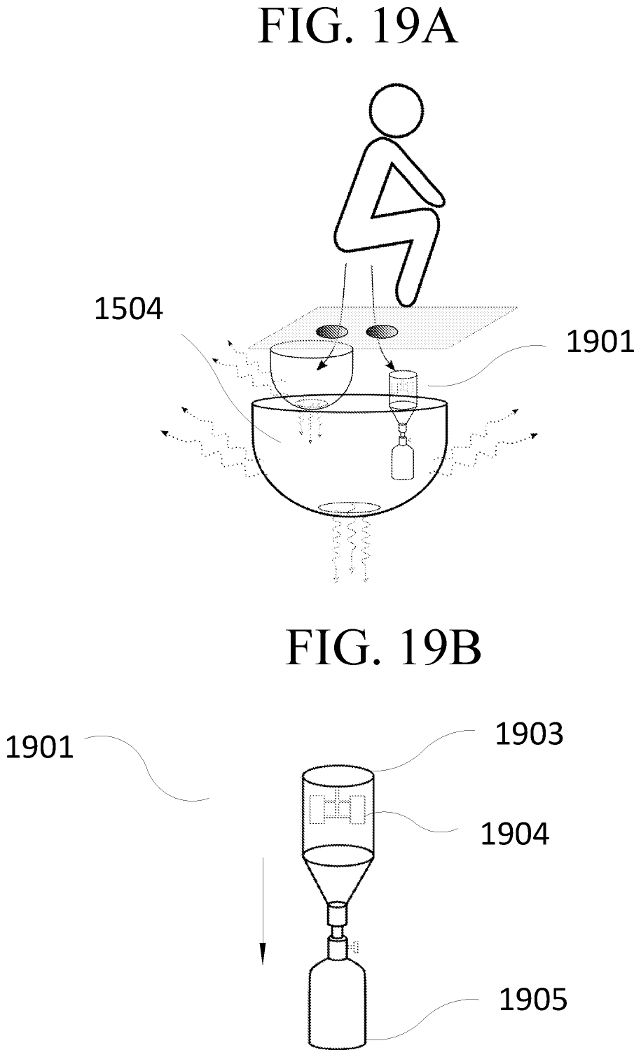

FIGS. 19A and 19B show an example embodiment including a precipitation reactor. The precipitation reactor 1901 has an inlet side 1903 for receiving collected liquid waste, an agitator 1904 for stirring the liquid, and an outlet side 1905 to collect the precipitate for future drying along with residual effluent. The outlet side also serves as an exit to release the residual effluent into subsequent sections of the apparatus, for example a waste capture container 1504. Other additives may be added to the inlet side 1903 while stirring to improve the precipitation yield.

Additionally, treated or clean liquid water may be recovered in some embodiments, by treating liquid waste effluent, or by condensing or harvesting gaseous water generated from or collected by the system. For example, gaseous water that was removed from the collected waste streams as a result of evaporation and/or pervaporation may be converted to clean or treated liquid water for some downstream application. Generation of treated or clean liquid water from condensation of gaseous water may be achieved by methods including but not limited to temperature differential, cooling, use of surfaces or surface contact to facilitate condensation or wicking or droplet formation, and filtration.

To achieve condensation, some embodiments may include a condensation surface that facilitates a gas-to-liquid phase change of the gaseous vapor or effluent. In such an embodiment, a condensation surface may achieve condensation by cooling gaseous liquid or effluent. Another example embodiment may utilize a cooled condensation surface relative to the gaseous liquid or effluent. Another option for such an embodiment may utilize a condensation surface comprised of a superhydrophobic or omniphobic material or coating or surface texturing, which may facilitate liquid droplet formation or wicking.

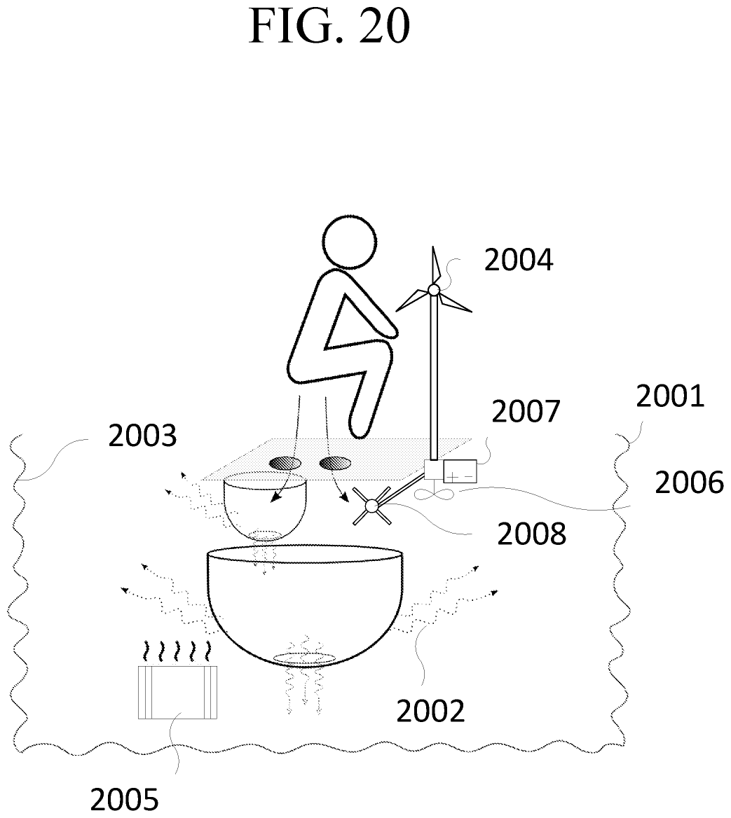

Referring to FIG. 20, an example embodiment including a condensation reaction is shown. The condensation surface 2001 encloses other components of the apparatus and comprises an inner surface 2003, which serves as an interface for condensing water vapor from the gas effluent 2002. The condensation surface 2001 may be comprised of materials including but not limited to metal, paper or textiles, and/or specialized surfaces including but not limited to ultrahydrophobic surfaces and/or coatings, omniphobic surfaces and/or coatings and surfaces treated with plasma, ultraviolet irradiation or anodization, which attract and promote cohesion among water molecules, resulting in cohesion. The inner face 2003 may be comprised of materials including but not limited to metal, paper or textiles, and/or specialized surfaces including but not limited to ultrahydrophobic surfaces and/or coatings, omniphobic surfaces and/or coatings and surfaces treated with plasma, ultraviolet irradiation or anodization, which attract and promote cohesion among water molecules, resulting in cohesion.

A heat component 2005 provides heat to an atmosphere contained within the condensation surface 2001. The heat provided by the heat component 2005 may serve to increase the ambient temperature within the condensation surface which may improve the rate of evaporation, thereby increasing the volume of water vapor in the gas effluent 2002. Additionally, heat provided by the heat component 2005 may provide a heat differential between the condensation surface 2001 and the inner face 2003, which may increase the rate of condensation along the inner face 2003. Embodiments of the heat component include but are not limited to an electrical heater, chemical reaction heaters, a heatsink, a geothermal heater, or any other form of component configured to radiate heat.

An air turbine 2004 is positioned external to the apparatus to convert kinetic energy of external air flow to electricity or facilitated/enhanced air flow or ventilation for use inside the apparatus. As air flow passes over blades of the air turbine 2004, the blades rotate and the air turbine 2004 generates energy which may be converted to electricity. A fluid turbine 2008 is positioned along the collection path of liquid waste feed to convert kinetic energy of flowing liquids to electricity. As liquid passes over/through the fluid turbine 2008, the rotors/blades of the fluid turbine 2008 rotate, and the fluid turbine 2008 generates energy which may be converted to electricity. Generated electricity may be used to help power the heat component 2005, help power additional electronics for the system, or be stored in a battery 2007 for future use. A fan component 2006 may be used to convert air and/or fluid turbine rotation directly into internal air flow. The fan component 6 may also be powered by electricity stored in the battery 2007.

Embodiments including recovery methods or components to generate value-added or useful resources may be applied individually or in combination with other methods. Recovery methods or components may be implemented in the previously-described embodiments, or through embodiments including additional components or devices upstream of, downstream from, surrounding or parallel to waste capture containers.

Conversion.

Some example embodiments may include onsite conversion of solid and/or liquid wastes. Waste conversion may provide economic or improved sustainability benefits (eg from reduced pollution, reduced resource consumption or waste-to-value use or conversion or monetization). Onsite waste conversion may also result in increased or improved deployability of onsite sanitation or water- or waste treatment systems. By reducing waste volumes onsite, such systems may be more compact and fit in more constrained contexts (for example, urban or built-out areas, internal or interior spaces), may help keep deployment sites cleaner, may be deployed in places where other alternatives are inoperable or infeasible. With increased or improved deployability, these systems may render sanitation, water treatment or waste treatment more accessible or available in more locations or in more challenging locations or geographies or in more low-resource contexts. Onsite waste-to-energy conversion may power sanitation, water and/or waste treatment systems in more remote or off-grid areas. Combining waste evaporation with composting may allow composting to be more feasible or deployable for applications in confined or enclosed spaces or crowded contexts (normal composting has no ability to reduce collected waste volumes onsite so generally require a larger footprint or more space or discharge of liquid waste into the surrounding ground). Monetization of converted waste outputs may reduce installation or operating costs for sanitation, water- or waste treatment systems, thereby increasing deployability or accessibility.

Options for onsite conversion of waste may include but are not excluded to the following approaches.

Metabolic or Biological Processing.

In some embodiments, waste may be converted using metabolic or biological or decomposition approaches or using microbes, microorganisms, microbial cultures or microbiome systems. These may utilize organisms including bacteria, fungi, algae or other microbial species.

Numerous biochemical and metabolic processes have been developed or harnessed to treat human waste for reuse and/or resource recovery, which may require prolonged biological treatment under controlled climate conditions to produce usable material from excreta that is safe to handle. By including such processes within some embodiments to occur alongside waste evaporation, a consistent climate may be more easily maintained and the footprint of the combined processes may be reduced, thus facilitating greater metabolic conversion simultaneous to the evaporative process. Furthermore, due to the multiple stages of passive separation occurring within some embodiments, the biological and metabolic processes described herein may be implemented at multiple stages throughout the system/process.

Composting.

In some embodiments, waste may be converted to neutralized forms by composting. Some example embodiments may be configured to facilitate composting of captured solid waste within the solid capture container and/or within a separate vessel. Generally, feces and mixed human waste must be composted for over a year for microbial activity to render it safe for agricultural use, during which time it must be contained and kept at appropriate climate conditions. The most common approach is to collect the waste in a secondary container kept away from foot traffic, as composting human waste often generates foul odors and attracts insects. By allowing this metabolic process to occur within the toilet, or within removable vessels from the toilet, the waste may be readily composted without handling the waste directly, and without the need for a dedicated external composting container. This potentially reduces the total footprint required to operate the toilet and compost the waste within, as well as removing the need for an additional container. While a diverse range of toilets have been produced which compost collected waste for agricultural reuse, these toilets require a very large collection vessel to contain the volume of waste added; this is typically accomplished by placing the toilet above a large storage container or an underground pit. Additionally, existing composting toilets are rarely able to prevent or eliminate foul odors, contributing to an unpleasant user experience which extends to the air surrounding the toilet. In contrast, the evaporative layer(s) of some embodiments contribute to volume reduction and odor neutralization of the waste, reducing the volume needed to compost waste and improving the user experience, respectively. The result is a compact, above-ground toilet with no solid or liquid effluent, in which the waste collected therein may be fully composted without disrupting the toilet's use or requiring additional equipment.

Other Metabolic and Biological Conversion.

Other optional biological or metabolic or decomposition processes which may operate alongside apparatus embodiments of this disclosure to recover value from waste include but are not limited to the production of biogas or the collection of insect larva.

Biogas.

Biogas, a mixture of gasses produced from raw or digested waste, contains high concentrations of methane and carbon dioxide which may be used as fuel for applications including but not limited to cooking, heating and conversion to electricity. The production of biogas occurs most often in an anaerobic digester in the presence of bacteria. The flexible, non-porous nature of the evaporative membrane, from which the collection vessels are constructed in some embodiments, allows for anaerobic digestion to occur within a covered vessel, such as one of the evaporative containers or a separate designated container, within the toilet. The biogas produced may then accumulate in the vessel, after which point it may be collected simply by pumping the gas from the flexible vessel. The chemical or metabolic conversion of the waste may reduce the need for end-of-cycle waste disposal or storage while simultaneously allowing valuable resources to be recovered from human waste.

Insects.

Another approach to metabolic or biological conversion of waste use insect species such as black soldier flies or other species of insects that feed on or utilize waste. In some embodiments, further value may be recovered from waste by taking advantage of natural insect behavior and intentionally breeding insect larva to feed off the waste. In this process, waste—primarily feces—is used to feed insects, such as flies, which lay eggs on feces. Their larva then hatches and feeds off the nutrients in the waste while growing. The insect larva consuming the waste may be harvested, dehydrated, and served as a high-protein, low-cost animal feed, allowing the nutrients from untreated and/or dehydrated human waste to undergo a number of metabolic processes before ultimately feeding livestock, thereby recycling significant resources contained within the waste.

Fungi or Algae/Microalgae or Bacteria.

Another approach to biological conversion of waste may microorganisms to metabolize or decompose waste converting it to value-added or useful outputs, including but not limited to proteins, fibrous materials, bio-fuels, oils, construction or packing materials, etc). In some embodiments, fungal species, algal species, bacteria, protozoa, or any other microorganism may be used to compost captured solid waste.

The described embodiments may also utilize additional processes including but not limited to non-biological, chemical, biochemical and/or enzymatic approaches to convert waste, including but not limited to the use of additives, catalysts, heat, irradiation and/or other methods or combinations thereof. Components, devices or systems to facilitate these or other conversion methods may be implemented either in the previously-described embodiments, or in additional embodiments comprising components or compartments placed upstream of, downstream from or parallel to previously described components or compartments.

These waste conversion approaches may yield a number of useful or value-added outputs, including but not limited to the following: bio-energy or electricity or urinetricity derived from solid or liquid wastes or wastewater, biogas, fertilizer, salts, fibers, bio-fertilizer, bio-fuels, oils, animal feed, nutrients, other bio-feedstock, biologically-derived chemicals, other organic or carbon-based matter, or biochemical or chemical intermediate products for use in other production processes.

The technologies and approaches explored thus far provide useful opportunities for recovering usable resources found within waste, though for many potential applications, the resources contained within the waste must be converted or otherwise treated before they provide a value or benefit. The presence of pathogens, for example, may prevent desiccated urine or feces from being used directly as fertilizer for crops. While the recovered waste constituents may be collected on-site and separated and/or converted prior to their intended application, the option exists for the apparatus to house additional chemical, biochemical and/or metabolic processes to operate alongside the standard evaporative function of the already-described design(s), allowing the conversion of waste components to more readily applied materials which may be more readily used for downstream purposes including but not limited to fertilizer, fuel and the production of animal feed. Despite some outputs requiring additional treatment and/or processing, which may occur offsite at a processing facility, there is still value to this onsite conversion, as it may partially or fully neutralize waste, it may contribute to onsite waste volume reduction, and/or enhance the value of the outputs from such a device or apparatus that may justify or offset some of the collection or handling costs to enhance the feasibility of such circular value chains.

Other example embodiments that collect solid or liquid waste or liquid feeds may also possess at least one waste capture container for receiving waste, and an energy cell attached to or incorporated into the system and configured to receive a portion of the collected waste, using at least a portion of that waste to generate power or electrical current, with the energy cell remains as part of or connected to the apparatus, rather than being separate or detached from that apparatus. Some embodiments may be configured to split the collected or received liquid waste or liquid feed, diverting at least a portion of the received waste to an energy cell, and a portion to the waste capture container.

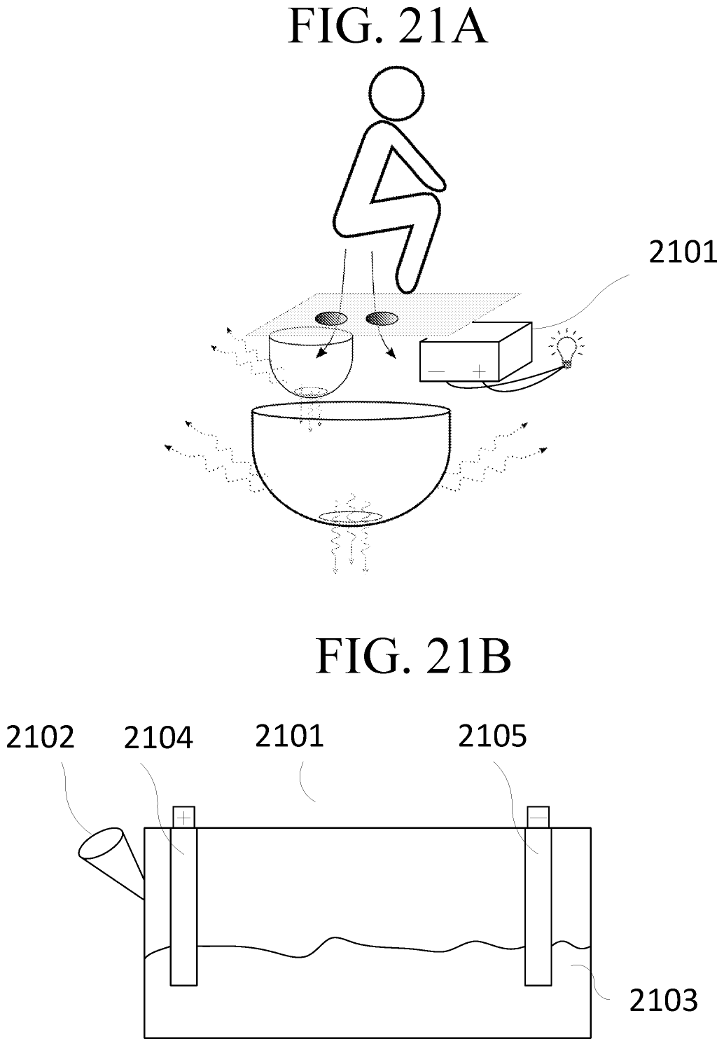

FIGS. 21A and 21B show an example embodiment that generates energy utilizing collected waste. An energy cell 2101 comprises a diverter 2102, which serves as an inlet for the liquid waste 2103 entering the energy cell. The liquid waste 2103 in the cell serves as an electrolyte between the anode and cathode which may generate energy. Generated energy may be stored for later use or be immediately used or stored by components within the apparatus and/or external to the apparatus. Additional energy generation efficiency may be realized in embodiments operating multiple smaller energy cells 2101 in parallel with a small liquid waste volume 2103 in each energy cell 2101. Similarly, the total energy capacity may be increased in some embodiments by increasing the liquid waste volume 2103 capacity by introducing more energy cells 2101 of the same size.

An embodiment utilizing an energy cell 2101, in which urine is a substrate, may generate approximately 24 mW per liter of urine. For example, for a family of five, each producing approximately 1.4 L of urine per day, this may amount to 168 mW daily, which may be used to power lights and/or charge electronic devices, or may be stored in a battery or the energy cell for accumulation and/or future use, including may be used inside this disclosure to power internal functions or components, for example odor ventilation.

It will be appreciated by those skilled in the art that changes could be made to the embodiments described above without departing from the broad inventive concept thereof It is understood, therefore, that the invention disclosed herein is not limited to the particular embodiments disclosed, and is intended to cover modifications within the spirit and scope of the present invention.

What is claimed is:

1. An apparatus for moisture removal and separation from moisture-containing media, comprising:
one or more hydrophilic evaporative layers; and
one or more wicking layers,
wherein the moisture-containing media contains one or more of a suspended solid, a dissolved solid, a dissolved ion or salt, biological material or other pollutant,
the one or more hydrophilic evaporative layers are non-porous or nano-porous and allowing selective passage of water molecules in vapor form while preventing passage of one or more of a suspended solid, a dissolved solid, a dissolved ion, salts, biological material or other pollutants, and
the one or more wicking layer are adapted to absorb and spread bulk moisture, with or without dissolved ions, across a surface area, allowing the transfer of moisture from the one or more wicking layers to the one or more evaporative layers, direct evaporation from the one or more wicking layers retaining one or more of a suspended solid, a dissolved solid, a dissolved ion, salts, biological material or other pollutants.

2. The apparatus of claim 1, wherein the one or more evaporative layers comprise a bag or tube with an opening for substrate or media delivery.

3. The apparatus of claim 1, wherein the one or more wicking layers and the one or more evaporative layers are in contact.

4. The apparatus of claim 2, wherein the one or more wicking layers and the one or more evaporative layers are not in contact, and the one or more wicking layers are suspended into the media or substrate which is contained in the bag or tube formed of the one or more evaporative layers.

5. The apparatus of claim 4, further comprising one or more odor-neutralizing layer, wherein the one or more wicking layers are each paired with the one or more odor-neutralizing layer, each pair of the one or more wicking layers and the one or more odor-neutralizing layers being in direct contact.

6. The apparatus of claim 4, wherein the one or more wicking layers are impregnated with an absorptive material to increase moisture removal, including but not limited to hydrogel and silica gel.

7. The apparatus of claim 1, wherein the one or more wicking layers are selectively hydrophilic or hydrophobic to control a direction of wicking or a release of moisture from the one or more wicking layers.

8. The apparatus of claim 1, wherein the one or more evaporative layers are made from a copolyetherester elastomer, a polyether-block-polyamide, a polyether urethane, homopolymers or copolymers of polyvinyl alcohol, or mixtures thereof.

9. The apparatus of claim 8, wherein the one or more evaporative layers are made from polyether-block-polyamide PEBAX® 1074, or a combination of polyether-block-polyamides in which PEBAX® 1074 is one component.

10. The apparatus of claim 1, wherein the one or more wicking layers and the one or more evaporative layers are encased in a rigid shell for protection, with one opening for the delivery of moisture-containing media to the evaporative layer bag.

11. The apparatus of claim 10, further comprising holes in the rigid shell for ventilation.

12. The apparatus of claim 10, further comprising one or more of a powered fan and a vacuum for assisting airflow and ventilation.

13. The apparatus of claim 12, wherein the one or more wicking and one or more odor-neutralizing layers are arranged in parallel to create channels that direct airflow through the apparatus.

14. The apparatus of claim 10, further comprising a heater for providing additional heat into the rigid shell to improve a rate of pervaporation through the one or more evaporative layers.

15. A method for moisture removal and separation from moisture-containing media, comprising:
providing one or more hydrophilic evaporative layers; and
providing one or more wicking layers,
wherein the moisture-containing media contains one or more of a suspended solid, a dissolved solid, a dissolved ion or salt, biological material or other pollutant,
the one or more hydrophilic evaporative layers are non-porous or nano-porous and allowing selective passage of water molecules in vapor form while preventing passage of one or more of a suspended solid, a dissolved solid, a dissolved ion, salts, biological material or other pollutants, and
the one or more wicking layer are adapted to absorb and spread bulk moisture, with or without dissolved ions, across a surface area, allowing the transfer of moisture from the one or more wicking layers to the one or more evaporative layers, direct evaporation from the one or more wicking layers retaining one or more of a suspended solid, a dissolved solid, a dissolved ion, salts, biological material or other pollutants.

16. The method of claim 15, wherein the one or more evaporative layers comprise a bag or tube with an opening for substrate or media delivery.

17. The method of claim 15, wherein the one or more wicking layers and the one or more evaporative layers are in contact.

18. The method of claim 16, wherein the one or more wicking layers and the one or more evaporative layers are not in contact, and the one or more wicking layers are suspended into the media or substrate which is contained in the bag or tube formed of the one or more evaporative layers.

19. The method of claim 18, further comprising providing one or more odor-neutralizing layer, wherein the one or more wicking layers are each paired with the one or more odor-neutralizing layer, each pair of the one or more wicking layers and the one or more odor-neutralizing layers being in direct contact

20. The method of claim 18, wherein the one or more wicking layers are impregnated with an absorptive material to increase moisture removal, including but not limited to hydrogel and silica gel.

21. The method of claim 15, wherein the one or more wicking layers are selectively hydrophilic or hydrophobic to control a direction of wicking or a release of moisture from the one or more wicking layers.

22. The method of claim 15, wherein the one or more evaporative layers are made from a copolyetherester elastomer, a polyether-block-polyamide, a polyether urethane, homopolymers, copolymers of polyvinyl alcohol, or mixtures thereof.

23. The method of claim 22, wherein the one or more evaporative layers are made from polyether-block-polyamide PEBAX® 1074, or a combination of polyether-block-polyamides in which PEBAX® 1074 is one component

24. The method of claim 15, further comprising providing a rigid shell, wherein the one or more wicking layers and the one or more evaporative layers are encased in the rigid shell for protection, with one opening for the delivery of moisture-containing media to the evaporative layer bag.

25. The method of claim 24, wherein the rigid shell comprises holes for ventilation.

26. The method of claim 24, further comprising providing one or more of a powered fan and a vacuum for assisting airflow and ventilation.

27. The method of claim 26, wherein the one or more wicking and one or more odor-neutralizing layers are arranged in parallel to create channels that direct airflow through the apparatus.

28. The method of claim 24, further comprising providing a heater for providing additional heat into the rigid shell to improve a rate of pervaporation through the one or more evaporative layers.

29. A composition for passive dewatering and moisture removal, comprising:
at least one evaporative material selected from the group consisting of copolyetherester elastomer, a polyether-block-polyamide, a polyether urethane, homopolymers, copolymers of polyvinyl alcohol, polyether-block-polyamide PEBAX® 1074, a combination of polyether-block-polyamides in which PEBAX® 1074 is one component, or mixtures thereof; and
at least one wicking material selected from the group consisting of cotton, cellulose fiber, silica gel, hydrogels, desiccant paper, wood cellulose absorptive paper, and mixtures thereof.

30. The composition of claim 29, wherein a weight ratio of the evaporative material to the wicking material ranges from 1:3 to 5:2.

31. A composition for passive dewatering and moisture removal, comprising:
at least one evaporative material selected from the group consisting of copolyetherester elastomer, a polyether-block-polyamide, a polyether urethane, homopolymers, copolymers of polyvinyl alcohol, polyether-block-polyamide PEBAX® 1074, a combination of polyether-block-polyamides in which PEBAX® 1074 is one component, or mixtures thereof; and
at least one odor-neutralizing material selected from the group consisting of cellulose fiber, activated carbon, zeolite, kinetic degradation fluxion media, synthetic fibers, cellulose activated carbon media, and mixtures thereof.

32. The composition of claim 31, wherein a weight ratio of the evaporative material to the odor-neutralizing material ranges from 1:3 to 5:2.

33. A composition for passive dewatering and moisture removal, comprising:
at least one wicking material selected from the group consisting of cotton, cellulose fiber, silica gel, hydrogels, desiccant paper, wood cellulose absorptive paper, and mixtures thereof; and
at least one odor-neutralizing material selected from the group consisting of cellulose fiber, activated carbon, zeolite, kinetic degradation fluxion media, synthetic fibers, cellulose activated carbon media, and mixtures thereof.

34. The composition of claim 33, wherein a weight ratio of the wicking material to the odor-neutralizing material ranges from 1:3 to 5:2.

35. A composition for passive dewatering and moisture removal, comprising:
at least one evaporative material selected from the group consisting of copolyetherester elastomer, a polyether-block-polyamide, a polyether urethane, homopolymers, copolymers of polyvinyl alcohol, polyether-block-polyamide PEBAX® 1074, a combination of polyether-block-polyamides in which PEBAX® 1074 is one component, or mixtures thereof;
at least one wicking material selected from the group consisting of cotton, cellulose fiber, silica gel, hydrogels, desiccant paper, wood cellulose absorptive paper, and mixtures thereof; and
at least one odor-neutralizing material selected from the group consisting of cellulose fiber, activated carbon, zeolite, kinetic degradation fluxion media, synthetic fibers, cellulose activated carbon media, and mixtures thereof.

36. The composition of claim 35, wherein a weight ratio of the evaporative material to the wicking material ranges from 1:3 to 5:2.

37. The composition of claim 35, wherein a weight ratio of the wicking material to the odor-neutralizing material ranges from 1:3 to 5:2.

38. The composition of claim 35, wherein a weight ratio of the evaporative material to the odor-neutralizing material ranges from 1:3 to 5:2.

39. An apparatus for the collection and re-use of water vapor from a contaminated or un-contaminated liquid, solid or gaseous source, comprising: one or more hydrophilic evaporative layers,
wherein the liquid, solid or gaseous source comprises one or more of a suspended solid, a dissolved solid, a dissolved ion or salt, biological material or other pollutant, and
the one or more hydrophilic evaporative layers are non-porous or nano-porous, and allow selective passage of water molecules in vapor form while preventing passage of one or more of a suspended solid, a dissolved solid, a dissolved ion, salts, biological material or other pollutants.

40. The apparatus of claim 39, wherein the collected water vapor is condensed through passive or active means into a liquid for storage or re-use.

41. The apparatus of claim 39, wherein at least one of heat or pressure is artificially applied to the one or more hydrophilic evaporative layers to increase the rate of moisture vapor transmission.

42. The apparatus of claim 39, wherein the liquid, solid or gaseous source contains no contaminants.

43. An apparatus for evaporative containment of liquid or solid wastes, comprising:
one or more evaporative membranes for receiving the liquid or solid waste;
one or more flaps comprising one or more of a wicking layer, an odor-neutralizing layer or both; and
a skeletal frame for supporting the one or more evaporative membranes and the one or more flaps.

44. The apparatus of claim 43, wherein the one or more evaporative membranes comprises a membrane bag for removing moisture in the liquid or solid waste by pervaporation.

45. The apparatus of claim 43, further comprising a first receptacle for receiving solid waste, and a second receptacle for receiving liquid waste.

46. The apparatus of claim 43, further comprising a ventilation system comprising one or more vent cutouts for passive ventilation or a fan for active ventilation.

47. The apparatus of claim 43, further comprising one or more hinged doors for providing access to the evaporative membrane and the one or more flaps.

48. The apparatus of claim 43, further comprising a pre-treatment system configured for pre-treatment of liquid waste prior to the liquid waste being deposited on the evaporative membrane.

49. The apparatus of claim 48, wherein liquid waste is configured to be received by a receptacle for liquid waste, then received by the pre-treatment system before being received by the one or more flaps or the one or more evaporative membranes.

50. The apparatus of claim 48, wherein the pre-treatment system comprises a funnel and one or more tubes.

51. The apparatus of claim 43, wherein the one or more flaps comprise at least one of the wicking layer and at least one of the odor-neutralizing layer, the at least one wicking layer and the at least one odor-neutralizing layer being in contact at least partly to form a single flap of the one or more flaps.

52. The apparatus of claim 43 wherein the one or more evaporative layers are made from a copolyetherester elastomer, a polyether-block-polyamide, a polyether urethane, homopolymers or copolymers of polyvinyl alcohol, or mixtures thereof.

53. The apparatus of claim 52, wherein the one or more evaporative layers are made from polyether-block-polyamide PEBAX® 1074, or a combination of polyether-block-polyamides in which PEBAX® 1074 is one component.

54. The apparatus of claim 52, further comprising a heater for providing additional heat to improve a rate of pervaporation through the one or more evaporative membranes.

55. The apparatus of claim 43, further comprising tracks or carriages or guide rails that allow for easy unrestricted linear movement of the receptacles.

56. A method for evaporative containment of liquid or solid wastes, comprising:
providing an apparatus, comprising:
one or more evaporative membranes for receiving the liquid or solid waste;
one or more flaps comprising one or more of a wicking layer and an odor-neutralizing layer, or both; and
a skeletal frame for supporting the one or more evaporative membranes and the one or more flaps.

57. The method of claim 56, wherein the one or more evaporative membranes comprises a membrane bag for removing moisture in the liquid or solid waste by pervaporation.

58. The method of claim 56, wherein the apparatus further comprises a first receptacle for receiving solid waste, and a second receptacle for receiving liquid waste.

59. The method of claim 56, wherein the apparatus further comprises a ventilation system comprising one or more vent cutouts for passive ventilation or a fan for active ventilation.

60. The method of claim 56, wherein the apparatus further comprises one or more hinged doors for providing access to the evaporative membrane and the one or more flaps.

61. The method of claim 56, wherein the apparatus further comprises a pre-treatment system configured for pre-treatment of liquid waste prior to the liquid waste being deposited on the evaporative membrane.

62. The method of claim 61, further comprising: receiving liquid waste using a receptacle for liquid waste; receiving liquid waste from the receptacle by the pre-treatment system; receiving liquid waste from the pre-treatment system into the one or more flaps or the one or more evaporative membranes.

63. The method of claim 61, wherein the pre-treatment system comprises a funnel and one or more tubes.

64. The method of claim 56, wherein the one or more flaps of the apparatus comprise at least one of the wicking layer and at least one of the odor-neutralizing layer, the at least one wicking layer and the at least one odor-neutralizing layer being in contact at least partly to form a single flap of the one or more flaps.

65. The method of claim 56, wherein the one or more evaporative layers are made from a copolyetherester elastomer, a polyether-block-polyamide, a polyether urethane, homopolymers or copolymers of polyvinyl alcohol, or mixtures thereof.

66. The method of claim 65, wherein the one or more evaporative layers are made from polyether-block-polyamide PEBAX® 1074, or a combination of polyether-block-polyamides in which PEBAX® 1074 is one component.

67. The method of claim 56, wherein the apparatus further comprises a heater for providing additional heat to improve a rate of pervaporation through the one or more evaporative membranes.

68. The method of claim 56, wherein the apparatus further comprises tracks or carriages or guide rails that allow for easy unrestricted linear movement of the receptacles.

69. An apparatus for diversion of liquid or solid wastes, comprising:
a solid waste capture container for capturing solid waste and facilitating volume reduction of collected solid waste to provide effluent in liquid or gas form; and
a liquid waste capture container for capturing liquid waste and facilitating volume reduction of collected liquid waste to provide effluent in liquid or gas form.

70. The apparatus of claim 69, further comprising:
a solid waste filter which forms or is formed in at least part of the solid waste capture container and facilitates in the volume reduction of the collected solid waste; and
a liquid waste filter which forms or is formed in at least part of the liquid waste capture container and facilitates in the volume reduction of the collected liquid waste.

71. The apparatus of claim 69, wherein the solid waste capture container effluent is released into the liquid waste capture container.

72. The apparatus of claim 69, further comprising a secondary waste capture container, wherein the solid waste capture container effluent and the liquid waste capture container effluent are released into the secondary waste capture container.

73. The apparatus of claim 72, further comprising a secondary waste capture filter which forms or is formed in at least part of the secondary waste capture container and facilitates in the volume reduction of the solid waste capture container effluent and the liquid waste capture container effluent.

74. An apparatus for collecting liquid or solid wastes, comprising:
a solid waste capture container capable of volume reduction of collected solid waste and generating effluent in liquid or gas form containing a lower amount of impurities than the captured solid waste; and
a liquid waste capture container capable of volume reduction of collected liquid waste and generating effluent in liquid or gas form containing a lower amount of impurities than the captured liquid waste.

75. The apparatus of claim 74, wherein collected solid waste is stored in the solid waste capture container and kept separate from liquid waste, and collected liquid waste is stored in the liquid waste capture container and kept separate from solid waste.

76. The apparatus of claim 74 further comprising:
a membrane distillation module for receiving collected liquid waste and producing a liquid effluent, the module comprising a feed side, a distillate side, and at least one distillation membrane separating the feed and distillate sides, the module configured to provide a temperature differential between the feed side and distillate side.

77. The apparatus of claim 76, wherein the collected liquid waste is at least partially treated.

78. The apparatus of claim 76, wherein the liquid waste contains at least one impurity, and the produced effluent contains less than 50% by volume of the at least one impurity.

79. The apparatus of claim 74 further comprising:
a filtration cell for receiving collected liquid waste and producing a liquid permeate, the cell comprising at least one filtration module having a filter feed side,
a filter permeate side, and
at least one filtration membrane separating the feed side and the permeate side, the cell configured to provide a pressure differential between the filter feed side and the permeate side.

80. The apparatus of claim 79, wherein the at least one filtration membrane comprises an ultrafiltration membrane.

81. The apparatus of claim 79, wherein the collected liquid waste is at least partially treated.

82. The apparatus of claim 79, wherein the liquid waste contains at least one impurity, and the produced permeate contains less than 5% by volume of the at least one impurity.

83. The apparatus of claim 74, wherein at least one of the solid capture container or liquid capture container comprises at least one of a disinfection component or an odor-reduction component.

84. The apparatus of claim 74 further comprising:
a precipitation reactor and/or element configured to receive liquid waste and generate a solid compound using a process, wherein the process comprises at least one of solidification, condensation, concentration, or precipitation.

85. A method for collecting liquid and/or waste or other liquid feeds for processing comprising:
providing an apparatus comprising:
a solid capture container for capturing solid waste or wet mass, facilitating volume reduction of collected solid waste or wet mass, and providing effluent in liquid or gas form;
a liquid capture container for capturing liquid waste or feed liquid, facilitating volume reduction of collected liquid waste or feed liquid, and providing effluent in liquid or gas form;
collecting at least one of a solid waste, wet mass, liquid waste, or feed liquid; and
generating at least one of a solid compound or concentrated liquid by utilizing the collected waste, mass or feed.

86. The apparatus of claim 74, further comprising a condensation surface configured to facilitate a gas-to-liquid phase change of the gas effluent.

87. The apparatus of claim 86, wherein the condensation surface has an inner face configured to contact the gas effluent and be conditioned to a temperature less than the temperature of the gas effluent

88. The apparatus of claim 86, wherein the condensation surface is comprised of at least one of a superhydrophic material, superhydrophic coating, omniphophic material, omniphophic coating, or textured surface.

89. An apparatus for the collection of at least one of solid waste, liquid waste, or liquid feed comprising:
at least one waste capture container for receiving a waste; and
an energy cell operably attached to the apparatus and configured to receive at least a portion of the received waste and generate an electric current utilizing the at least a portion of the received waste, wherein the energy cell generates the electric current without being detached from the apparatus.

90. The apparatus of claim 89, wherein the received waste is a liquid, and the apparatus is configured to divert at least a portion of the received waste to the energy cell and at least a portion of the received waste to the at least one waste capture container.

91. The apparatus of claim 74, wherein the solid capture container is configured to facilitate the composting of captured solid waste.

92. A method for collecting solid or liquid waste, comprising:
providing an apparatus comprising:
a solid waste capture container for capturing solid waste, facilitating volume reduction of collected solid waste, and providing effluent in liquid or gas form;
a liquid waste capture container for capturing liquid waste, facilitating volume reduction of collected liquid waste, and providing effluent in liquid or gas form;
collecting a solid waste; and
performing a conversion of the solid waste.

93. The method of claim 92, wherein the conversion comprises composting.

94. The apparatus of claim 74, wherein the solid capture container is configured to facilitate the generation and capture of biogas.

95. The method of claim 92, wherein the conversion comprises generating a biogas.

96. The apparatus of claim 74, wherein the solid capture container is configured to allow conversion of captured waste by a living organism.

97. The method of claim 92, wherein the conversion comprises metabolic conversion by a living organism.

98. The apparatus of claim 74, wherein at least one of the solid capture container or the liquid capture container are configured to collect solid compounds and allow for the removal of said solid compounds from the apparatus.

99. The apparatus of claim 74, wherein effluent from the solid capture container is released into the liquid capture container.

100. An apparatus for the collection of solid and/or liquid waste comprising:
a waste collection container capable of volume reduction of collected waste, wherein the waste collection container is configured to maximize exposure of collected liquid to an evaporative environment.

101. A method of waste collection and volume reduction comprising:
providing a waste collection container capable of volume reduction of collected waste and configured to maximize evaporation of liquid;
collecting a solid waste or liquid waste in the collection container; and
evaporating liquid from the collected waste directly from the waste, and through the waste collection container.

102. An apparatus for the collection of solid and/or liquid waste comprising:
at least one waste container configured to hold a volume of waste and having a plurality of surfaces for reducing the volume, wherein at least one of the surfaces is configured to be tuneably and/or intermittently submerged in the volume, ranging between partially submerged and fully submerged.

103. The apparatus of claim 102, wherein the at least one surface reduces the volume at least in part by pervaporation.

104. The apparatus of claim 74, further comprising a component for providing heat to improve a rate of volume reduction of collected waste.

105. The apparatus of claim 74, further comprising a turbine for utilizing an air current external to the apparatus to provide at least one of internal air flow or energy.

106. The apparatus of claim 74, further comprising a turbine for utilizing fluid flow of collected liquid waste to provide at least one of internal air flow or energy.

107. An apparatus for the collection of solid and/or liquid waste comprising:
at least one waste capture container for reducing the volume of captured waste, wherein the capture container at least in part comprises a non-hydrophobic material.

108. The apparatus of claim 107, wherein the at least one waste capture container also comprises a hydrophobic material.

109. The apparatus of claim 74, wherein the solid waste container is nested in the liquid waste container, wherein the liquid and solid waste containers together form a unified waste container for both liquid and solid wastes.

110. The apparatus of claim 74, wherein waste is at least partially treated prior to being captured in a waste container.

111. An apparatus for collecting liquid and/or solid wastes, comprising:
a waste capture container capable of volume reduction of collected solid and/or liquid waste and generating effluent in liquid or gas form containing a lower amount of impurities than the captured waste, wherein the waste capture container comprises at least one of a hydrophilic material, a breathable material, or a wicking material, and wherein volume reduction is achieved by partial vaporization of captured liquid through the waste capture container.

112. The apparatus of claim 74, further comprising a prefilter, wherein liquid waste passes through the prefilter before entering the liquid waste capture container.

113. The apparatus of claim 74, wherein the solid and liquid waste capture container comprise at least one of a hydrophilic material, a breathable material, or wicking material, and wherein volume reduction is achieved by partial vaporization of captured liquid through the waste capture container.

114. The apparatus of claim 100, further comprising an evaporative surface, wherein volume reduction of collected waste is achieved by evaporating liquid through the waste container and by at least one of evaporating directly from the waste or from the evaporative surface.

115. The method of claim 101, further comprising:
providing an evaporative surface and evaporating liquid from the evaporative surface.

116. An apparatus for collecting liquid and/or solid wastes, comprising:
a waste capture container and an evaporative surface configured to contact captured waste and capable of volume reduction of captured waste and generating effluent in liquid or gas form containing a lower amount of impurities than the captured waste, wherein the waste capture container is impermeable to gas and liquid, and wherein the evaporative surface comprises at least one of a hydrophilic material, non-hydrophobic material, wicking material, or breathable material.

117. An apparatus for the collection of solid and/or liquid waste comprising:
at least one waste capture container for reducing the volume of captured waste, wherein the capture container comprises a non-hydrophobic liquid impermeable material for containing the waste.
